(19) United States
(12) Patent Application Publication
(10) Pub. No.: US 2023/0394955 A1
(43) Pub. Date: Dec. 7, 2023

(54) USER INTERFACES FOR MANAGING A TIME-BASED EVENT

(71) Applicant: Apple Inc., Cupertino, CA (US)

(72) Inventor: Vincenzo O. GIULIANI, Thousand Oaks, CA (US)

(21) Appl. No.: 18/204,925

(22) Filed: Jun. 1, 2023

Related U.S. Application Data
(60) Provisional application No. 63/348,989, filed on Jun. 3, 2022.

(51) Int. Cl. G08B 25/01; G08B 13/16

(52) U.S. Cl. CPC G08B 25/016; G08B 25/012; G08B 13/1672

(57) ABSTRACT

The present disclosure generally relates to managing audio output of captured sounds. In some examples, a device can output sound captured by an external device while a time-based process active, where the time-based process ends after a predetermined amount of time has passed since the time-based process was initiated.

### CROSS-REFERENCE TO RELATED APPLICATIONS

This application claims priority to U.S. Provisional Patent Application Ser. No. 63/348,989, entitled “USER INTERFACES FOR MANAGING A TIME-BASED EVENT,” filed on Jun. 3, 2022, the content of which is hereby incorporated by reference in its entirety.

### FIELD

The present disclosure relates generally to computer user interfaces, and more specifically to techniques for managing a time-based event.

### BACKGROUND

Electronic devices are configured to establish connections with external electronic devices so that users of the electronic devices can communicate with one another. Electronic devices include the ability to initiate and receive phone calls, send and receive electronic messages, and/or send and receive audio messages. Electronic devices can also output notifications related to communications with external electronic devices.

### BRIEF SUMMARY

Some techniques for managing a time-based event using electronic devices, however, are generally cumbersome and inefficient. For example, some existing techniques use a complex and time-consuming user interface, which may include multiple key presses or keystrokes. As another example, some existing techniques do not establish communication between devices that lasts a finite time, which can reduce privacy and/or security of users. Existing techniques require more time than necessary, wasting user time and device energy. This latter consideration is particularly important in battery-operated devices.

Accordingly, the present technique provides electronic devices with faster, more efficient methods and interfaces for managing a time-based event. Such methods and interfaces optionally complement or replace other methods for managing a time-based event. Such methods and interfaces reduce the cognitive burden on a user and produce a more efficient human-machine interface. Such methods and interfaces increase an amount of privacy and/or security for users. For battery-operated computing devices, such methods and interfaces conserve power and increase the time between battery charges.

In accordance with some embodiments, a method is described. The method is performed at a computer system that is in communication with one or more audio output devices. The method comprises: receiving an indication of an event; in response to receiving the indication of the event, initiating a first time-based process, where during the first time-based process, captured sound is outputted via the one or more audio output devices; at a first time while the first time-based process is active: receiving a first captured sound; and outputting, via the one or more audio output devices, a first audio output that is based on the first captured sound; and at a second time while the first time-based process is active: in accordance with a determination that a set of one or more process-termination criteria are met, where the set of one or more process-termination criteria includes a criterion that is met when a predetermined time has elapsed since a third time, terminating the first time-based process; and in accordance with a determination that the set of one or more process-termination criteria are not met, maintaining the first time-based process.

In accordance with some embodiments, a non-transitory computer-readable storage medium is described. The non-transitory computer-readable storage medium stores one or more programs configured to be executed by one or more processors of a computer system that is in communication with one or more audio output devices, the one or more programs including instructions for: receiving an indication of an event; in response to receiving the indication of the event, initiating a first time-based process, where during the first time-based process, captured sound is outputted via the one or more audio output devices; at a first time while the first time-based process is active: receiving a first captured sound; and outputting, via the one or more audio output devices, a first audio output that is based on the first captured sound; and at a second time while the first time-based process is active: in accordance with a determination that a set of one or more process-termination criteria are met, where the set of one or more process-termination criteria includes a criterion that is met when a predetermined time has elapsed since a third time, terminating the first time-based process; and in accordance with a determination that the set of one or more process-termination criteria are not met, maintaining the first time-based process.

In accordance with some embodiments, a transitory computer-readable storage medium is described. The transitory computer-readable storage medium stores one or more programs configured to be executed by one or more processors of a computer system that is in communication with one or more audio output devices, the one or more programs including instructions for: receiving an indication of an event; in response to receiving the indication of the event, initiating a first time-based process, where during the first time-based process, captured sound is outputted via the one or more audio output devices; at a first time while the first time-based process is active: receiving a first captured sound; and outputting, via the one or more audio output devices, a first audio output that is based on the first captured sound; and at a second time while the first time-based process is active: in accordance with a determination that a set of one or more process-termination criteria are met, where the set of one or more process-termination criteria includes a criterion that is met when a predetermined time has elapsed since a third time, terminating the first time-based process; and in accordance with a determination that the set of one or more process-termination criteria are not met, maintaining the first time-based process.

In accordance with some embodiments, a computer system is described. The computer system is in communication with one or more audio output devices. The computer system comprises: one or more processors; and memory storing one or more programs configured to be executed by the one or more processors, the one or more programs including instructions for: receiving an indication of an event; in response to receiving the indication of the event, initiating a first time-based process, where during the first time-based process, captured sound is outputted via the one or more audio output devices; at a first time while the first time-based process is active: receiving a first captured sound; and outputting, via the one or more audio output devices, a first audio output that is based on the first captured sound; and at a second time while the first time-based process is active: in accordance with a determination that a set of one or more process-termination criteria are met, where the set of one or more process-termination criteria includes a criterion that is met when a predetermined time has elapsed since a third time, terminating the first time-based process; and in accordance with a determination that the set of one or more process-termination criteria are not met, maintaining the first time-based process.

In accordance with some embodiments, a computer system is described. The computer system is in communication with and one or more audio output devices. The computer system comprises: means for receiving an indication of an event; means for, in response to receiving the indication of the event, initiating a first time-based process, where during the first time-based process, captured sound is outputted via the one or more audio output devices; means for, at a first time while the first time-based process is active: receiving a first captured sound; and outputting, via the one or more audio output devices, a first audio output that is based on the first captured sound; and means for, at a second time while the first time-based process is active: in accordance with a determination that a set of one or more process-termination criteria are met, where the set of one or more process-termination criteria includes a criterion that is met when a predetermined time has elapsed since a third time, terminating the first time-based process; and in accordance with a determination that the set of one or more process-termination criteria are not met, maintaining the first time-based process.

In accordance with some embodiments, a computer program product is described. The computer program product comprises one or more programs configured to be executed by one or more processors of a computer system that is in communication with one or more audio output devices, the one or more programs including instructions for: receiving an indication of an event; in response to receiving the indication of the event, initiating a first time-based process, where during the first time-based process, captured sound is outputted via the one or more audio output devices; at a first time while the first time-based process is active: receiving a first captured sound; and outputting, via the one or more audio output devices, a first audio output that is based on the first captured sound; and at a second time while the first time-based process is active: in accordance with a determination that a set of one or more process-termination criteria are met, where the set of one or more process-termination criteria includes a criterion that is met when a predetermined time has elapsed since a third time, terminating the first time-based process; and in accordance with a determination that the set of one or more process-termination criteria are not met, maintaining the first time-based process.

In accordance with some embodiments, a method is described. The method is performed at a computer system that is in communication with one or more audio detection devices. The method comprises: receiving an indication of an event; in response to receiving the indication of the event, initiating a first time-based process, where during the first time-based process, audio data associated with sound captured via the one or more audio detection devices is enabled to be transmitted to an external computer system; at a first time while the first time-based process is active: transmitting the audio data associated with sound captured via the one or more audio detection devices; and outputting feedback indicative of the transmission of the audio data associated with sound captured via the one or more audio detection devices; and at a second time while the first time-based process is active: in accordance with a determination that a set of one or more process-termination criteria are met, wherein the set of one or more process-termination criteria includes a criterion that is met when a predetermined time has elapsed since a third time, terminating the first time-based process; in accordance with a determination that the set of one or more process-termination criteria are not met, maintaining the first time-based process.

In accordance with some embodiments, a non-transitory computer-readable storage medium is described. The non-transitory computer-readable storage medium stores one or more programs configured to be executed by one or more processors of a computer system that is in communication with one or more audio detection devices, the one or more programs including instructions for: receiving an indication of an event in response to receiving the indication of the event, initiating a first time-based process, where during the first time-based process, audio data associated with sound captured via the one or more audio detection devices is enabled to be transmitted to an external computer system; at a first time while the first time-based process is active: transmitting the audio data associated with sound captured via the one or more audio detection devices; and outputting feedback indicative of the transmission of the audio data associated with sound captured via the one or more audio detection devices; and at a second time while the first time-based process is active: in accordance with a determination that a set of one or more process-termination criteria are met, wherein the set of one or more process-termination criteria includes a criterion that is met when a predetermined time has elapsed since a third time, terminating the first time-based process; in accordance with a determination that the set of one or more process-termination criteria are not met, maintaining the first time-based process.

In accordance with some embodiments, a transitory computer-readable storage medium is described. The transitory computer-readable storage medium stores one or more programs configured to be executed by one or more processors of a computer system that is in communication with one or more audio detection devices, the one or more programs including instructions for: receiving an indication of an event in response to receiving the indication of the event, initiating a first time-based process, where during the first time-based process, audio data associated with sound captured via the one or more audio detection devices is enabled to be transmitted to an external computer system; at a first time while the first time-based process is active: transmitting the audio data associated with sound captured via the one or more audio detection devices; and outputting feedback indicative of the transmission of the audio data associated with sound captured via the one or more audio detection devices; and at a second time while the first time-based process is active: in accordance with a determination that a set of one or more process-termination criteria are met, wherein the set of one or more process-termination criteria includes a criterion that is met when a predetermined time has elapsed since a third time, terminating the first time-based process; in accordance with a determination that the set of one or more process-termination criteria are not met, maintaining the first time-based process.

In accordance with some embodiments, a computer system is described. The computer system is in communication with one or more audio detection devices. The computer system comprises: one or more processors; and memory storing one or more programs configured to be executed by the one or more processors, the one or more programs including instructions for: receiving an indication of an event; in response to receiving the indication of the event, initiating a first time-based process, where during the first time-based process, audio data associated with sound captured via the one or more audio detection devices is enabled to be transmitted to an external computer system; at a first time while the first time-based process is active: transmitting the audio data associated with sound captured via the one or more audio detection devices; and outputting feedback indicative of the transmission of the audio data associated with sound captured via the one or more audio detection devices; and at a second time while the first time-based process is active: in accordance with a determination that a set of one or more process-termination criteria are met, wherein the set of one or more process-termination criteria includes a criterion that is met when a predetermined time has elapsed since a third time, terminating the first time-based process; in accordance with a determination that the set of one or more process-termination criteria are not met, maintaining the first time-based process.

In accordance with some embodiments, a computer system is described. The computer system is in communication with one or more audio detection devices. The computer system comprises: means for receiving an indication of an event; means for, in response to receiving the indication of the event, initiating a first time-based process, where during the first time-based process, audio data associated with sound captured via the one or more audio detection devices is enabled to be transmitted to an external computer system; means for, at a first time while the first time-based process is active: transmitting the audio data associated with sound captured via the one or more audio detection devices; and outputting feedback indicative of the transmission of the audio data associated with sound captured via the one or more audio detection devices; and means for, at a second time while the first time-based process is active: in accordance with a determination that a set of one or more process-termination criteria are met, wherein the set of one or more process-termination criteria includes a criterion that is met when a predetermined time has elapsed since a third time, terminating the first time-based process; in accordance with a determination that the set of one or more process-termination criteria are not met, maintaining the first time-based process.

In accordance with some embodiments, a computer program product is described. The computer program product comprises one or more programs configured to be executed by one or more processors of a computer system that is in communication with one or more audio detection devices, the one or more programs including instructions for: receiving an indication of an event in response to receiving the indication of the event, initiating a first time-based process, where during the first time-based process, audio data associated with sound captured via the one or more audio detection devices is enabled to be transmitted to an external computer system; at a first time while the first time-based process is active: transmitting the audio data associated with sound captured via the one or more audio detection devices; and outputting feedback indicative of the transmission of the audio data associated with sound captured via the one or more audio detection devices; and at a second time while the first time-based process is active: in accordance with a determination that a set of one or more process-termination criteria are met, wherein the set of one or more process-termination criteria includes a criterion that is met when a predetermined time has elapsed since a third time, terminating the first time-based process; in accordance with a determination that the set of one or more process-termination criteria are not met, maintaining the first time-based process.

In accordance with some embodiments, a method is described. The method is performed at a computer system that is in communication with a display generation component. The method comprises: displaying, via the display generation component, a user interface, the user interface including: a first user interface object that, when selected, modifies the state of a first setting, where the first setting, when in a first state, enables the computer system to report an event based on a sound of a first type that is detected by at least a first external computer system of a set of one or more external computer systems; a second user interface object that, when selected, modifies the state of a second setting, where the second setting, when in a second state, enables the computer system to report an event based on a sound of a second type, different from the first type, that is detected by at least a second external computer system of the set of one or more external computer systems; a third user interface object that, when selected, modifies the state of a third setting, where the third setting, when in a third state, causes a third external computer system to be included in the set of one or more external computer systems; and a fourth user interface object that, when selected, modifies the state of a fourth setting, where the fourth setting, when in a fourth state, causes a fourth external computer system, different from the third external computer system, to be included in the set of one or more external computer systems.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: displaying, via the display generation component, a user interface, the user interface including: a first user interface object that, when selected, modifies the state of a first setting, where the first setting, when in a first state, enables the computer system to report an event based on a sound of a first type that is detected by at least a first external computer system of a set of one or more external computer systems; a second user interface object that, when selected, modifies the state of a second setting, where the second setting, when in a second state, enables the computer system to report an event based on a sound of a second type, different from the first type, that is detected by at least a second external computer system of the set of one or more external computer systems; a third user interface object that, when selected, modifies the state of a third setting, where the third setting, when in a third state, causes a third external computer system to be included in the set of one or more external computer systems; and a fourth user interface object that, when selected, modifies the state of a fourth setting, where the fourth setting, when in a fourth state, causes a fourth external computer system, different from the third external computer system, to be included in the set of one or more external computer systems.

In accordance with some embodiments, a transitory computer-readable storage medium is described. The transitory computer-readable storage medium stores one or more programs configured to be executed by one or more processors of a computer system that is in communication with a display generation component, the one or more programs including instructions for: displaying, via the display generation component, a user interface, the user interface including: a first user interface object that, when selected, modifies the state of a first setting, where the first setting, when in a first state, enables the computer system to report an event based on a sound of a first type that is detected by at least a first external computer system of a set of one or more external computer systems; a second user interface object that, when selected, modifies the state of a second setting, where the second setting, when in a second state, enables the computer system to report an event based on a sound of a second type, different from the first type, that is detected by at least a second external computer system of the set of one or more external computer systems; a third user interface object that, when selected, modifies the state of a third setting, where the third setting, when in a third state, causes a third external computer system to be included in the set of one or more external computer systems; and a fourth user interface object that, when selected, modifies the state of a fourth setting, where the fourth setting, when in a fourth state, causes a fourth external computer system, different from the third external computer system, to be included in the set of one or more external computer systems.

In accordance with some embodiments, a computer system is described. The computer system is in communication with a display generation component. The computer system comprises: one or more processors; and memory storing one or more programs configured to be executed by the one or more processors, the one or more programs including instructions for: displaying, via the display generation component, a user interface, the user interface including: a first user interface object that, when selected, modifies the state of a first setting, where the first setting, when in a first state, enables the computer system to report an event based on a sound of a first type that is detected by at least a first external computer system of a set of one or more external computer systems; a second user interface object that, when selected, modifies the state of a second setting, where the second setting, when in a second state, enables the computer system to report an event based on a sound of a second type, different from the first type, that is detected by at least a second external computer system of the set of one or more external computer systems; a third user interface object that, when selected, modifies the state of a third setting, where the third setting, when in a third state, causes a third external computer system to be included in the set of one or more external computer systems; and a fourth user interface object that, when selected, modifies the state of a fourth setting, where the fourth setting, when in a fourth state, causes a fourth external computer system, different from the third external computer system, to be included in the set of one or more external computer systems.

In accordance with some embodiments, a computer system is described. The computer system is in communication with a display generation component. The computer system comprises: means for displaying, via the display generation component, a user interface, the user interface including: a first user interface object that, when selected, modifies the state of a first setting, where the first setting, when in a first state, enables the computer system to report an event based on a sound of a first type that is detected by at least a first external computer system of a set of one or more external computer systems; a second user interface object that, when selected, modifies the state of a second setting, where the second setting, when in a second state, enables the computer system to report an event based on a sound of a second type, different from the first type, that is detected by at least a second external computer system of the set of one or more external computer systems; a third user interface object that, when selected, modifies the state of a third setting, where the third setting, when in a third state, causes a third external computer system to be included in the set of one or more external computer systems; and a fourth user interface object that, when selected, modifies the state of a fourth setting, where the fourth setting, when in a fourth state, causes a fourth external computer system, different from the third external computer system, to be included in the set of one or more external computer systems.

In accordance with some embodiments, a computer program product is described. The computer program product comprises one or more programs configured to be executed by one or more processors of a computer system that is in communication with a display generation component, the one or more programs including instructions for: displaying, via the display generation component, a user interface, the user interface including: a first user interface object that, when selected, modifies the state of a first setting, where the first setting, when in a first state, enables the computer system to report an event based on a sound of a first type that is detected by at least a first external computer system of a set of one or more external computer systems; a second user interface object that, when selected, modifies the state of a second setting, where the second setting, when in a second state, enables the computer system to report an event based on a sound of a second type, different from the first type, that is detected by at least a second external computer system of the set of one or more external computer systems; a third user interface object that, when selected, modifies the state of a third setting, where the third setting, when in a third state, causes a third external computer system to be included in the set of one or more external computer systems; and a fourth user interface object that, when selected, modifies the state of a fourth setting, where the fourth setting, when in a fourth state, causes a fourth external computer system, different from the third external computer system, to be included in the set of one or more external computer systems.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing a time-based event, thereby increasing the effectiveness, efficiency, and user satisfaction with such devices. Such methods and interfaces may complement or replace other methods for managing a time-based event.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C illustrates an electronic device in accordance with some embodiments.

FIG. 5D is a block diagram illustrating an electronic device in accordance with some embodiments.

FIGS. 6A-6M illustrate exemplary user interfaces for managing a time-based event, in accordance with some embodiments.

FIG. 7 is a flow diagram illustrating methods of initiating a time-based event that includes outputting captured audio, in accordance with some embodiments.

FIG. 8 is a flow diagram illustrating methods of initiating a time-based event that includes transmitting captured audio, in accordance with some embodiments.

FIGS. 9A-9G illustrate exemplary user interfaces for configuring a device to initiate a time-based event, in accordance with some embodiments.

FIG. 10 is a flow diagram illustrating methods of configuring a device to initiate a time-based event, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing a time-based event. For example, there is a need for electronic devices that increase security and/or privacy for users of electronic devices by establishing communication with an external device for a finite amount of time. As another example, there is a need for electronic devices that are able to configure external devices to detect one or more security events and/or to enable communication with the electronic device to be initiated and/or established when a security event is detected. Such techniques can reduce the cognitive burden on a user who manages a time-based event, thereby enhancing productivity. Further, such techniques can reduce processor and battery power otherwise wasted on redundant user inputs.

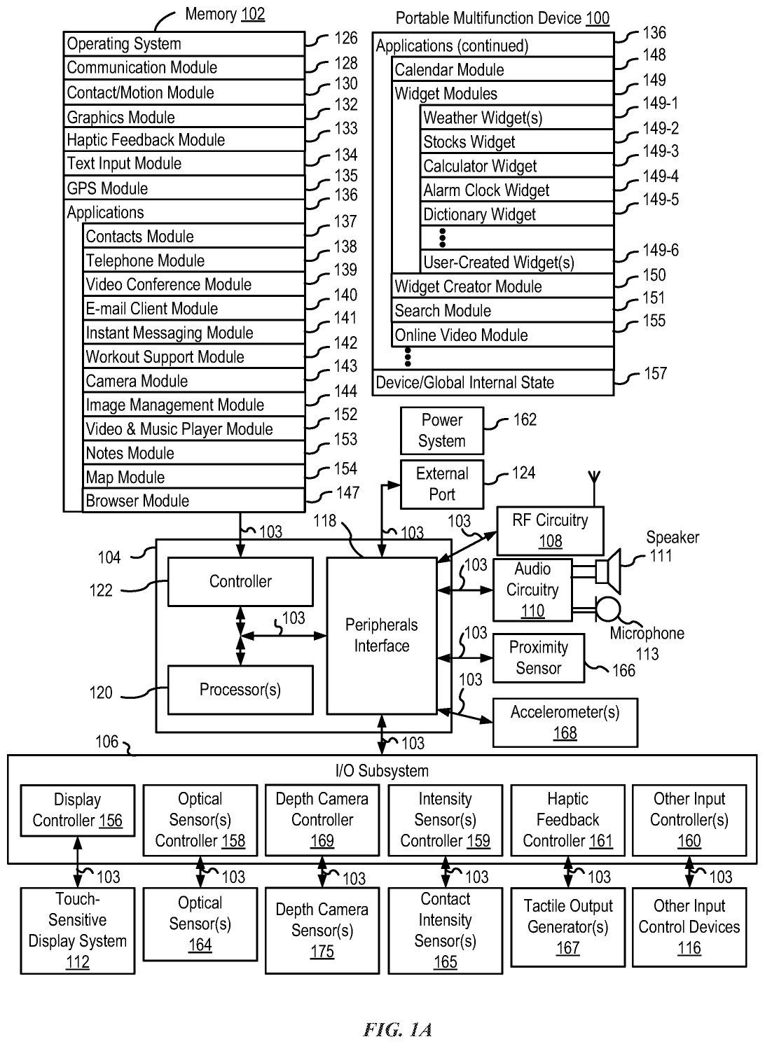

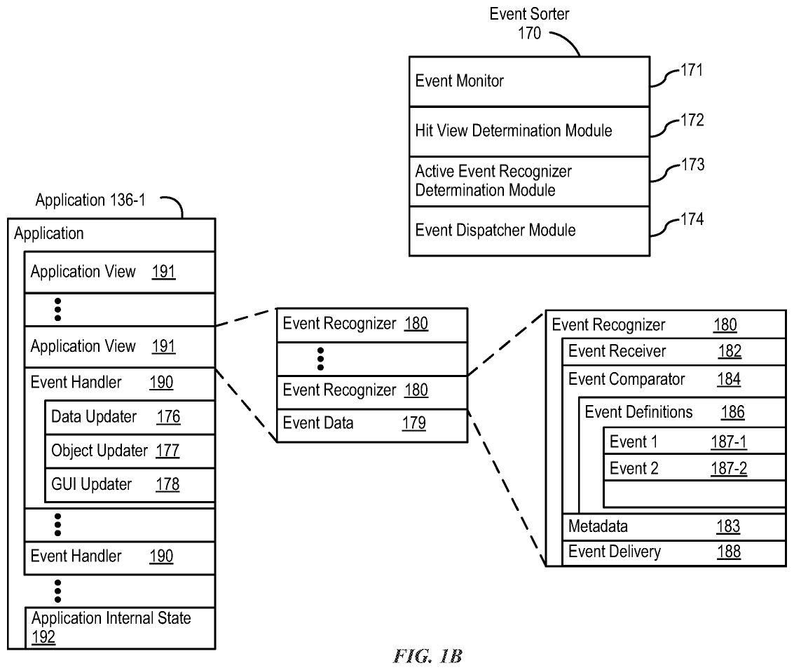

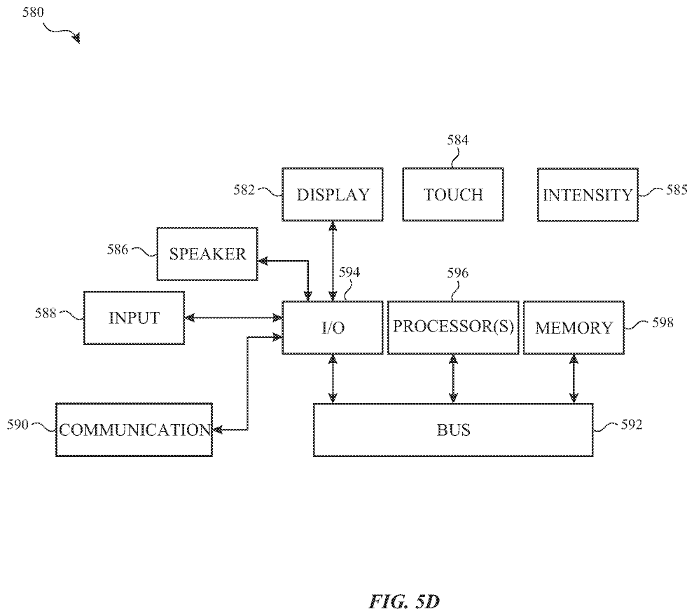

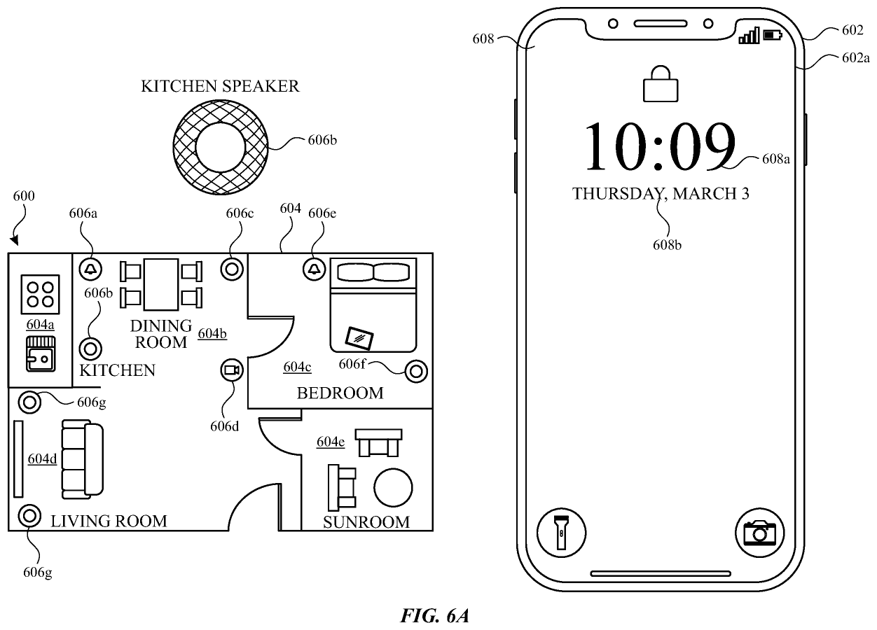

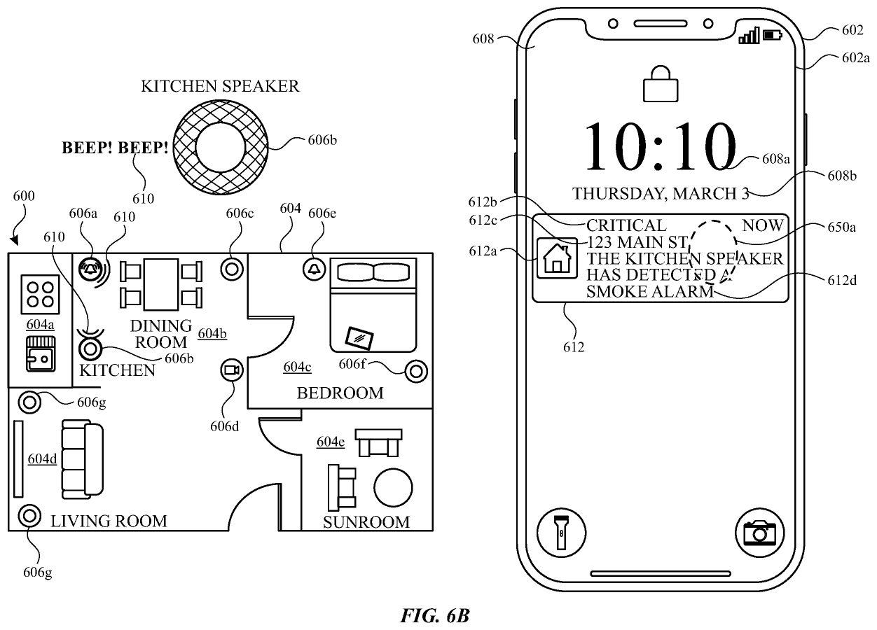

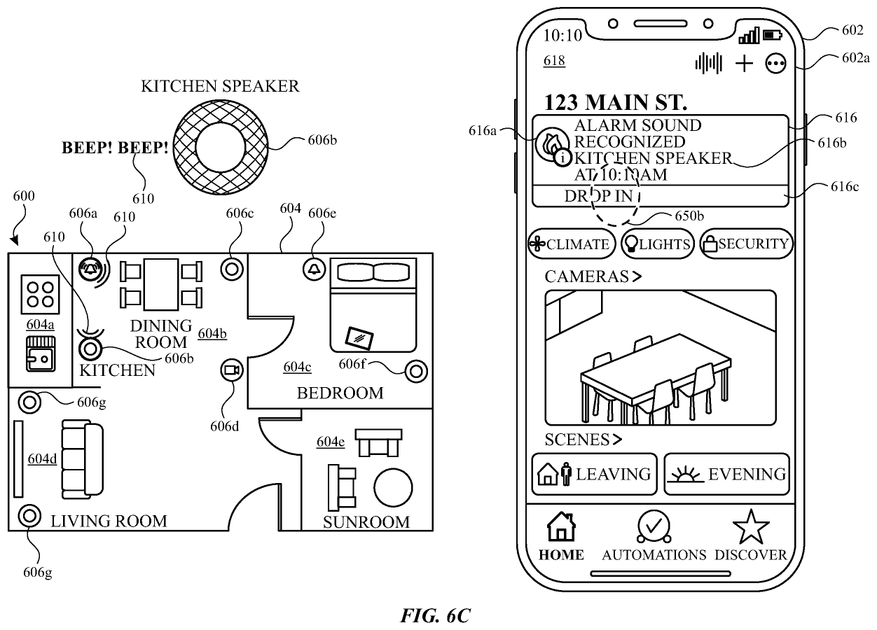

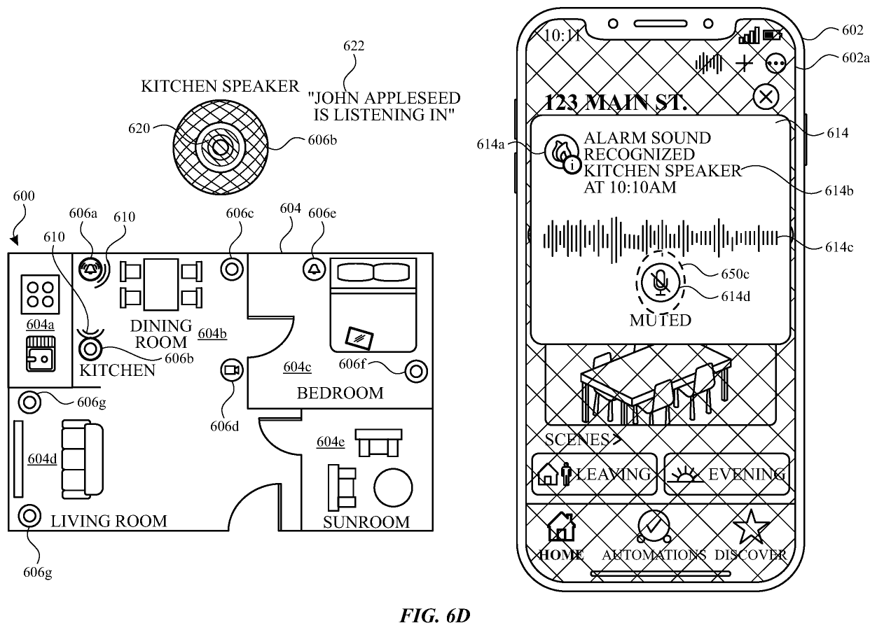

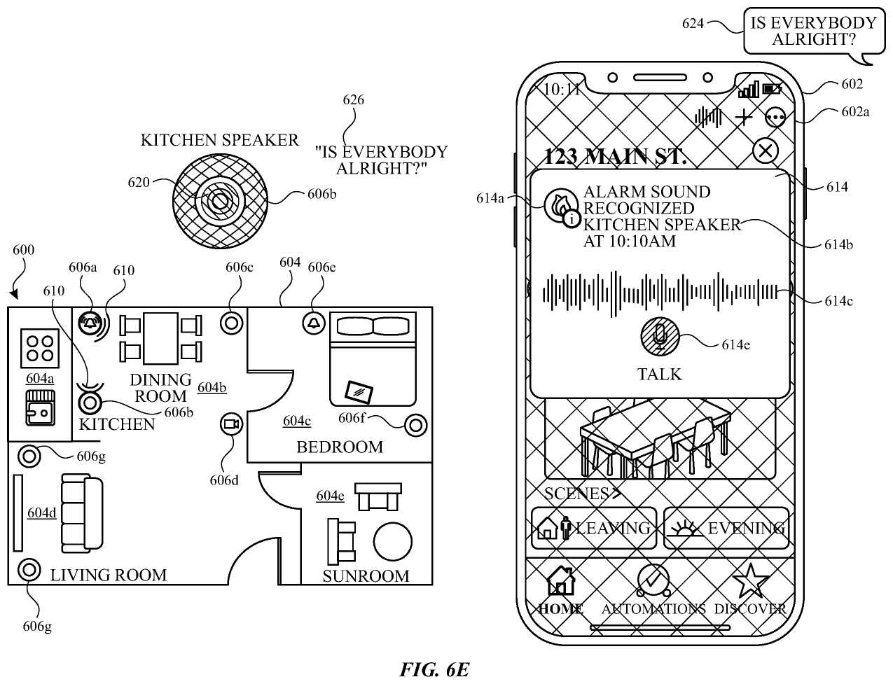

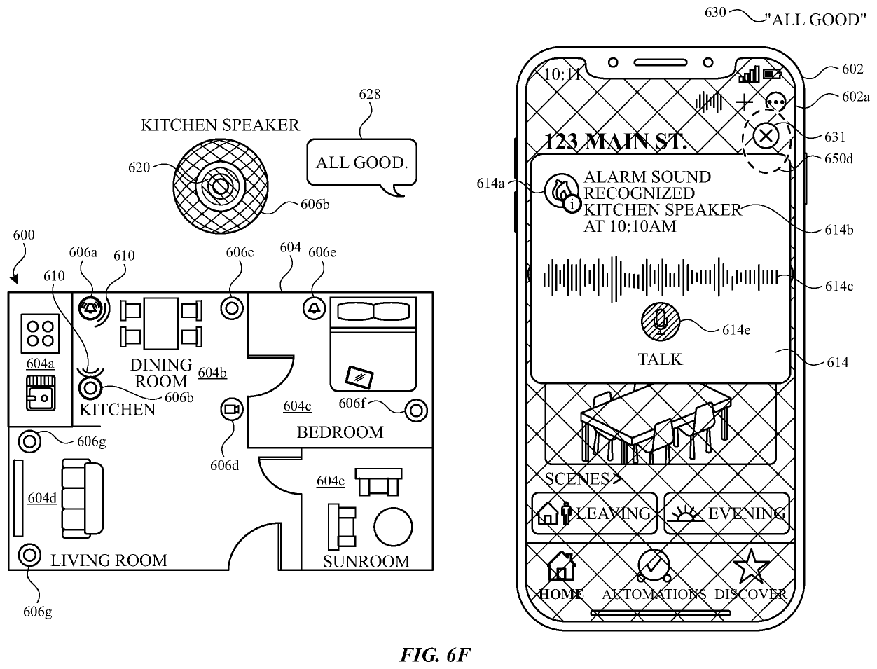

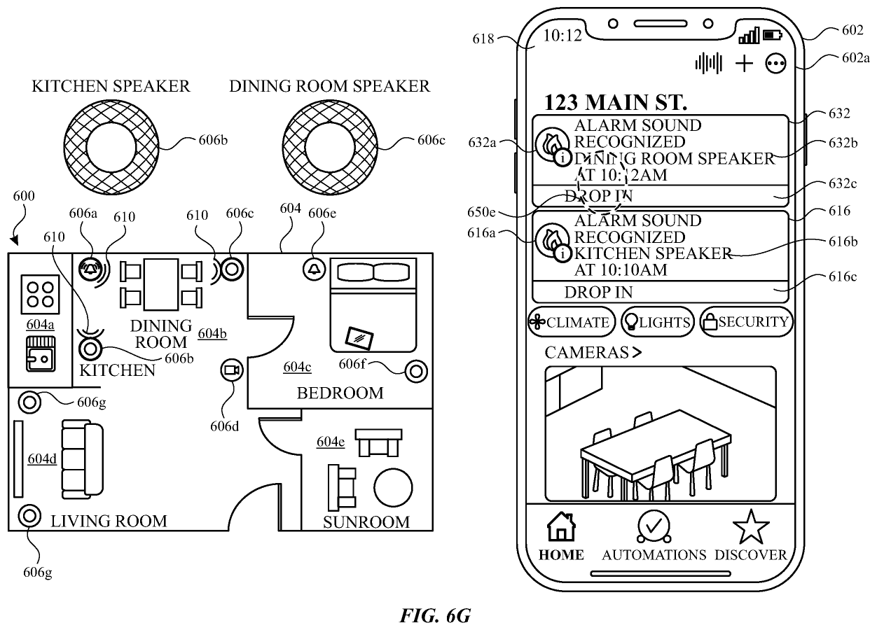

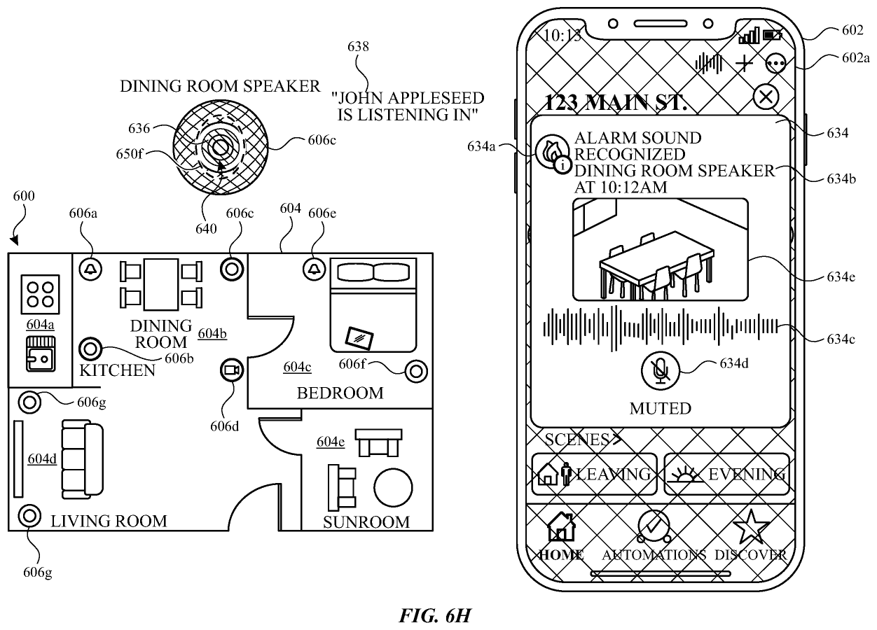

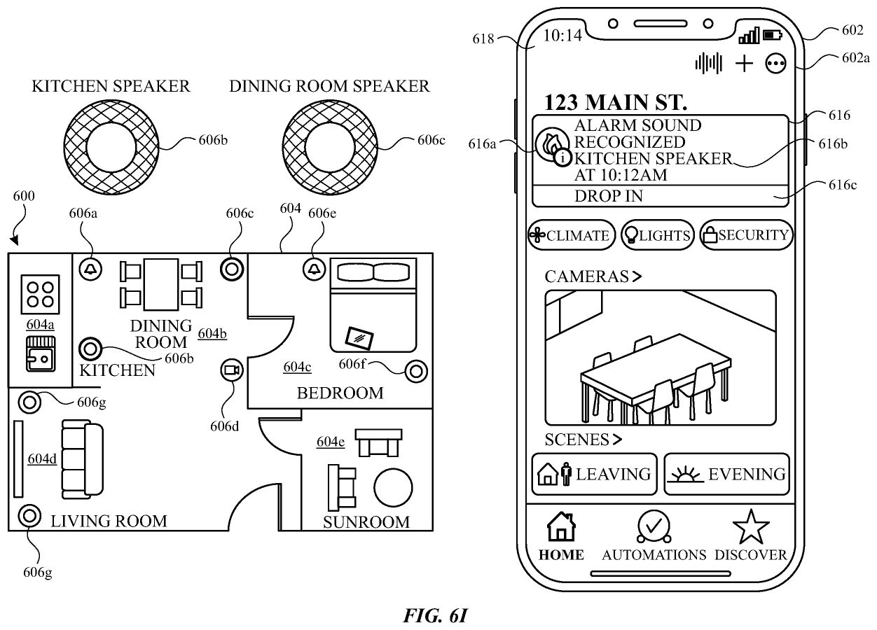

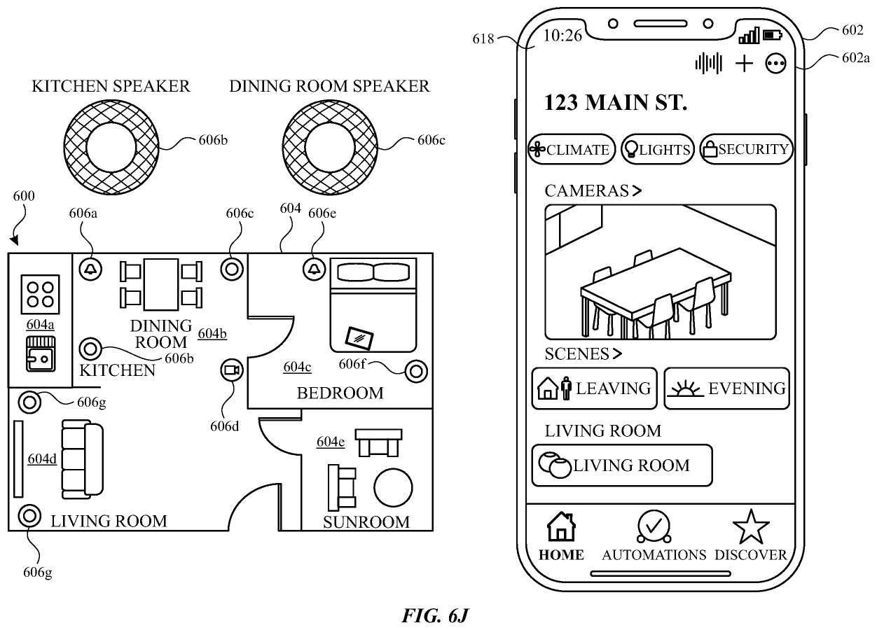

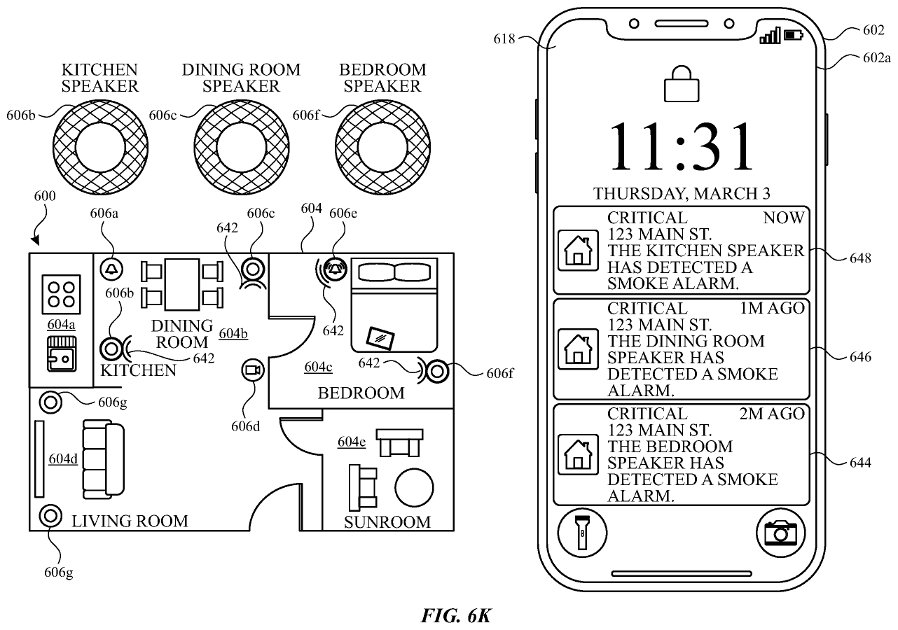

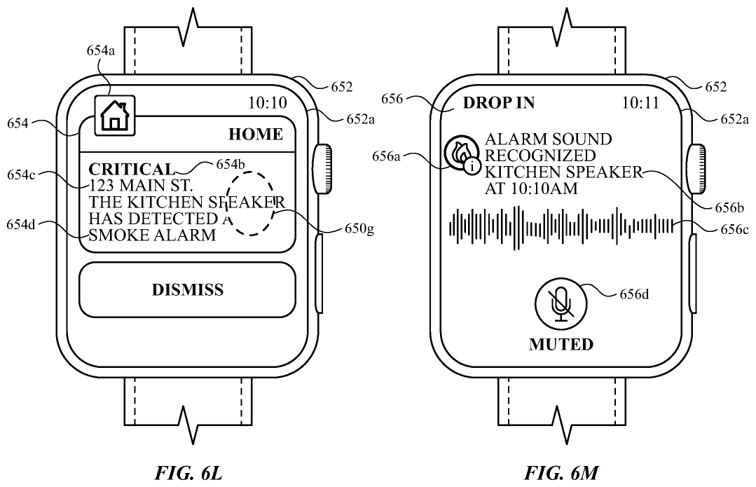

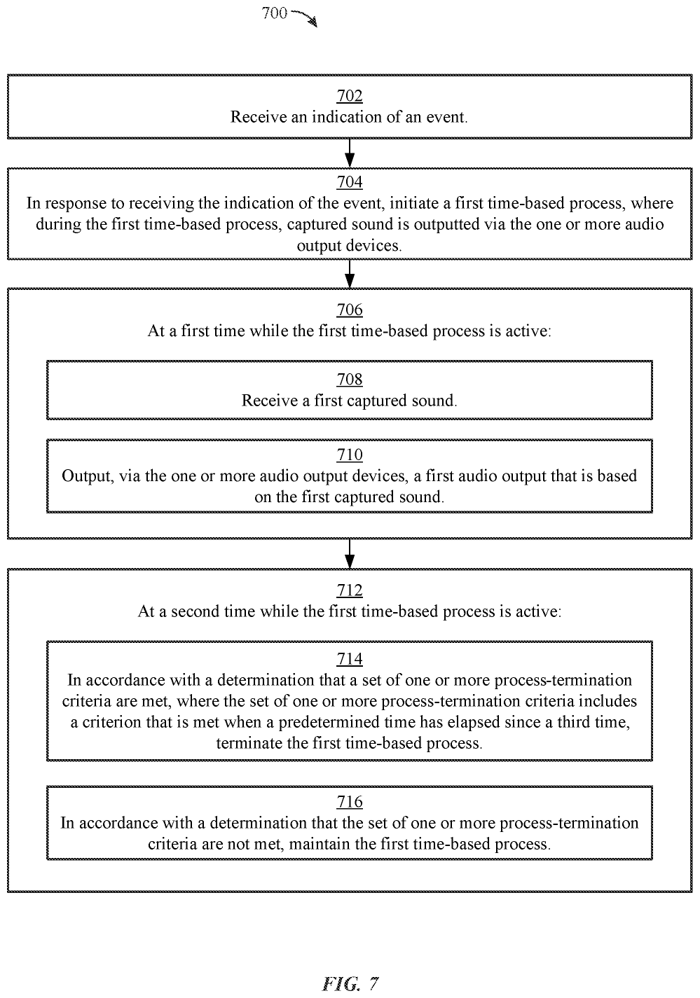

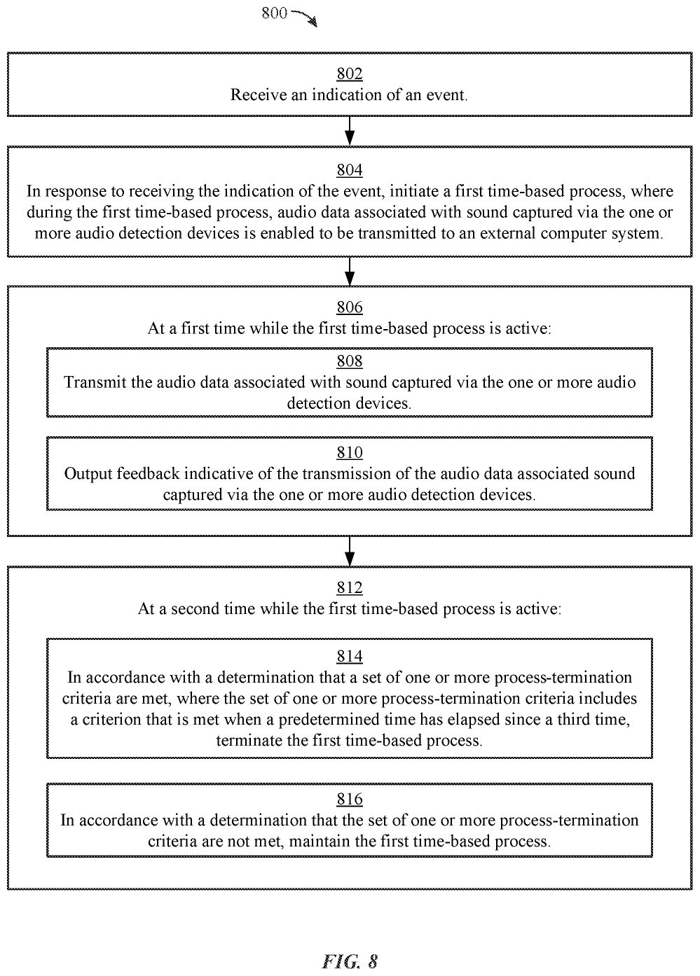

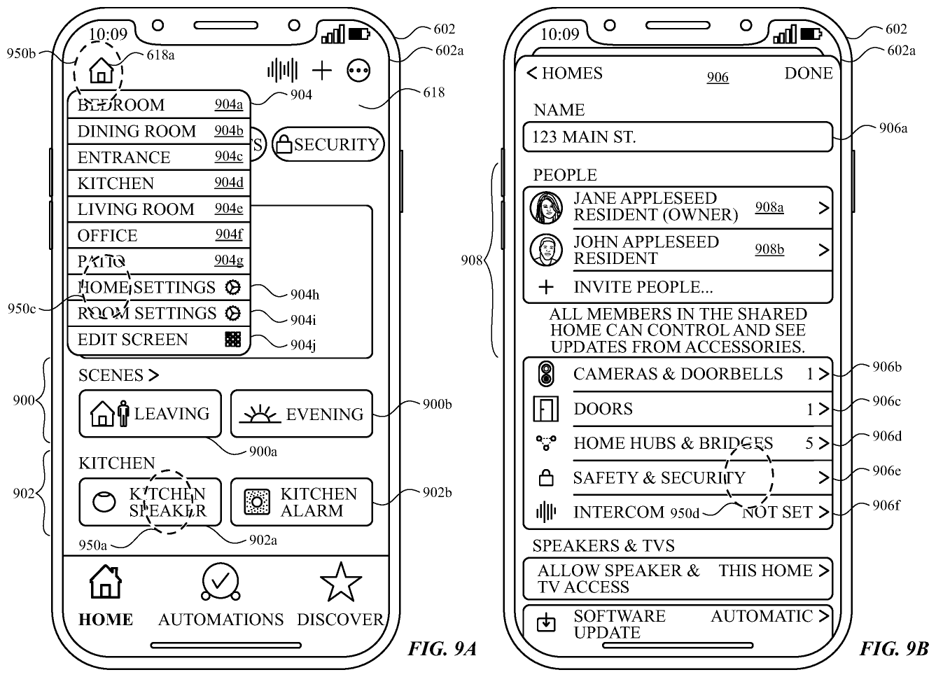

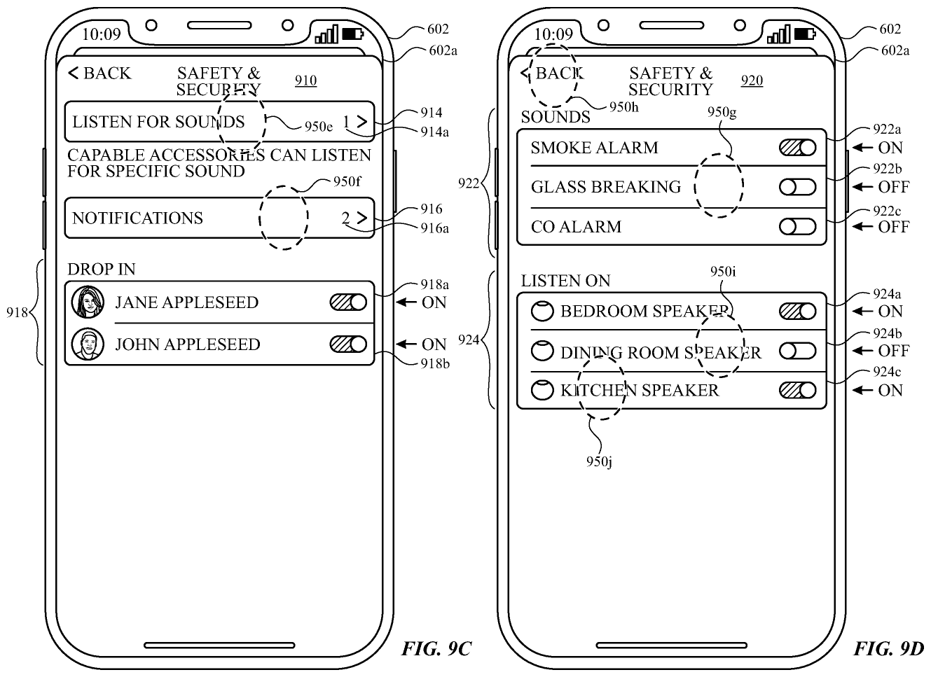

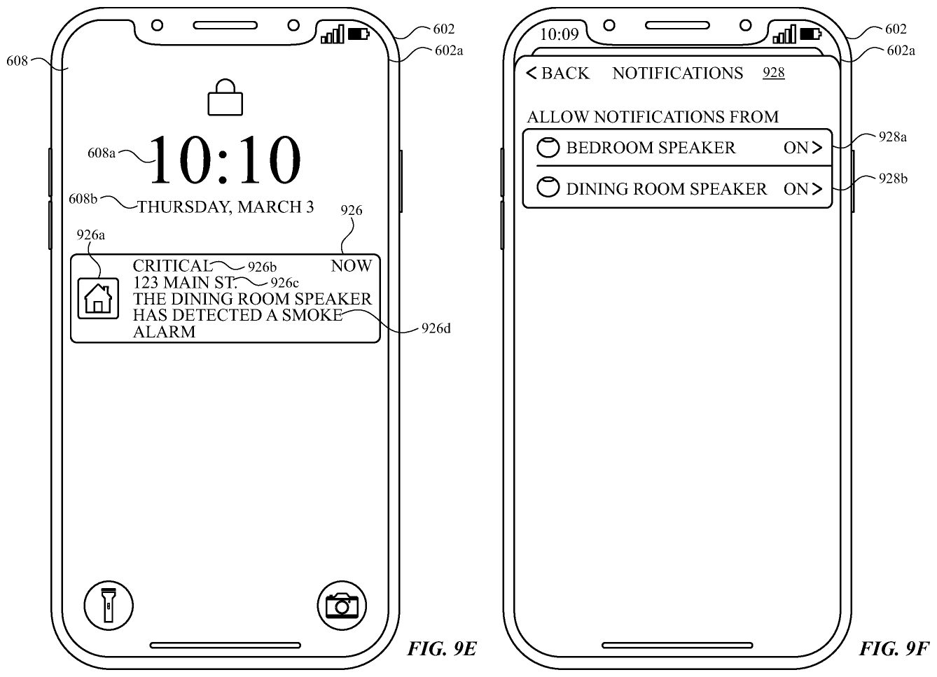

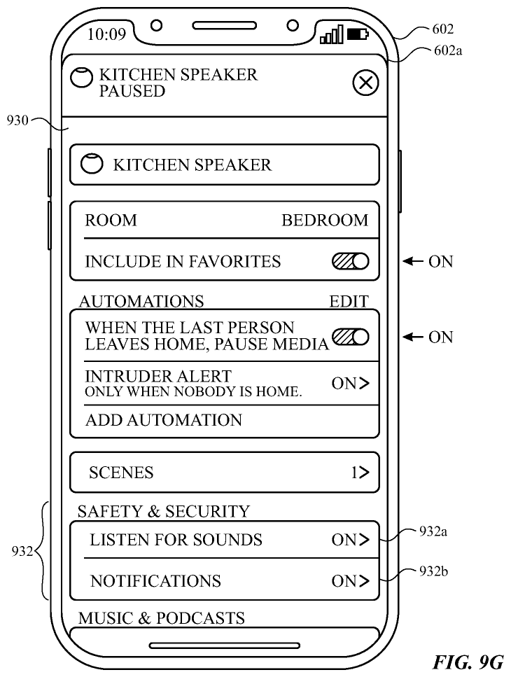

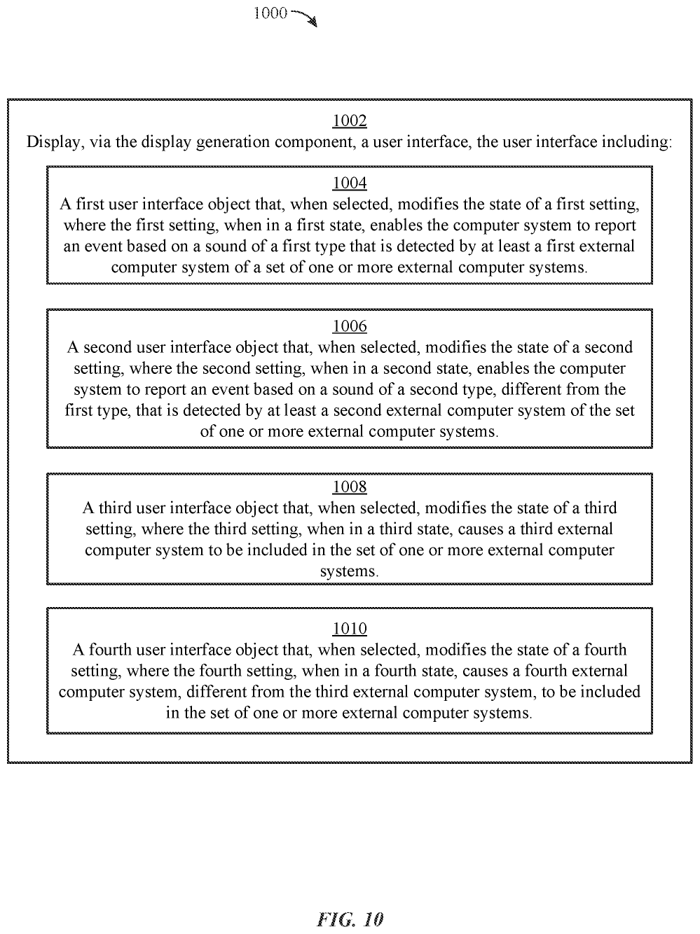

Below, FIGS. 1A-1B, 2, 3, 4A-4B, and 5A-5D provide a description of exemplary devices for performing the techniques for managing time-based events. FIGS. 6A-6M illustrate exemplary user interfaces for managing a time-based event. FIG. 7 is a flow diagram illustrating methods of initiating a time-based event that includes outputting captured audio in accordance with some embodiments. FIG. 8 is a flow diagram illustrating methods of initiating a time-based event that includes transmitting captured audio in accordance with some embodiments. The user interfaces in FIGS. 6A-6M are used to illustrate the processes described below, including the processes in FIGS. 7 and 8. FIGS. 9A-9G illustrate exemplary user interfaces for configuring a device to initiate a time-based event. FIG. 10 is a flow diagram illustrating methods of configuring a device to initiate a time-based event in accordance with some embodiments. The user interfaces in FIGS. 9A-9G are used to illustrate the processes described below, including the processes in FIG. 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, increasing privacy and/or security, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

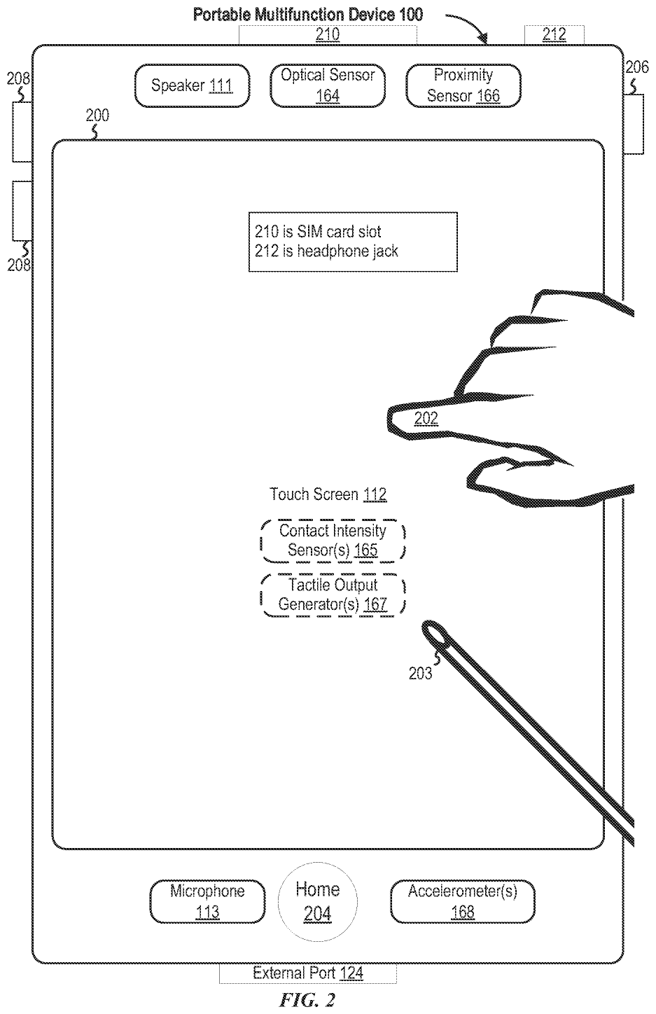

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

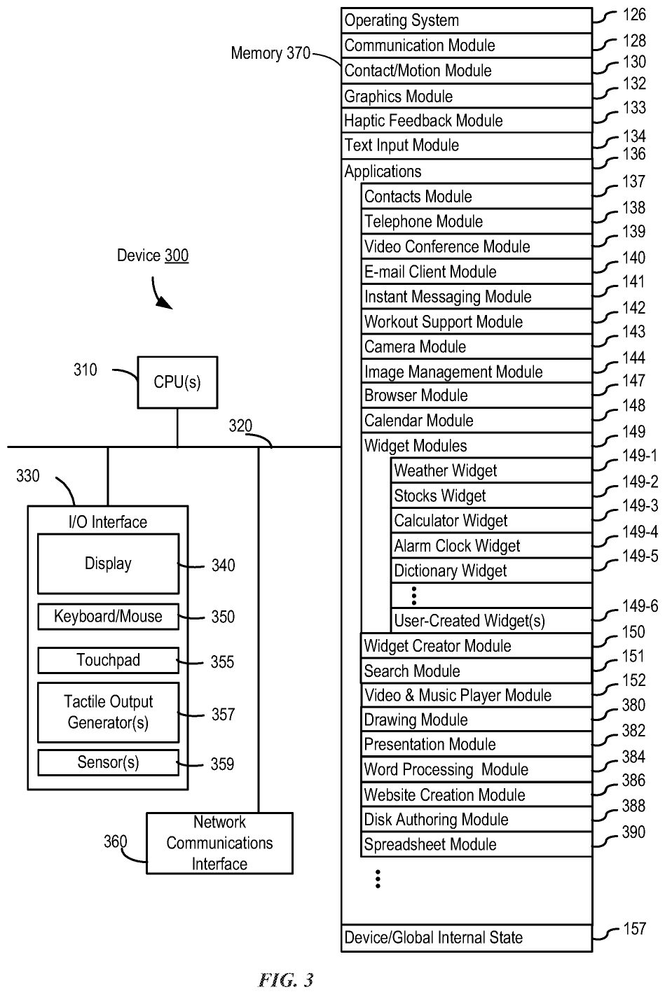

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

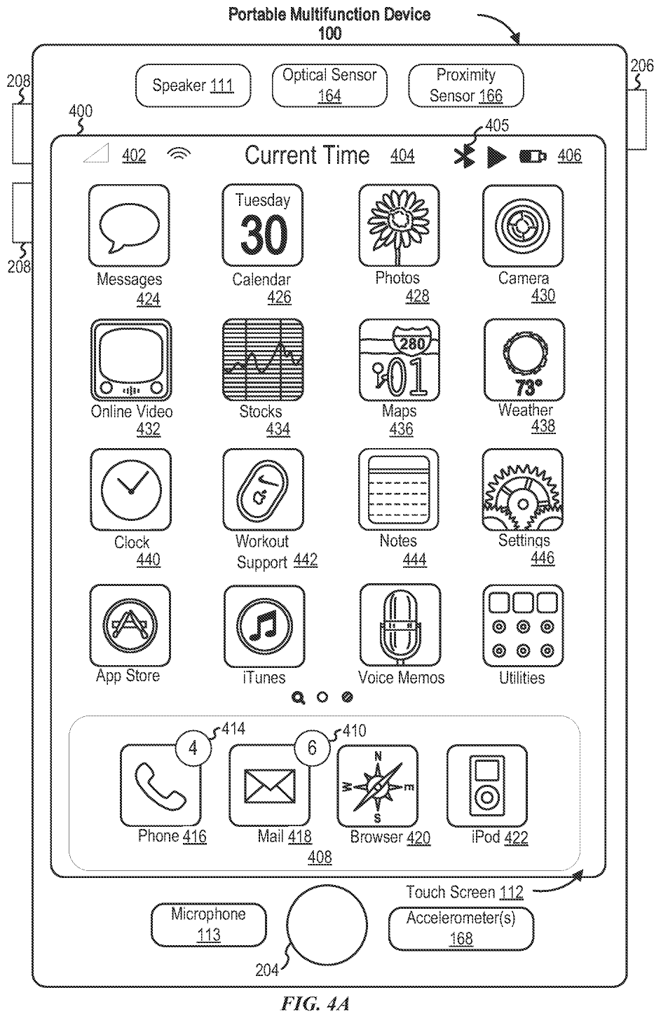

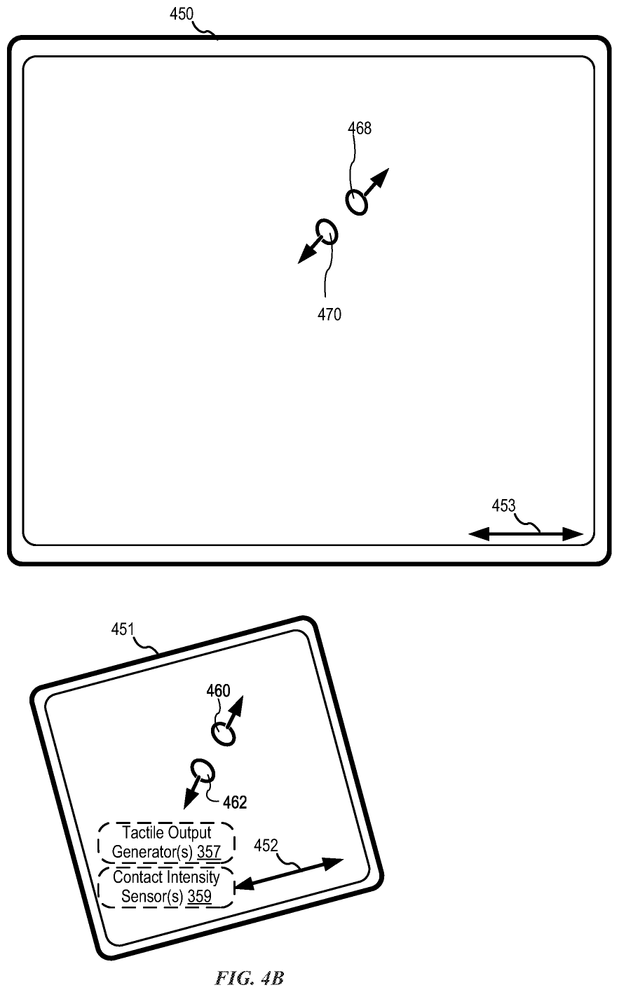

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

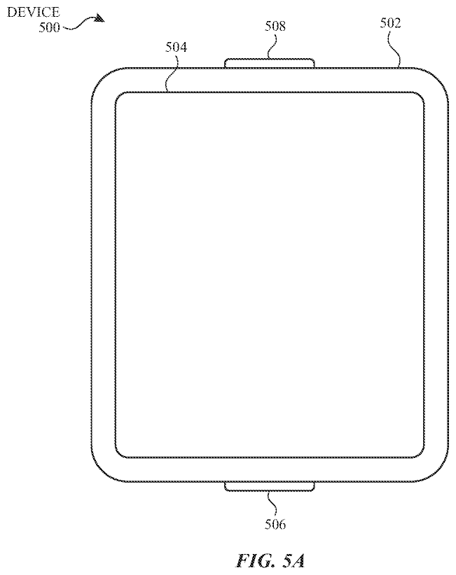

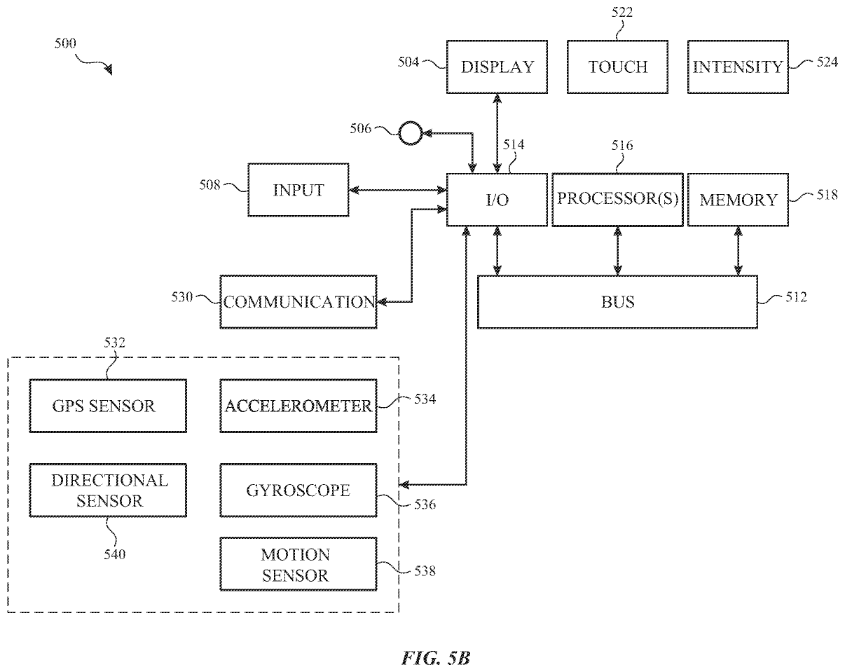

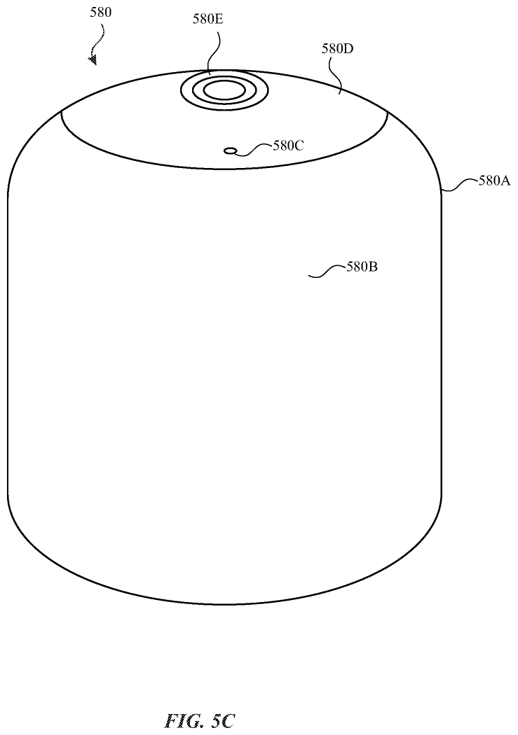

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 800, and/or 1000 (FIGS. 7, 8, and 10). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates exemplary electronic device 580. Device 580 includes body 580A. In some embodiments, device 580 can include some or all of the features described with respect to devices 100, 300, and 500 (e.g., FIGS. 1A-5B). In some embodiments, device 580 has one or more speakers 580B (concealed in body 580A), one or more microphones 580C, one or more touch-sensitive surfaces 580D, and one or more displays 580E. Alternatively, or in addition to a display and touch-sensitive surface 580D, the device has a touch-sensitive display (also referred to as a touchscreen). As with devices 100, 300, and 500, in some embodiments, touch-sensitive surface 580D (or the touch screen) optionally includes one or more intensity sensors for detecting intensity of contacts (e.g., touches) being applied. The one or more intensity sensors of touch-sensitive surface 580D (or the touchscreen) can provide output data that represents the intensity of touches. The user interface of device 580 can respond to touches based on their intensity, meaning that touches of different intensities can invoke different user interface operations on device 580. In some embodiments, the one or more displays 580E are one or more light-emitting diodes (LEDs). For example, a display can be a single LED, an LED cluster (e.g., a red, a green, and a blue LED), a plurality of discrete LEDs, a plurality of discrete LED clusters, or other arrangement of one or more LEDs. For example, the display 580E can be an array of nine discrete LED clusters arranged in a circular shape (e.g., a ring). In some examples, the one or more displays are comprised of one or more of another type of light-emitting elements.

FIG. 5D depicts exemplary personal electronic device 580. In some embodiments, device 580 can include some or all of the components described with respect to FIGS. 1A, 1B, 3, and 5A-5B. Device 580 has bus 592 that operatively couples I/O section 594 with one or more computer processors 596 and memory 598. I/O section 594 can be connected to display 582, which can have touch-sensitive component 584 and, optionally, intensity sensor 585 (e.g., contact intensity sensor). In some embodiments, touch-sensitive component 584 is a separate component than display 582. In addition, I/O section 594 can be connected with communication unit 590 for receiving application and operating system data, using Wi-Fi, Bluetooth, near field communication (NFC), cellular, and/or other wireless communication techniques. Device 580 can include input mechanisms 588. Input mechanism 588 is, optionally, a button, in some examples. Input mechanism 588 is, optionally, a microphone, in some examples. Input mechanism 588 is, optionally, a plurality of microphones (e.g., a microphone array).

Electronic device 580 includes speaker 586 for outputting audio. Device 580 can include audio circuitry (e.g., in I/O section 594) that receives audio data, converts the audio data to an electrical signal, and transmits the electrical signal to speaker 586. Speaker 586 converts the electrical signal to human-audible sound waves. The audio circuitry (e.g., in I/O section 594) also receives electrical signals converted by a microphone (e.g., input mechanism 588) from sound waves. The audio circuitry (e.g., in I/O section 594) converts the electrical signal to audio data. Audio data is, optionally, retrieved from and/or transmitted to memory 598 and/or RF circuitry (e.g., in communication unit 590) by I/O section 594.

Memory 598 of personal electronic device 580 can include one or more non-transitory computer-readable storage mediums, for storing computer-executable instructions, which, when executed by one or more computer processors 596, for example, can cause the computer processors to perform the techniques described below, including processes 700, 800, and/or 1000 (FIGS. 7, 8, and 10). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 580 is not limited to the components and configuration of FIG. but can include other or additional components in multiple configurations.

Attention is now directed towards embodiments of user interfaces (“UP”) and associated processes that are implemented on an electronic device, such as portable multifunction device 100, device 300, or device 500.

FIGS. 6A-6M illustrate exemplary user interfaces for managing a time-based event, in accordance with some embodiments. The user interfaces in these figures are used to illustrate the processes described below, including the processes in FIGS. 7 and 8.

FIGS. 6A-6M include diagram 600 illustrating a physical structure and an exemplary set of devices, in accordance with some embodiments. At FIGS. 6A-6M, diagram 600 is provided for a more complete understanding, but is not part of the user interfaces displayed via electronic device 602 and/or electronic device 652. In some embodiments, electronic device 602 and/or electronic device 652 include one or more features of electronic devices 100, 300, and/or 500. Diagram 600 includes home 604 and a set of devices. The set of devices include kitchen sensor 606a, kitchen speaker 606b, dining room speaker 606c, dining room camera 606d, bedroom sensor 606e, bedroom speaker 606f, and living room speakers 606g. In some embodiments, kitchen speaker 606b, dining room speaker 606c, bedroom speaker 606f, and/or living room speakers 606g include one or more features of electronic devices 100, 300, 500, and/or 580.

As set forth below, electronic device 602 displays user interfaces that enable communication between electronic device 602 (and, optionally, another electronic device (e.g., electronic device 652)) and one or more devices of the set of devices of home 604 when an event occurs within home 604. For instance, in some embodiments, electronic device 602 displays user interfaces that enable electronic device to output audio that is based on sound captured by kitchen speaker 606b, dining room speaker 606c, bedroom speaker 606f, and/or living room speakers 606g. In some embodiments, kitchen speaker 606b, dining room speaker 606c, bedroom speaker 606f, and/or living room speakers 606g are configured to detect one or more predetermined sounds and/or noise within home 604 that are indicative of a predefined event, such as an event that is related to safety and/or security of home 604. In some embodiments, kitchen speaker 606b, dining room speaker 606c, bedroom speaker 606f, and/or living room speakers 606g detect sound indicative of kitchen sensor 606a and/or bedroom sensor 606e being activated and/or triggered. In some embodiments, kitchen sensor 606a and/or bedroom sensor 606e include a smoke alarm, a carbon monoxide detector, a security alarm, a glass breaking sensor, and/or a baby monitor. In some embodiments, kitchen sensor 606a and/or bedroom sensor 606e are in communication with kitchen speaker 606b, dining room speaker 606c, bedroom speaker 606f, and/or living room speakers 606g and provide (e.g., transmit and/or otherwise direct) information indicative of kitchen sensor 606a and/or bedroom sensor 606e activating and/or detecting an event to kitchen speaker 606b, dining room speaker 606c, bedroom speaker 606f, and/or living room speakers 606g. As such, kitchen speaker 606b, dining room speaker 606c, bedroom speaker 606f, and/or living room speakers 606g are configured to detect the event via detection of sound and/or noise output via kitchen sensor 606a and/or bedroom sensor 606e and/or via information received from kitchen sensor 606a and/or bedroom sensor 606e.

As set forth in detail below, after one or more of the devices of the set of devices of home 604 detect an event, a time-based process is initiated. The time-based process allows one or more of the devices of the set of devices of home 604 to transmit and/or provide audio data to one or more external devices (e.g., one or more devices that are remote from home 604, such as electronic device 602 and/or electronic device 652), where the audio data is based on sound and/or noise captured by the one or more devices. The external device is configured to output audio that is based on the sound captured by the one or more devices so that a user that is not present and/or located in home 604 can obtain additional information about the detected event. The time-based process is configured to last for a predefined amount of time so that the user of the external device cannot cause the external device to output the audio based on the captured sound after the predefined amount of time has expired. In some embodiments, the predefined amount of time begins and/or starts to elapse at a time when the event is detected (e.g., detected by kitchen speaker 606b, dining room speaker 606c, bedroom speaker 606f, and/or living room speakers 606g), a time at which audio based on the captured sound is output by an external device (e.g., electronic device 602), and/or a time at which sound associated with the event was last detected (e.g., detected by kitchen speaker 606b, dining room speaker 606c, bedroom speaker 606f, and/or living room speakers 606g). In some embodiments, the predefined amount of time is fifteen minutes. In some embodiments, the predefined amount of time continues to elapse even after sound associated with the event is no longer outputted and/or no longer detected (e.g., detected by kitchen speaker 606b, dining room speaker 606c, bedroom speaker 606f, and/or living room speakers 606g). In some embodiments, the predefined amount of time stops and/or the time-based process ceases in response to detecting one or more user inputs (e.g., one or more user inputs detected by kitchen speaker 606b, dining room speaker 606c, bedroom speaker 606f, living room speakers 606g, and/or electronic device 602).

In some embodiments, each of the devices of the set of devices are smart devices that are directly connected to one or more other devices (e.g., of the set) or indirectly connected to one or more other devices via one or more networks (e.g., wireless networks (e.g., Bluetooth, NFC, Wi-Fi, 4G)). In some embodiments, each of the devices of the set of devices are directly connected to electronic device 602 and/or are indirectly connected to electronic device 602 via one or more networks (e.g., wireless networks (e.g., Bluetooth, NFC, Wi-Fi, 4G)). Accordingly, in response to detecting a predetermined event, one or more of the devices of the set of devices are configured to provide an indication of the predetermined event to electronic device 602.

At FIGS. 6A-6M, home 604 includes kitchen 604a, dining room 604b, bedroom 604c, living room 604d, and sunroom 604e. Kitchen 604a is in the upper left portion of home 604 and dining room 604b is between kitchen 604a and bedroom 604c, where bedroom 604c is to the right of dining room 604b. Living room 604d is in the bottom left portion of home 604 and sunroom 604e is in the bottom right portion of home 604. In some embodiments, home 604 includes other rooms than those depicted in FIGS. 6A-6M and/or excludes rooms that are depicted in FIGS. 6A-6M. While diagram 600 depicts a home, it should be recognized that this is merely an example and techniques described herein can work with other types of physical structures, such as an office building, a hotel, an apartment, etc.

At FIGS. 6A-6M, kitchen sensor 606a and kitchen speaker 606b are included in kitchen 604a. Dining room speaker 606c and dining room camera 606d are included in dining room 604b. Bedroom sensor 606e and bedroom speaker 606f are included in bedroom 604c. Living room speakers 606g are included in living room 604d. In some embodiments, each device of the set of devices are assigned to (e.g., designated to) a room in which it is included. For example, dining room speaker 606c and dining room camera 606d are assigned to (e.g., programmatically mapped to a group that corresponds to) dining room 604b. In some embodiments, a respective device of the set of devices cannot be assigned to two different rooms of home 604. Further, in some embodiments, each group of devices that correspond to each room are also assigned to home 604. Thus, devices that are mapped to a room of home 604 are also concurrently mapped to home 604.

FIG. 6A illustrates electronic device 602 displaying, via display 602a, first user interface 608 at a first time (e.g., 10:09). First user interface 608 is a home screen and/or lock screen of electronic device 602. In some embodiments, the home screen and/or lock screen is displayed by electronic device 602 based on detecting an absence of user input, detecting one or more predetermined user inputs, and/or after powering on electronic device 602. At FIG. 6A, first user interface 608 includes time indicator 608a and date indicator 608b. In some embodiments, electronic device 602 prompts a user to provide authentication to transition from displaying first user interface 608 to displaying another user interface (e.g., a user interface associated with a normal mode of operation of electronic device 602).

At FIG. 6A, diagram 600 illustrates that both kitchen sensor 606a and bedroom sensor 606e are not activated and/or have not detected an event, such as smoke in home 604, carbon monoxide in home 604, glass breaking in home 604, and/or a baby crying in home 604, at the first time (e.g., 10:09). At FIG. 6A, kitchen speaker 606b is also shown as being in an idle state at the first time (e.g., 10:09), thereby indicating that kitchen speaker 606b is not transmitting sound captured in home 604 (e.g., in kitchen 604a) to electronic device 602 and/or another external electronic device.

At FIG. 6B, diagram illustrates that an event has occurred and was detected by kitchen sensor 606a at a second time (e.g., 10:10) after the first time (e.g., 10:09). For instance, at FIG. 6B, kitchen sensor 606a outputs sound 610 indicating that kitchen sensor 606a has detected an event, such as the presence of smoke, the presence of carbon dioxide, glass breaking, and/or a baby crying. Kitchen speaker 606b detects sound 610 and/or receives an indication from kitchen sensor 606a that the event was detected by kitchen sensor 606a. At FIG. 6B, kitchen speaker 606b is in communication with electronic device 602 via one or more networks, and kitchen speaker 606b provides an indication of the event to electronic device 602.

In some embodiments, when kitchen speaker 606b detects sound 610, kitchen speaker 606b (and/or another electronic device, such as electronic device 602) can request information from other devices (e.g., kitchen sensor 606a, dining room speaker 606c, dining room camera 606d, bedroom sensor 606e, bedroom speaker 606f, and/or living room speakers 606g) to confirm that an event has occurred and/or to obtain additional information about the event. For instance, in some embodiments, kitchen speaker 606b requests information from dining room speaker 606c to determine whether dining room speaker 606c is detecting and/or detected sound 610. As another example, in some embodiments, kitchen speaker 606b requests information from dining room camera 606d to determine whether an image captured by dining room camera 606d indicates that smoke is present in home 604 and/or an intruder is present in home 604. In some embodiment, after receiving information from one or more devices of home 604, kitchen speaker 606b (and/or another electronic device) can determine whether to perform an action based on the event and/or the information from the one or more devices of home 604. For instance, when kitchen speaker 606b (and/or another electronic device) determines that a large amount of smoke is present in home 604, kitchen speaker 606b can initiate a phone call to an emergency service (e.g., 911) and/or to an emergency contact associated with home 604 (e.g., an emergency contact associated with the home automation system). Accordingly, kitchen speaker 606b and/or other devices of home 604 can perform actions after detecting the event and/or after receiving additional information that can mitigate the effects of the event.

In some embodiments, after detecting sound 610, kitchen speaker 606b (and, optionally, dining room speaker 606c, bedroom speaker 606f, and/or living room speakers 606g) monitor home 604 for additional sounds, such as voices of people calling for help and/or requesting assistance. In some embodiments, in response to detecting a predetermined sound (e.g., speech and/or an utterance requesting assistance), kitchen speaker 606b (and/or another electronic device) can perform an action, such as initiate a phone call to an emergency service and/or an emergency contact associated with home 604.

In some embodiments, in response to detecting sound 610, kitchen speaker 606b outputs audio requesting a response from any individuals that are within the vicinity of kitchen speaker 606b. For instance, in some embodiments, kitchen speaker 606b outputs audio including speech that asks about a status of the individuals. In some embodiments, kitchen speaker 606b outputs audio including speech that asks whether an individual within the vicinity of kitchen speaker 606b wants to record sound captured by kitchen speaker 606b and/or record video, if available. For instance, in some embodiments, kitchen speaker 606b (and/or another electronic device) can cause dining room camera 606d to record video and/or images after kitchen speaker 606b detects sound 610 and/or after kitchen speaker 606b detects authorization from an individual to record the video and/or images.

In some embodiments, when audio and/or video is recorded, kitchen speaker 606b, electronic device 602, and/or another device can analyze recorded audio and/or video to determine whether to perform a predetermined action. For instance, in some embodiments, kitchen speaker 606b (and/or another electronic device) analyzes (e.g., via sound analysis) recorded audio corresponding to sound captured by kitchen speaker 606b to determine whether the recorded audio includes speech from an individual present in home 604 requesting assistance (e.g., an individual present in home 604 is calling for help). In some embodiments, when kitchen speaker 606b (and/or another electronic device) determines that the recorded audio includes speech from an individual requesting assistance, kitchen speaker 606b (and/or another electronic device) can initiate a phone call to an emergency service (e.g., 911) and/or to an emergency contact associated with home 604. Similarly, in some embodiments, kitchen speaker 606b (and/or another electronic device) can analyze (e.g., via photo and/or video analysis) recorded images from dining room camera 606d to determine whether to perform a predetermined action.

Based on receiving the indication of the event, electronic device 602 displays and/or outputs notification 612 associated with the event on first user interface 608. For instance, at FIG. 6B, notification 612 includes application indicator 612a, alert indicator 612b, home indicator 612c, and event information 612d. Application indicator 612a provides a visual indication (e.g., an icon, an image, and/or a symbol) of an application that is associated with notification 612, such as an application associated with the home automation system and/or an application that enables electronic device 602 to control the home automation system. Alert indicator 612b (e.g., “CRITICAL”) provides a visual indication as to a type and/or urgency of notification 612. Home indicator 612c provides a visual indication (e.g., “123 MAIN STREET”) about a location and/or identification of home 604 where the event occurred and/or was detected. Event information 612d includes information about the event, such as a device that detected the event (e.g., kitchen speaker 606b), the type of event (e.g., smoke alarm and/or kitchen sensor 606a being activated and/or triggered), and/or a time associated with the event.

At FIG. 6B, when kitchen speaker 606b detects sound 610 output by kitchen sensor 606a, the time-based process (e.g., a communication window) that enables electronic device 602 to receive and/or output audio based on sound captured by kitchen speaker 606b is initiated (e.g., initiated by kitchen sensor 606a, kitchen speaker 606b, and/or electronic device 602). In other words, the predefined amount of time for which the time-based process lasts begins to elapse and/or starts after kitchen speaker 606b detects sound 610 (e.g., starts at the second time (e.g., In some embodiments, kitchen speaker 606b includes a microphone and/or another sound detection device that enables kitchen speaker 606b to capture sound in a physical environment in which kitchen speaker 606b is located (e.g., kitchen 604a of home 604). When electronic device 602 detects one or more user inputs requesting to output audio based on sound captured by kitchen speaker 606b, kitchen speaker 606b receives the request from electronic device 602. Based on receiving the request from electronic device 602, kitchen speaker 606b is configured to transmit audio data based on the sound captured by kitchen speaker 606b for the predefined amount of time (e.g., the predefined amount of time starting at the second time (e.g., In some embodiments, the predefined amount of time begins to elapse when kitchen speaker 606b detects sound 610, when kitchen speaker 606b receives an indication of the event from kitchen sensor 606a, when kitchen speaker 606b begins transmitting the audio data to electronic device 602, and/or when kitchen speaker 606b stops detecting sound 610. Accordingly, when a user of electronic device 602 is remote from home 604 and/or away from home 604, the user can obtain additional information about the event and/or communicate with one or more persons that are located in home 604.

In some embodiments, another electronic device (e.g., electronic device 652 and/or an electronic device that is different from electronic device 602 and electronic device 652) is also able to display a notification similar to notification 612 when kitchen speaker 606b detects sound 610. For instance, another electronic device that has authorization to receive captured sound from kitchen speaker 606b can display a notification similar to notification 612. Therefore, multiple electronic devices can output the sound captured by kitchen speaker 606b concurrently and/or at the same time after kitchen speaker 606b detects sound 610 and while the time-based process is active.

At FIG. 6B, electronic device 602 detects user input 650a (e.g., a tap gesture, a press gesture, and/or an authentication user input) corresponding to selection of notification 612. In response to detecting user input 650a, electronic device 602 displays communication user interface 614, as shown at FIG. 6D. As set forth below, communication user interface 614 enables electronic device 602 to output audio based on the sound captured by kitchen speaker 606b for the predefined amount of time of the time-based process.

In some embodiments, electronic device 602 is not displaying first user interface 608 when the event is detected (e.g., by kitchen speaker 606b). In some embodiments, electronic device 602 is configured to display and/or otherwise output a notification corresponding to the event so that user is alerted to the occurrence of the event even when electronic device 602 is not displaying first user interface 608. In some embodiments, electronic device 602 detects user input dismissing the notification of the event and/or does not otherwise detect user input selecting the notification associated with the event. In some embodiments, electronic device 602 receives one or more user inputs requesting to navigate to an application of electronic device 602 associated with the home automation system, and in response to receiving the one or more user inputs, displays home user interface 618 with notification 616 (e.g., when a current time is within the predefined time of the time-based process), as shown at FIG. 6C.

At FIG. 6C, notification 616 includes event indicator 616a, event information 616b, and communication user interface object 616c. Event indicator 616a includes an icon, image, and/or symbol indicative of the event detected by kitchen speaker 606b. For instance, at FIG. 6C, event indicator 616a includes an icon, image, and/or symbol of fire indicating that the event is associated with a smoke alarm (e.g., kitchen sensor 606a) being activated and/or triggered. Event information 616b includes details (e.g., textual details) related to the event, such as a device (e.g., kitchen speaker 606b) that detected the event, a type of event (e.g., alarm sound recognized), and/or a time at which the event was detected.

In some embodiments, another electronic device (e.g., electronic device 652 and/or an electronic device that is different from electronic device 602 and electronic device 652) is also able to display a notification similar to notification 616 when kitchen speaker 606b detects sound 610. For instance, another electronic device that has authorization to receive captured sound from kitchen speaker 606b can display a notification similar to notification 616. Therefore, multiple electronic devices can output the sound captured by kitchen speaker 606b concurrently and/or at the same time after kitchen speaker 606b detects sound 610 and while the time-based process is active.

At FIG. 6C, electronic device 602 displays home user interface 618 including notification 616 corresponding to the event at the second time (e.g., 10:10) that is within the predefined amount of time (e.g., the predefined amount of time from detection of the event by kitchen speaker 606b). Accordingly, electronic device 602 is configured to output audio that is based on sound captured by kitchen speaker 606b in response to detecting one or more user inputs corresponding to notification 616 because notification 616 is displayed within the predefined amount of time. At FIG. 6C, electronic device 602 detects user input 650b (e.g., a tap gesture) corresponding to selection of communication user interface object 616c of notification 616. In response to detecting user input 650b, electronic device 602 displays communication user interface 614, as shown at FIG. 6D.

At FIG. 6D, diagram illustrates that the event is still occurring and kitchen sensor 606a continues to output sound 610 at a third time (e.g., 10:11) that is after the second time (e.g., Electronic device 602 displays communication user interface 614 at the third time (e.g., which is still within the predefined amount of time of the time-based process. Communication user interface 614 enables electronic device 602 to output (e.g., via a speaker and/or headphones in communication with electronic device 602) audio that is based on sound captured by kitchen speaker 606b. For instance, kitchen speaker 606b includes a microphone and/or another audio capture device that detects and captures sound within a physical environment in which kitchen speaker 606b is located, such as kitchen 604a of home 604. Kitchen speaker 606b can transmit audio (e.g., sound) captured within its vicinity (e.g., in kitchen 604a of home 604) to electronic device 602 (e.g., directly transmit the audio data to electronic device 602 and/or transmit the audio data to electronic device 602 indirectly, such as via a server), which can output the audio. In this way, a user of electronic device 602 can listen in to the audio in the environment around kitchen speaker 606b and/or receive communications from one or more people located near kitchen speaker 606b (e.g., people located in kitchen 604a of home 604) after being alerted of the event.

At FIG. 6D, kitchen speaker 606b transmits the audio (e.g., sound) captured by kitchen speaker 606b in response to receiving an indication from electronic device 602 associated with electronic device 602 detecting user input 650a and/or user input 650b. When kitchen speaker 606b begins transmitting the audio data (e.g., to electronic device 602 and/or to another electronic device, such as a server), kitchen speaker 606b outputs feedback to alert people that are present and/or located near kitchen speaker 606b that sound is being captured and the audio data is being transmitted (e.g., listened to by a user of electronic device 602 who is remote from home 604). For instance, at FIG. 6D, kitchen speaker 606b outputs light 620 as a visual indication that sound is being captured and/or that audio data based on the captured sound is being transmitted to an external device (e.g., electronic device 602). As such, a person that is within viewing distance of kitchen speaker 606b is informed that kitchen speaker 606b is capturing sound, including speech and/or utterances made by that person. In addition, at FIG. 6D, kitchen speaker 606b outputs audio 622 that provides an audible indication that sound is being captured and/or that audio data based on the captured sound is being transmitted to an external device (e.g., electronic device 602). In some embodiments, kitchen speaker 606b is at a position and/or location within kitchen 604a where at least a portion of kitchen speaker 606b is not visible to a person that is present in kitchen 604a. For example, in some embodiments, a portion of kitchen speaker 606b is covered by other objects in kitchen 606b, which may affect an ability of a person to view light 620. As such, audio 622 provides another form of feedback that alerts and/or informs a person within home 604 (e.g., within kitchen 604a of home 604) that kitchen speaker 606b is capturing audio and/or transmitting audio data based on sound captured by kitchen speaker 606b.

At FIG. 6D, audio 622 includes speech that provides information about electronic device 602 receiving the audio data from kitchen speaker 606b. For instance, at FIG. 6D, audio 622 includes the speech “John Appleseed is listening in,” which provides a person that is near kitchen speaker 606b with information about an identity of a person that may be listening to audio that is based on sound captured by kitchen speaker 606b and/or that audio data based on the sound captured by kitchen speaker 606b is being transmitted to another device. In some embodiments, kitchen speaker 606b outputs, in addition to or in lieu of speech, one or more audio bursts that do not include speech, such as beeps and/or chimes. In some embodiments, kitchen speaker 606b is configured to output audio bursts of audio 622 at predetermined intervals of time to alert a person that is located near kitchen speaker 606b that audio data based on sound captured by kitchen speaker 606b is being transmitted to electronic device 602. Accordingly, a person that is not present in kitchen 604a at the third time (e.g., 10:11) can still become aware that kitchen speaker 606b is transmitting the audio data based on sound captured by kitchen speaker 606b at a time after the third time when kitchen speaker 606b outputs the audio bursts (e.g., at the predetermined time intervals that occur during the predefined amount of time of the time-based process).

In some embodiments, kitchen speaker 606b is configured to output light 620 and/or audio 622 continuously while kitchen speaker 606b transmits audio data that is based on sound captured by kitchen speaker 606b. In some embodiments, kitchen speaker 606b ceases and/or stops outputting light 620 and/or audio 622 when kitchen speaker 606b receives an indication to stop transmitting audio data based on the captured sound (e.g., receives an indication from electronic device 602 based on one or more user inputs received at electronic device 602). In some embodiments, kitchen speaker 606b ceases and/or stops outputting light 620 and/or audio 622 after the predefined amount of time of the time-based process has elapsed. As set forth below, kitchen speaker 606b is configured to cease and/or stop transmitting audio data that is based on the captured sound in response to detecting user input on one or more input devices of kitchen speaker 606b. In some embodiments, in response to detecting user input on the one or more input devices of kitchen speaker 606b, kitchen speaker 606b ceases and/or stops the time-based process, transmitting the audio data, outputting light 620, and/or outputting audio 622.

At FIG. 6D, electronic device 602 displays communication user interface 614 at the third time (e.g., 10:11), which is within the predefined amount of time of the time-based process. Communication user interface 614 includes event indicator 614a, event information 614b, audio indicator 614c, and voice user interface object 614d. Similar to notification 616, event indicator 614a includes an icon, image, and/or symbol indicative of the event detected by kitchen speaker 606b. For instance, at FIG. 6D, event indicator 614a includes an icon, image, and/or symbol of fire indicating that the event is associated with a smoke alarm (e.g., kitchen sensor 606a) being activated and/or triggered. Event information 614b includes details (e.g., textual details) related to the event, such as a device (e.g., kitchen speaker 606b) that detected the event, a type of event (e.g., alarm sound recognized), and/or a time at which the event was detected. Audio indicator 614c includes a visual indication of audio that is configured to be output by electronic device 602, where the audio that is configured to be output by electronic device 602 is based on the sound captured by kitchen speaker 606b. At FIG. 6D, audio indicator 614c includes a representation of a sound wave that provides a visual indication of volumes, frequencies, and/or timing of the sound captured by kitchen speaker 606b. At FIG. 6D, communication user interface 614 is overlaid on home user interface 618. In some embodiments, communication user interface 614 occupies an entire display area of display 602a and/or is overlaid on a different user interface (e.g., first user interface 608).

In some embodiments, communication user interface 614 provides an ability to record the sound captured by kitchen speaker 606b. For instance, in some embodiments, communication user interface 614 includes a record user interface object that causes electronic device 602 and/or kitchen speaker 606b to record the sound captured by kitchen speaker 606b. In some embodiments, communication user interface 614 provides an ability to capture images from a camera device (e.g., dining room camera 606d). Accordingly, a user that is remote from home 604 can record audio, video, and/or images so that the user can document and/or otherwise access information about the event at a later time.

As set forth above, in some embodiments, another electronic device (e.g., electronic device 652 and/or an electronic device that is different from electronic device 602 and electronic device 652) is also able to output the sound captured by kitchen speaker 606b concurrently and/or at the same time as electronic device 602. Accordingly, multiple electronic devices, when authorized, can output the sound captured by the kitchen speaker 606b simultaneously so that multiple users that are remote from home 604 can obtain information about the event.

At FIG. 6D, electronic device 602 detects user input 650c (e.g., a tap gesture) corresponding to selection of voice user interface object 614d at the third time (e.g., 10:11). In response to detecting user input 650c, electronic device 602 enables a sound capture device (e.g., a microphone) to capture sound within a physical environment in which electronic device 602 is located and displays communication user interface 614 (e.g., updates an appearance of communication user interface 614), as shown at FIG. 6E.

At FIG. 6E, electronic device 602 displays communication user interface 614 at the third time (e.g., 10:11), which is within the predefined amount of time of the time-based process. Communication user interface 614 includes mute user interface object 614e and does not include voice user interface object 614d. Accordingly, electronic device 602 replaces display of voice user interface object 614d with mute user interface object 614e in response to detecting user input 650c selecting voice user interface object 614d. In some embodiments, mute user interface object 614e includes a different appearance (e.g., a different color, a different shape, a different size, and/or a different icon, symbol, and/or image) as compared to voice user interface object 614d. Displaying mute user interface object 614e with a different appearance than voice user interface object 614d provides visual confirmation to a user of electronic device 602 that a sound capture device (e.g., a microphone) of electronic device 602 is activated, such that speech, utterances, and/or other sound made by the user is configured to be captured by electronic device 602. For instance, in some embodiments, electronic device 602 includes a microphone that, when activated, enables electronic device 602 to capture sounds within a physical environment in which electronic device 602 is located. In response to detecting user input 650c, electronic device 602 is configured to activate the sound capture device, capture sound in the physical environment in which electronic device 602 is located, and transmit audio data that is based on the sound captured by electronic device 602 to kitchen speaker 606b.

At FIG. 6E, after electronic device 602 detects user input 650c at the third time (e.g., electronic device 602 detects speech 624 within a physical environment in which electronic device 602 is located. For instance, speech 624 includes the question “Is everybody alright?” In some embodiments, speech 624 is spoken and/or uttered by a user of electronic device 602 who wants to obtain additional information about the event detected by kitchen speaker 606b. In response to detecting speech 624, electronic device 602 transmits audio data based on speech 624 to kitchen speaker 606b (e.g., transmits the audio data directly to kitchen speaker 606b and/or indirectly via a server). When kitchen speaker 606b receives the audio data based on speech 624, kitchen speaker 606b outputs audio 626. Audio 626 is based on the audio data received from electronic device 602 and associated with speech 624 detected by electronic device 602. For instance, at FIG. 6E, audio 626 includes the question “Is everybody alright?” Thus, audio 626 includes a representation of speech 624, which enables the user of electronic device 602 to communicate with one or more people located in home 604.

In some embodiments, one or more additional electronic devices (e.g., electronic devices that are different from electronic device 602) can provide audio data to kitchen speaker 606b. Therefore, while the time-based process is active and/or within the predefined amount of time of the time-based process, a user of device 602, a user of another electronic device that is remote from home 604, and/or an individual that is located in home 604 can have a conversation with one another.

At FIG. 6E, kitchen speaker 606b outputs light 620 to indicate that kitchen speaker 606b continues to capture sound and/or transmit audio data based on sound captured by kitchen speaker 606b to electronic device 602. Accordingly, one or more people that are located in home 604 can respond to audio 626 and communicate back to the user of electronic device 602 within the predefined amount of time of the time-based process. For instance, at FIG. 6F, kitchen speaker 606b has stopped and/or ceased outputting audio 626. Kitchen speaker 606b detects speech 628 at the third time (e.g., 10:11), where speech 628 includes words spoken and/or uttered by the one or more people located in home 604.

At FIG. 6F, kitchen speaker 606b detects speech 628 within a physical environment in which kitchen speaker 606b is located (e.g., within kitchen 604a of home 604) at the third time (e.g., 10:11) that is within the predefined amount of time of the time-based process. For instance, speech 628 includes the statement “All good,” which is spoken and/or uttered by a person that is located near kitchen speaker 606b (e.g., within kitchen 604a of home 604) and is responding to audio 626. In response to detecting speech 628, kitchen speaker 606b transmits audio data based on speech 628 to electronic device 602 (e.g., transmits the audio data directly to electronic device 602 and/or indirectly via a server). When electronic device 602 receives the audio data based on speech 628, electronic device 602 outputs audio 630. Audio 630 is based on the audio data received from kitchen speaker 606b and associated with speech 628 detected by kitchen speaker 606b. For instance, at FIG. 6F, audio 630 includes the statement “All good,” which is a representation of speech 628. Accordingly, the user of electronic device 602 and/or one or more people located in home 604 can easily communicate with one another within the predefined amount of time of the time-based process. In some embodiments, electronic device 602 detects user input corresponding to selection of mute user interface object 614e before outputting audio 630. In some embodiments, electronic device 602 outputs audio 630 without detecting user input corresponding to selection of mute user interface object 614e.

At FIG. 6F, electronic device 602 detects user input 650d (e.g., a tap gesture) corresponding to selection of exit user interface object 631. In response to detecting user input 650d, electronic device 602 displays home user interface 618, as shown at FIG. 6G. In some embodiments, in response to detecting user input 650d, electronic device 602 displays first user interface 608.

While FIGS. 6A-6F illustrate kitchen speaker 606b detecting the event (e.g., detecting sound 610 output by kitchen sensor 606a) and transmitting audio data to electronic device 602, other devices of home 604 are configured to detect the event (e.g., the same event and/or a different event) and transmit audio data based on captured sound to electronic device 602. For instance, at FIG. 6G, diagram 600 illustrates that kitchen sensor 606a continues to output sound 610 and dining room speaker 606c detects sound 610 at a fourth time (e.g., 10:12) that is after the first time, the second time, and the third time. In some embodiments, dining room speaker 606c detects sound 610 after kitchen speaker 606b because kitchen speaker 606b is positioned closer to kitchen sensor 606a as compared to dining room speaker 606c.

In some embodiments, when dining room speaker 606c detects the event (e.g., by detecting sound 610 and/or receiving an indication from kitchen sensor 606a), the predefined amount of time of the time-based process does not reset and/or restart. In other words, in some embodiments, when a first device of the set of devices of home 604 detects the event, the predefined amount of time of the time-based process begins and does not extend, restart, and/or reset when a second device of the set of devices of home 604 detects the event. In some embodiments, when dining room speaker 606c detects the event (e.g., by detecting sound 610 and/or receiving an indication from kitchen sensor 606a), a second time-based process is initiated that is different from the time-based process initiated when kitchen speaker 606b detects the event. In other words, a second and separate time-based process is initiated when dining room speaker 606c detects the event, where the second time-based event includes a second predefined amount of time that is independent of the predefined amount of time associated with the time-based process initiated when kitchen speaker 606b detects the event. In some embodiments, electronic device 602 is configured to output audio based on sound captured by dining room speaker 606c at a time that is after the predefined amount of time associated with the time-based process initiated when kitchen speaker 606b detects the event (e.g., so long as the time is within the second predefined amount of time associated with the second time-based process).

Based on receiving an indication that dining room speaker 606c detected the event, electronic device 602 displays and/or outputs notification 632 associated with the event on home user interface 618 at the fourth time (e.g., 10:12). As set forth above, the fourth time is within the predefined amount of time of the time-based process that was initiated in response to and/or after kitchen speaker 606b detected the event. At FIG. 6G, notification 632 is displayed concurrently with notification 616 on home user interface 618 at the fourth time (e.g., 10:12), where notification 632 corresponds to dining room speaker 606c detecting the event and notification 616 corresponds to kitchen speaker 606b detecting the event. Notification 632 includes event indicator 632a, event information 632b, and communication user interface object 632c. Event indicator 632a includes an icon, image, and/or symbol indicative of the event detected by dining room speaker 606c. For instance, at FIG. 6G, event indicator 632a includes an icon, image, and/or symbol of fire indicating that the event is associated with a smoke alarm (e.g., kitchen sensor 606a) being activated and/or triggered. Event information 632b includes details (e.g., textual details) related to the event, such as a device (e.g., dining room speaker 606c) that detected the event, a type of event (e.g., alarm sound recognized), and/or a time at which the event was detected.

At FIG. 6G, kitchen speaker 606b is also shown as being in an idle state at the fourth time (e.g., 10:12) because kitchen speaker 606b is not transmitting sound captured in home 604 (e.g., in kitchen 604a) to electronic device 602 and/or another external electronic device. In other words, kitchen speaker 606b stopped and/or ceased transmitting audio data to electronic device 602 in response to receiving an indication from electronic device 602 that electronic device 602 detected user input 650d. At FIG. 6G, kitchen speaker 606b does not output light 620 and/or audio 622, thereby providing confirmation to a user located in home 604 that kitchen speaker 606b is not transmitting audio data based on sound captured by kitchen speaker 606b. At FIG. 6G, dining room speaker 606c is shown as being in the idle state at the fourth time (e.g., thereby indicating that dining room speaker 606c is not capturing sound and/or transmitting audio data based on sound captured by dining room speaker 606c to electronic device 602 and/or another device.

In some embodiments, dining room speaker 606c includes a microphone and/or another sound detection device that enables dining room speaker 606c to capture sound in a physical environment in which dining room speaker 606c is located (e.g., dining room 604b of home 604). When electronic device 602 detects one or more user inputs requesting to output audio based on sound captured by dining room speaker 606c, dining room speaker 606c receives the request from electronic device 602. Based on receiving the request from electronic device 602, dining room speaker 606c is configured to transmit audio data based on the sound captured by dining room speaker for the predefined amount of time and/or the second predefined amount of time.

At FIG. 6G, electronic device 602 displays home user interface 618 including notification 632 at the fourth time (e.g., 10:12) that is within the predefined amount of time (e.g., the predefined amount of time from detection of the event by kitchen speaker 606b and/or a second predefined amount of time from detection of the event by dining room speaker 606c). Accordingly, electronic device 602 is configured to output audio that is based on sound captured by dining room speaker 606c in response to detecting one or more user inputs corresponding to notification 632 because notification 632 is displayed within the predefined amount of time. At FIG. 6G, electronic device 602 detects user input 650e (e.g., a tap gesture) corresponding to selection of communication user interface object 632c of notification 632. In response to detecting user input 650e, electronic device 602 displays communication user interface 634, as shown at FIG. 6H.

At FIG. 6H, diagram illustrates that kitchen sensor 606a has stopped and/or ceased outputting sound 610 at a fifth time (e.g., 10:13) that is after the fourth time (e.g., 10:12). Even though kitchen sensor 606a has stopped and/or ceased outputting sound 610, the predefined amount of time of the time-based process has not elapsed, and thus, electronic device 602 is still configured to output audio based on sound captured by kitchen speaker 606b and/or dining room speaker 606c. For instance, electronic device 602 displays communication user interface 634 at the fifth time (e.g., 10:13), which is still within the predefined amount of time of the time-based process. Communication user interface 634 enables electronic device 602 to output (e.g., via a speaker and/or headphones in communication with electronic device 602) audio that is based on sound captured by dining room speaker 606c (and not kitchen speaker 606b). For instance, dining room speaker 606c includes a microphone and/or another audio capture device that detects and captures sound within a physical environment in which dining room speaker 606c is located, such as dining room 604b of home 604. Dining room speaker 606c is configured to generate audio data that is based on the sound captured in dining room 604b of home 604 and transmit the audio data to electronic device 602 (e.g., directly transmit the audio data to electronic device 602 and/or transmit the audio data to electronic device 602 indirectly, such as via a server). In response to receiving the audio data, electronic device 602 is configured to output audio that is based on the sound captured by dining room speaker 606c so that a user of electronic device 602 can obtain additional information about the event and/or receive communications from one or more people located near dining room speaker 606c (e.g., located in dining room 604b of home 604).

When dining room speaker 606c begins transmitting the audio data (e.g., to electronic device 602 and/or to another electronic device), dining room speaker 606c outputs feedback to alert people that are present and/or located near dining room speaker 606c that sound is being captured and the audio data is being transmitted (e.g., listened to by a user of electronic device 602 who is remote from home 604). For instance, at FIG. 6H, dining room speaker 606c outputs light 636 as a visual indication that sound is being captured and/or that audio data based on the captured sound is being transmitted to an external device (e.g., electronic device 602). As such, a person that is within viewing distance of dining room speaker 606c is informed that dining room speaker 606c is capturing sound, including speech and/or utterances made by that person. In addition, at FIG. 6H, dining room speaker 606c outputs audio 638 that provides an audible indication that sound is being captured and/or that audio data based on the captured sound is being transmitted to an external device (e.g., electronic device 602). In some embodiments, dining room speaker 606c is at a position and/or location within dining room 604b where at least a portion of dining room speaker 606c is not visible to a person that is present in dining room 604b. For example, in some embodiments, a portion of dining room speaker 606c is covered by other objects in dining room 604b, which may affect an ability of a person to view light 636. As such, audio 638 provides another form of feedback that alerts and/or informs a person within home 604 (e.g., within dining room 604b of home 604) that dining room speaker 606c is capturing audio and/or transmitting audio data based on sound captured by dining room speaker 606c.

At FIG. 6H, audio 638 includes speech that provides information about electronic device 602 receiving the audio data from dining room speaker 606c. For instance, at FIG. 6H, audio 638 includes the speech “John Appleseed is listening in,” which provides a person that is near dining room speaker 606c with information about an identity of a person that may be listening to audio that is based on sound captured by dining room speaker 606c and/or that audio data based on the sound captured by dining room speaker 606c is being transmitted to another device. In some embodiments, dining room speaker 606c outputs, in addition to or in lieu of speech, one or more audio bursts that do not include speech, such as beeps and/or chimes. In some embodiments, dining room speaker 606c is configured to output audio bursts of audio 638 at predetermined intervals of time to alert a person that is located near dining room speaker 606c that audio data based on sound captured by dining room speaker 606c is being transmitted to electronic device 602. Accordingly, a person that is not present in dining room 604b at the fifth time (e.g., 10:13) can still become aware that dining room speaker 606c is transmitting the audio data based on sound captured by dining room speaker 606c at a time after the fifth time because dining room speaker 606c continues to output the audio bursts (e.g., at the predetermined time intervals that occur during the predefined amount of time of the time-based process).

In some embodiments, dining room speaker 606c is configured to output light 636 and/or audio 638 continuously while dining room speaker 606c transmits audio data that is based on sound captured by dining room speaker 606c. In some embodiments, dining room speaker 606c ceases and/or stops outputting light 636 and/or audio 638 when dining room speaker 606c receives an indication to stop transmitting audio data based on the captured sound (e.g., receives an indication from electronic device 602 based on one or more user inputs received at electronic device 602). In some embodiments, dining room speaker 606c ceases and/or stops outputting light 636 and/or audio 638 after the predefined amount of time of the time-based process has passed. As set forth below, dining room speaker 606c is configured to cease and/or stop transmitting audio data that is based on the captured sound in response to detecting user input (e.g., user input 650f) on one or more input devices of dining room speaker 606c. In some embodiments, in response to detecting user input (e.g., user input 650f) on the one or more input devices of dining room speaker 606c, dining room speaker 606c ceases and/or stops transmitting the audio data, outputting light 636, and/or outputting audio 638.

At FIG. 6H, kitchen speaker 606b is not transmitting audio data based on sound captured by kitchen speaker 606b because user input 650e corresponds to selection of notification 632 that is associated with dining room speaker 606c. Accordingly, kitchen speaker 606b does not (e.g., forgoes) output of light 620 and/or audio 622 because the audio data is not being transmitted by kitchen speaker 606b.

At FIG. 6H, electronic device 602 displays communication user interface 634 at the fifth time (e.g., 10:14), which is within the predefined amount of time of the time-based process. Communication user interface 634 includes event indicator 634a, event information 634b, audio indicator 634c, voice user interface object 634d, and camera view user interface object 634e. Event indicator 634a includes an icon, image, and/or symbol indicative of the event detected by dining room speaker 606c. For instance, at FIG. 6H, event indicator 634a includes an icon, image, and/or symbol of fire indicating that the event is associated with a smoke alarm (e.g., kitchen sensor 606a) being activated and/or triggered. Event information 634b includes details (e.g., textual details) related to the event, such as a device (e.g., dining room speaker 606c) that detected the event, a type of event (e.g., alarm sound recognized), and/or a time at which the event was detected. Audio indicator 634c includes a visual indication of audio that is configured to be output by electronic device 602, where the audio that is configured to be output by electronic device 602 is based on the sound captured by dining room speaker 606c. At FIG. 6H, audio indicator 634c includes a representation of a sound wave that provides a visual indication of volumes, frequencies, and/or timing of the sound captured by dining room speaker 606c.

Camera view user interface object 634e includes one or more images and/or video (e.g., live video) based on information received from dining room camera 606d. In some embodiments, communication user interface 634 (and, optionally, communication user interface 614) includes camera view user interface object 634e when a camera device is associated with a same room as a device that is transmitting audio data (e.g., dining room speaker 606c). For instance, in some embodiments, devices of home 604 are programmatically mapped to different areas and/or locations within home 604 (e.g., based on receiving one or more user inputs associating a respective device with a respective area and/or location of home 604). In some embodiments, dining room speaker 606c and dining room camera 606d are both associated with dining room 604b, and thus, communication user interface 634 includes camera view user interface object 634e that enables a user of electronic device 602 to view one or more images and/or video based on information received from dining room camera 606d. In some embodiments, dining room camera 606d is not associated with kitchen 604a and no additional camera device is associated with kitchen 604a of home 604. Therefore, in some embodiments, communication user interface 614 does not include camera view user interface object 634e because communication user interface 614 is associated with kitchen speaker 606b, which is associated with kitchen 604a (and not dining room 604b).

In some embodiments, communication user interface 634 can enable video from dining room camera 606d to be recorded. For instance, in some embodiments, communication user interface 634 includes a record user interface object that enables the sound captured by dining room speaker 606c, video and/or images captured by dining room camera 606d, and/or sound captured by dining room camera 606d to be recorded. Accordingly, a user that is remote from home 604 can record audio, video, and/or images so that the user can document and/or otherwise access information about the event at a later time.

In some embodiments, camera view user interface object 634e includes a camera view of a camera that is in communication with dining room speaker 606c and/or that is associated with the same room as dining room speaker 606c. In some embodiments, communication user interface 634 is a user interface associated with a real-time communication session between electronic device 602, dining room speaker 606c, and/or another electronic device. Accordingly, a user of electronic device 602 can easily communicate and/or converse with individuals that are located in home 604 to obtain additional information about the event.

At FIG. 6H, dining room speaker 606c detects user input 650f (e.g., a tap gesture, a press gesture, a touch gesture, and/or an authentication input) corresponding to selection of region 640 of dining room speaker 606c at the fifth time (e.g., 10:13). In some embodiments, in response to detecting user input 650f, the time-based process ceases with respect to dining room speaker 606c, such that dining room speaker 606c is not able to transmit audio data based on sound captured by dining room speaker 606c and/or electronic device 602 is not able to output audio based on the sound captured by dining room speaker 606c. In some embodiments, in response to detecting user input 650f, the time-based process ceases with respect to dining room speaker 606c, but not with respect to kitchen speaker 606b (and/or other devices that detect an event). In some such embodiments, kitchen speaker 606b is able to continue transmitting audio data based on sound captured by kitchen speaker 606b and/or electronic device 602 is able to continue outputting audio that is based on the sound captured by kitchen speaker 606b. For instance, in some embodiments, in response to detecting user input 650f, dining room speaker 606c ceases and/or stops transmitting audio data based on sound captured by dining room speaker 606c to electronic device 602. After dining room speaker 606c detects user input 650f, electronic device 602 ceases to display communication user interface 634 and displays home user interface 618 without notification 632, as shown at FIG. 6I.

In some embodiments, in response to detecting user input 650f, dining room speaker 606c ceases and/or stops transmitting the audio data based on sound captured by dining room speaker 606c, but the time-based process is not ceased. Accordingly, in some embodiments, dining room speaker 606c can re-initiate the transmission of audio data based on sound captured by dining room speaker 606c when electronic device 602 provides an indication of a request to receive the audio data (e.g., via user input on notification 632). For instance, in some embodiments, in response to detecting user input 650f, dining room speaker 606c ceases and/or stops transmitting the audio data based on sound captured by dining room speaker 606c to electronic device 602. After dining room speaker 606c detects user input 650f, electronic device 602 ceases to display communication user interface 634 and displays home user interface 618 that still includes display of notification 632, as shown at FIG. 6G. Therefore, in some embodiments, electronic device 602 can resume output of audio based on sound captured by dining room speaker 606c in response to user input (e.g., user input 650e) selecting notification 632.

In some embodiments, user input 650f includes an authentication user input, such as a password (e.g., a voice password and/or an alphanumeric password) and/or authentication of a biometric feature of an individual providing user input 650f. In some embodiments, when dining room speaker 606c detects user input corresponding to region 640, dining room speaker 606c outputs a prompt to provide an authentication user input. In some embodiments, when dining room speaker 606c does not receive the authentication user input and/or does not confirm that the authentication user input corresponds to an authorized user, dining room speaker 606c continues to transmit the audio data based on sound captured by dining room speaker 606c. Accordingly, in some embodiments, dining room speaker 606c does not cease transmitting the audio data when an unauthorized individual attempts to cease the transmission of audio data.

At FIG. 6I, electronic device 602 displays home user interface 618 including notification 616, but not notification 632, at a sixth time (e.g., 10:14) that is after the fifth time. The sixth time (e.g., 10:14) is still within the predefined amount of time of the time-based process, and therefore, electronic device 602 maintains display of notification 616 on home user interface 618. As set forth above, in some embodiments, in response to detecting user input 650f, dining room speaker 606c ceases and/or ends the time-based process with respect to dining room speaker 606c and transmits information to electronic device 602 indicating that the time-based process has ceased with respect to dining room speaker 606c. As such, in some embodiments, electronic device 602 does not display and/or forgoes display of notification 632 at the sixth time, as shown at FIG. 6I.

In some embodiments, in response to detecting user input corresponding to selection of notification 616, electronic device 602 displays communication user interface 614 (e.g., as shown at FIG. 6D) and kitchen speaker 606b transmits audio data based on sound captured by kitchen speaker 606b to electronic device 602. Therefore, because the predefined amount of time of the time-based process has not elapsed, electronic device 602 is able to output audio that is based on the sound captured by kitchen speaker 606b.

At FIG. 6I, both kitchen speaker 606b and dining room speaker 606c are shown as being in an idle state at the sixth time (e.g., 10:14) because kitchen speaker 606b and dining room speaker 606c are not transmitting audio data based on captured sound to electronic device 602 and/or another external electronic device. In other words, dining room speaker 606c stopped and/or ceased transmitting audio data to electronic device 602 in response to receiving user input 650f. At FIG. 6G, dining room speaker 606c does not output light 636 and/or audio 638, thereby providing confirmation to a user located in home 604 that dining room speaker 606c is not transmitting audio data based on sound captured by dining room speaker 606c.

At FIG. 6J, electronic device 602 displays home user interface 618 at a seventh time (e.g., 10:26) that is after the sixth time (e.g., 10:14). The seventh time occurs after the predefined amount of time of the time-based process has elapsed, and therefore, the time-based process has been ended (e.g., ended by kitchen sensor 606a, kitchen speaker 606b, electronic device 602, and/or another external device, such as a server). Accordingly, home user interface 618 does not include notification 616 and/or notification 632 indicating that electronic device 602 cannot output audio based on sound captured by kitchen speaker 606b and/or dining room speaker 606c, respectively. When the time-based process ends and/or ceases, devices of home 604 are not configured to transmit audio data based on sound captured by the devices, and electronic device 602 is not configured to output audio based on sound captured by the devices. Therefore, the time-based process allows electronic device 602 to output the audio based on sound captured by a respective device for a finite duration (e.g., the predefined amount of time).

In some embodiments, when the time-based process ends while electronic device 602 is outputting audio based on sound captured by a respective device of home 604 (e.g., electronic device is displaying communication user interface 614 and/or communication user interface 634), electronic device 602 ceases to output the audio based on sound captured by the respective device (and, optionally, ceases to display communication user interface 614 and/or communication user interface 634). As such, electronic device 602 automatically ceases outputting the audio based on sound captured by the respective device in response to receiving an indication and/or detecting that the time-based process has ended.

As set forth above, multiple devices of home 604 are configured to detect an event and cause the time-based process (and/or separate time-based processes) to initiate. For instance, at FIG. 6K, diagram illustrates that an event has occurred and was detected by bedroom sensor 606e. At FIG. 6K, bedroom sensor 606e outputs sound 642 indicating that bedroom sensor 606e has detected an event such as, the presence of smoke, the presence of carbon dioxide, glass breaking, and/or a baby crying. Further, at FIG. 6K, electronic device 602 displays first notification 644, second notification 646, and third notification 648 based on receiving information from one or more devices of home 604 that detected sound 642.

First notification 644 corresponds to bedroom speaker 606f detecting sound 642 two minutes ago (e.g., at 11:29). In some embodiments, electronic device 602 output and/or displayed first notification 644 two minutes ago (e.g., at 11:29) based on receiving an indication that bedroom speaker 606f detected sound 642. At FIG. 6K, after bedroom speaker 606f detected sound 642 output by bedroom sensor 606e, the time-based process and/or communication window that enables electronic device 602 to receive and/or output audio based on sound captured by bedroom speaker 606f is initiated (e.g., initiated by bedroom sensor 606e, bedroom speaker 606f, and/or electronic device 602). In other words, the predefined amount of time for which the time-based process lasts, begins to elapse and/or starts.

At FIG. 6K, second notification 646 corresponds to dining room speaker 606c detecting sound 642 one minute ago (e.g., at 11:30). In some embodiments, electronic device 602 output and/or displayed second notification 646 one minute ago (e.g., at 11:30) based on receiving an indication that dining room speaker 606c detected sound 642. In some embodiments, dining room speaker 606c detected sound 642 after bedroom speaker 606f because dining room speaker 606c is positioned within home 604 at a location that is further away from bedroom sensor 606e as compared to bedroom speaker 606f.

Further, at FIG. 6K, third notification 648 corresponds to kitchen speaker 606b detecting sound 642 at a current time (e.g., at 11:31). In some embodiments, electronic device 602 outputs and/or displays third notification at the current time based on receiving an indication that kitchen speaker 606b detected sound 642. In some embodiments, kitchen speaker 606b detects sound 642 after bedroom speaker 606f and/or after dining room speaker 606c because kitchen speaker 606b is positioned within home 604 at a location that is further away from bedroom sensor 606e as compared to bedroom speaker 606f and/or dining room speaker 606c.

Accordingly, electronic device 602 is configured to output and/or display notifications at different times based on respective devices of home 604 detecting an event (e.g., the same event and/or different events). In some embodiments, electronic device 602 is configured to output audio that is based on sound captured by a respective device (e.g., bedroom speaker 606f, dining room speaker 606c, or kitchen speaker 606b) in response to detecting user input selecting a respective notification 644, 646, or 648. In some embodiments, electronic device 602 consolidates notifications 644, 646, and 648 into a single notification and, in response to detecting user input selecting the single notification, displays selectable options corresponding to the respective devices (e.g., bedroom speaker 606f, dining room speaker 606c, or kitchen speaker 606b). Therefore, a user of electronic device 602 can choose and/or select a particular device of home 604 that causes electronic device 602 to output audio based on sound captured by the chosen and/or selected device.

In some embodiments, electronic device 602 (e.g., and/or another device, such as a server) determines which of the respective devices that detect sound 642 is best suited for establishing a communication with electronic device 602. For instance, in some embodiments, electronic device 602 determines that outputting sound captured by bedroom speaker 606f would provide the user of electronic device 602 with the most accurate information about the event because bedroom speaker 606f detected sound 642 first, and therefore, is closest in proximity to the event. In some embodiments, electronic device 602 determines that outputting sound captured by kitchen speaker 606b would provide the user of electronic device 602 with the most accurate information about the event because kitchen speaker 606b detected sound 642 after bedroom speaker 606f and dining room speaker 606c, and therefore, sound 642 may not interrupt and/or interfere with a communication to an individual that is located in home 604. In some embodiments, electronic device 602 displays a single notification corresponding to the respective device for which electronic device 602 determines is best suited for establishing a communication.

At FIG. 6K, electronic device 602 does not display a notification indicative of living room speakers 606g detecting sound 642. As set forth below with reference to FIGS. 9A-9G, in some embodiments, living room speakers 606g are not configured to detect sound 642 (e.g., a particular type of sound corresponding to sound 642 and/or any types of sound). In some embodiments, living room speakers 606g detect sound 642, but are not configured to transmit audio based on sound captured by living room speakers 606g. In some embodiments, living room speakers 606g detect sound 642 and are configured to transmit audio based on sound captured by living room speakers 606g, but electronic device 602 is not configured to receive notifications associated with living room speakers 606g. Further, in some embodiments, living room speakers 606g detect sound 642 and electronic device 602 displays a notification associated with living room speakers 606g detecting sound 642.

In some embodiments, when multiple alarms (e.g., 606a and 606e) are activated at the same time (e.g., detecting the same and/or separate events concurrently), a voice assistant is activated on one or more of devices 606b, 606c, 606f, and/or 606g. In some embodiments, the voice assistant outputs feedback prompting an individual in the vicinity of the one or more devices to provide a status of their wellbeing and/or a status of home 604. In some embodiments, the voice assistant asks an individual to respond if the individual needs assistance. In some embodiments, in response to receiving an indication that the individual needs assistance, one or more of devices 606b, 606c, 606f, 606g, and/or another electronic device initiates a phone call to an emergency service (e.g., 911) and/or to an emergency contact associated with home 604. In some embodiments, when multiple alarms (e.g., 606a and 606e) are activated at the same time (e.g., detecting the same and/or separate events concurrently), the one or more devices 606b, 606c, 606f, and/or 606g detect sounds output by the multiple alarms and provide an indication to electronic device 602. In some embodiments, electronic device 602 outputs multiple notifications corresponding to detection of the respective alarms and groups the notifications based on a room and/or area of home 604 where the sound was first detected (e.g., by a device located in the room and/or area of home 604 and/or closest to the room and/or area of home 604).

While FIGS. 6A-6K illustrate electronic device 602 being configured to output the audio that is based on sound captured by a respective device of home 604, other types of electronic devices can also be configured to display notifications and/or output the audio based on sound captured by a respective device of home 604. For instance, at FIG. 6L, electronic device 652 (e.g., a watch and/or a smart watch) displays, via display 652a, notification 654 in response to receiving an indication associated with kitchen speaker 606b detecting sound 610 (e.g., as shown in diagram 600 of FIG. 6B). Notification 654 includes application indicator 654a, alert indicator 654b, home indicator 654c, and event information 654d. Application indicator 654a provides a visual indication (e.g., an icon, an image, and/or a symbol) of an application that is associated with notification 654, such as an application associated with the home automation system and/or an application that enables electronic device 652 to control the home automation system. Alert indicator 654b (e.g., “CRITICAL”) provides a visual indication as to a type and/or urgency of notification 654. Home indicator 654c provides a visual indication (e.g., “123 MAIN STREET”) about a location and/or identification of home 604 where the event occurred and/or was detected. Event information 654d includes information about the event, such as a device that detected the event (e.g., kitchen speaker 606b), the type of event (e.g., smoke alarm and/or kitchen sensor 606a being activated and/or triggered), and/or a time associated with the event.

At FIG. 6L, electronic device 652 detects user input 650g (e.g., a tap gesture, a press gesture, and/or an authentication user input) corresponding to selection of notification 654. In response to detecting user input 650g, electronic device 652 displays communication user interface 656, as shown at FIG. 6M.

At FIG. 6M, electronic device 652 displays communication user interface 656 at the third time (e.g., 10:11), which is within the predefined amount of time of the time-based process. Communication user interface 656 includes event indicator 656a, event information 656b, audio indicator 656c, and voice user interface object 656d. Event indicator 656a includes an icon, image, and/or symbol indicative of the event detected by kitchen speaker 606b. For instance, at FIG. 6M, event indicator 656a includes an icon, image, and/or symbol of fire indicating that the event is associated with a smoke alarm (e.g., kitchen sensor 606a) being activated and/or triggered. Event information 656b includes details (e.g., textual details) related to the event, such as a device (e.g., kitchen speaker 606b) that detected the event, a type of event (e.g., alarm sound recognized), and/or a time at which the event was detected. Audio indicator 656c includes a visual indication of audio that is configured to be output by electronic device 652, where the audio that is configured to be output by electronic device 652 is based on the sound captured by kitchen speaker 606b. At FIG. 6M, audio indicator 656c includes a representation of a sound wave that provides a visual indication of volumes, frequencies, and/or timing of the sound captured by kitchen speaker 606b.

In some embodiments, in response to detecting user input corresponding to selection of voice user interface object 656d, electronic device 652 is configured to display a user interface similar to communication user interface 614 shown at FIG. 6E. In some embodiments, when electronic device 652 displays the user interface similar to communication user interface 614 shown at FIG. 6E, electronic device 652 is configured to capture audio within a physical environment in which electronic device 652 is located and transmit audio data based on the sound captured by electronic device 652 to kitchen speaker 606b.

FIG. 7 is a flow diagram illustrating a method for initiating a time-based event that includes outputting captured audio using a computer system in accordance with some embodiments. Method 700 is performed at a computer system (e.g., 100, 300, 500, 580, 602, and/or 652) (e.g., an electronic device; a smart device, such as a smartphone or a smartwatch; a mobile device; a head mounted display, a robot, a personal assistive device, a self-motive device, a wearable device) that is in communication with one or more audio output devices (e.g., a speaker and/or a pair of headphones). Some operations in method 700 are, optionally, combined, the orders of some operations are, optionally, changed, and some operations are, optionally, omitted.

As described below, method 700 provides an intuitive way for initiating a time-based event that includes outputting captured audio. The method reduces the cognitive burden on a user for outputting captured audio, thereby creating a more efficient human-machine interface. For battery-operated computing devices, enabling a user to output captured audio faster and more efficiently conserves power and increases the time between battery charges.

The computer system (e.g., 100, 300, 500, 580, 602, and/or 652) receives (702) (e.g., from an external device) an indication of an event (e.g., kitchen sensor 606a outputting sound 610 and/or bedroom sensor 606e outputting sound 642) (e.g., an event detected by an external computer system (e.g., a smart speaker, a smart camera, and/or a smart alarm) that is in communication with the computer system, such as an audio event indicative of an activated smoke alarm, an activated carbon monoxide detector, glass breaking, and/or a baby crying). In some embodiments, the computer system receives the indication of the event from an external computer system (e.g., 606a, 606b, 606c, 606e, 606f, and/or 606g) that detects the event. In some embodiments, the computer system receives the indication of the event via an external computer system, such as a server, that does not detect the event. In some embodiments, the indication of the event is detected by an external computer system (e.g., 606b, 606c, 606f, and/or 606g) via sound recognition (e.g., the external computer system includes one or more microphones that are configured to detect one or more predetermined sounds and/or noises). In some embodiments, the indication of the event is received by an external computer system (e.g., 606b, 606c, 606f, and/or 606g) based on a communication from an alarm and/or a sensor (e.g., 606a and/or 606e) in communication with the external computer system (e.g., 606b, 606c, 606f, and/or 606g), and the indication of the event is directed (e.g., transmitted) to the computer system.

In response to receiving the indication of the event, the computer system (e.g., 100, 300, 500, 580, 602, and/or 652) initiates (704) a first time-based process (e.g., a process that is configured to execute and/or continue for a predetermined duration of time that starts from a time at which the first time-based process is initiated and ends after the expiration of the predetermined duration of time (e.g., the process stops, does not execute, and/or ceases after the predetermined duration of time elapses) and/or when a set of one or more process-termination criteria are met). During the first time-based process (e.g., during a phase of the process after receiving a user input (e.g., an input on a notification)), captured sound (e.g., 610, 628, and/or 642) (e.g., audible noise (e.g., machine generated and/or non-machine generated noise) that is present within an environment of an external computer system that is configured to detect, record, and/or capture the audible noise via an audio detection device (e.g., a microphone)) is outputted via the one or more audio output devices (e.g., the computer system is configured (e.g., changed from a state in which it cannot output audio based on captured sound (e.g., captured at an external device) to being able to do so) to output, via a speaker and/or headphones, captured audio that is captured by an external computer system (e.g., via a microphone of the external computer system), such as an external computer system that detects the event (e.g., detects the event via sound recognition and/or via communication with an alarm and/or sensor)). In some embodiments, the computer system outputs the captured audio (e.g., 610, 628, and/or 642) in response to receiving the indication of the event. In some embodiments, the computer system outputs the captured audio in response to receiving one or more user inputs (e.g., 650a, 650b, 650e, and/or 650g) (e.g., one or more user inputs directed to a notification (e.g., 612, 616, 632, 644, 646, 648, and/or 654) associated with the event) after receiving the indication of the event.

At a first time (706) (e.g., a time during the process after enabling the output of captured audio (e.g., a time after receiving an input on a notification associated with the receiving the indication of the event)) while the first time-based process is active, the computer system (e.g., 100, 300, 500, 580, 602, and/or 652) receives (708) (e.g., from an external device or via a microphone of the computer system; receiving data corresponding to the first captured sound) a first captured sound (e.g., 610, 628, and/or 642).

At the first time (706) (e.g., a time during the process after enabling the output of captured audio (e.g., a time after receiving an input on a notification associated with the receiving the indication of the event)) while the first time-based process is active, the computer system outputs (710), via the one or more audio output devices, a first audio output (e.g., audio represented by 614c, 630, audio represented by 634c, and/or audio represented by 656c) (e.g., machine-generated noise that is based on audio data of (e.g., received by) the computer system and output via one the one or more audio output devices of the computer system) that is based on the first captured sound (e.g., 610, 628, and/or 642). In some embodiments, the first audio output is playback (e.g., live playback) of the first captured sound.

At a second time (712) (e.g., a time that is the same as, earlier than, or later than, the first time) while the first time-based process is active and in accordance with a determination that a set of one or more process-termination criteria are met (e.g., home 604 as it appears at FIG. 6J) (e.g., the set of one or more process-termination criteria are met when the computer system does not include an established communication connection with an external computer system that is configured to capture the captured sound, when a predetermined amount of time from detection of the event has passed, and/or when the computer system receives an indication of user input of a first type detected via an external computer system), the set of one or more process-termination criteria includes a criterion that is met when a predetermined time (e.g., 15 minutes or 16 minutes) has elapsed since a third time (e.g., a time that the event was detected, a time after receiving an input (e.g., on a notification issued in response to the event), a time since starting the output of audio of captured sound, and/or a time since captured sound was last detected (e.g., by an external device) after the event), the computer system terminates (714) the first time-based process. In some embodiments, after the first time-based process is terminated and while the first time-based process is not active, captured sounds (e.g., sounds captured at an external device) are not outputted via the one or more audio output devices.

At the second time (712) (e.g., a time that is the same as, earlier than, or later than, the first time) while the first time-based process is active and in accordance with a determination that the set of one or more process-termination criteria are not met (e.g., home 604 as it appears at FIGS. 6B-6I) (e.g., the set of one or more process-termination criteria are not met when the computer system includes an established communication connection with an external computer system that is configured to capture the captured sound, when a predetermined amount of time from detection of the event has not passed, when the computer system does not receive an indication of user input of a first type detected via an external computer system, and/or when the computer system displays a notification that, when selected, is configured to enable the computer system to output the audio based on captured sound), the computer system maintains (716) (e.g., continuing to run; continuing to output received captured sound) the first time-based process (e.g., the process remains in an active state).

Terminating the first time-based process in accordance with a determination that the set of one or more process-termination criteria are met and maintaining the first time-based process in accordance with a determination that the set of one or more process termination criteria are not met provides a user of the computer system with an ability to listen to the captured sound for a finite duration after the indication of the event is received, thereby improving safety and security features of the computer system.

In some embodiments, in response to receiving the indication of the event (e.g., at a time before or after initiating the first time-based process) and while the first time-based process is active, the computer system (e.g., 100, 300, 500, 580, 602, and/or 652) displays, via a display generation component (e.g., 602a and/or 652a) (e.g., a display controller, a touch-sensitive display system, a projector, a display screen, a display monitor, and/or a holographic display) in communication with the computer system, a notification (e.g., 612, 616, 632, 644, 646, 648, and/or 654) (e.g., a push notification, a pop-up notification, and/or a banner notification that includes text, one or more user interface objects, symbols, icons, and/or images associated with the event) associated with the event. Displaying the notification associated with the event in response to receiving the indication of the event informs a user of the computer system that the first time-based process is active and/or that the computer system can output the first audio output that is based on the first captured sound, thereby providing improved visual feedback.

In some embodiments, while displaying the notification (e.g., 612, 616, 632, 644, 646, 648, and/or 654) associated with the event and while the first time-based process is active, the computer system (e.g., 100, 300, 500, 580, 602, and/or 652) detects a user input (e.g., 650a, 650b, 650e, and/or 650g) (e.g., a tap gesture, a press gesture, and/or a user input on a hardware input device of the computer system) corresponding to selection of the notification (e.g., 612, 616, 632, 644, 646, 648, and/or 654), where the computer system outputs the first audio output (e.g., audio represented by 614c, 630, audio represented by 634c, and/or audio represented by 656c) that is based on the first captured sound (e.g., 610, 628, and/or 642) in response to the user input (e.g., 650a, 650b, 650e, and/or 650g) corresponding to selection of the notification (e.g., 612, 616, 632, 644, 646, 648, and/or 654). Outputting the first audio output in response to detecting user input corresponding to selection of the notification allows a user of the computer system to quickly cause the computer system to output the first audio output without requiring the user to provide additional user inputs, thereby reducing the number of inputs needed to perform an operation.

In some embodiments, in accordance with a determination that the predetermined time (e.g., 15 minutes or 16 minutes) has elapsed since the third time, the computer system (e.g., 100, 300, 500, 580, 602, and/or 652) ceases display (e.g., stopping, forgoing, and/or not displaying) of the notification (e.g., 612, 616, 632, 644, 646, 648, and/or 654) associated with the event. In some embodiments, the notification associated with the event is displayed throughout the duration of the predetermined time and provides an indication to a user of the computer system that the first time-based process is active. Ceasing display of the notification associated with the event after the predetermined time has elapsed since the third time provides a visual indication to a user of the computer system that the first time-based process is active or inactive, thereby providing improved visual feedback.

In some embodiments, the notification (e.g., 612, 616, 632, 644, 646, 648, and/or 654) associated with the event includes an indication (e.g., 612a-612d, 616a, 616b, 632a, 632b, and/or 654a-654d) (e.g., text, a user interface object, a symbol, an icon, an image, and/or visual element) with information about the event (e.g., the notification includes information about a type of event (e.g., activation of a smoke alarm, activation of a carbon monoxide detector, a sensor detecting glass breaking, and/or a sensor detecting baby crying), a time at which the event was detected, a device that detected the event, and/or a location of the event within a structure (e.g., a home)). Including an indication with information about the event on the notification allows a user of the computer system to quickly determine whether the user should obtain more information about the event and/or otherwise take action, thereby providing improved visual feedback and improving safety and security features of the computer system.

In some embodiments, the notification (e.g., 612, 616, 632, 644, 648, and/or 654) associated with the event is displayed on a user interface (e.g., 618) (e.g., a home user interface and/or default user interface that is displayed when the application is first launched and/or opened) of an application associated with a home automation system (e.g., the application enables the computer system to control and/or adjust a state of one or more devices of a home automation system and/or the home automation system includes one or more devices that are configured to capture the first captured sound and/or transmit audio data associated with the first captured sound to the computer system). In some embodiments, the notification is a banner notification, such that the notification is displayed at a top portion of the user interface where a user of the computer system can easily view the notification. In some embodiments, the notification cannot be cleared and/or removed from the user interface via user input, but the notification is cleared and/or removed after the predetermined time has elapsed since the third time. Displaying the notification on a user interface of an application associated with a home automation system allows a user to easily access and/or view the notification while the first time-based process is active, thereby providing improved visual feedback.

In some embodiments, while the computer system (e.g., 100, 300, 500, 580, 602, and/or 652) outputs the first audio output (e.g., audio represented by 614c, 630, audio represented by 634c, and/or audio represented by 656c) that is based on the first captured sound (e.g., 610, 628, and/or 642) and while the first time-based process is active, the computer system detects a user input (e.g., 650d) requesting to cease outputting the first audio output that is based on the first captured sound (e.g., a user input requesting to close and/or otherwise no longer display a user interface that is displayed while the computer system outputs the first audio output that is based on the first captured sound, such as user input on a close and/or cancel user interface object, and/or user input requesting to mute and/or temporarily pause the first audio output that is based on the first captured sound, such as user input on a mute user interface object and/or user input on a volume user interface object). In response to detecting the user input (e.g., 650d) requesting to cease outputting the first audio output (e.g., audio represented by 614c, 630, audio represented by 634c, and/or audio represented by 656c) that is based on the first captured sound (e.g., 610, 628, and/or 642), the computer system ceases (e.g., stopping, pausing, and/or temporarily suspending) output of the first audio output (e.g., audio represented by 614c, 630, audio represented by 634c, and/or audio represented by 656c) that is based on the first captured sound (e.g., 610, 628, and/or 642) (e.g., the computer system stops and/or ceases outputting the first audio output that is based on the first captured sound, but the computer system is still configured to re-initiate output of the first audio output that is based on the first captured sound while the first time-based process remains active).

Ceasing output of the first audio output that is based on the first captured sound in response to detecting the user input requesting to cease outputting the first audio output allows a user to quickly and easily stop and/or pause the first audio output, thereby reducing the number of inputs needed to perform an operation.

In some embodiments, after ceasing output of the first audio output (e.g., audio represented by 614c, 630, audio represented by 634c, and/or audio represented by 656c) that is based on the first captured sound (e.g., 610, 628, and/or 642), while the first time-based process is active, and in accordance with the determination that the set of one or more process-termination criteria are not met (e.g., the set of one or more process-termination criteria are not met when the computer system includes an established communication connection with an external computer system that is configured to capture the captured sound, when a predetermined amount of time from detection of the event has not passed, when the computer system does not receive an indication of user input of a first type detected via an external computer system, and/or when the computer system displays a notification that, when selected, is configured to enable the computer system to output the audio based on captured sound), the computer system (e.g., 100, 300, 500, 580, 602, and/or 652) maintains the first time-based process (e.g., maintaining an ability of the computer system to continue outputting the first audio output that is based on the first captured sound (e.g., in response to detecting and/or receiving one or more user inputs (e.g., on a notification associated with the event) requesting to re-output and/or reinitiate output of the first audio output)). Maintaining the first time-based process after ceasing to output the first audio output allows a user to continue to listen to the first audio output at a later time if the user wants to obtain additional information about the event, thereby improving safety and security features of the computer system.

In some embodiments, after ceasing output of the first audio output (e.g., audio represented by 614c, 630, audio represented by 634c, and/or audio represented by 656c) that is based on the first captured sound (e.g., 610, 628, and/or 642), while the first time-based process is active, and in accordance with the determination that the set of one or more process-termination criteria are not met (e.g., the set of one or more process-termination criteria are not met when the computer system includes an established communication connection with an external computer system that is configured to capture the captured sound, when a predetermined amount of time from detection of the event has not passed, when the computer system does not receive an indication of user input of a first type detected via an external computer system, and/or when the computer system displays a notification that, when selected, is configured to enable the computer system to output the audio based on captured sound), the computer system (e.g., 100, 300, 500, 580, 602, and/or 652) displays (e.g., maintaining display of), via a display generation component (e.g., 602a and/or 652a) (e.g., a display controller, a touch-sensitive display system, a projector, a display screen, a display monitor, and/or a holographic display) in communication with the computer system, a second notification (e.g., 612, 616, 632, 644, 646, 648, and/or 654) (e.g., a push notification, a pop-up notification, and/or a banner notification that includes text, one or more user interface objects, symbols, icons, and/or images associated with the event) associated with the event, where the second notification (e.g., 612, 616, 632, 644, 646, 648, and/or 654), when selected (e.g., selected via one or more user inputs, such as a tap gesture and/or a press gesture), is configured to initiate (e.g., cause the computer system to initiate and/or begin) output, via the one or more audio output devices, of the first audio output (e.g., audio represented by 614c, 630, audio represented by 634c, and/or audio represented by 656c) that is based on the first captured sound (e.g., 610, 628, and/or 642). In some embodiments, the computer system displays the notification in response to receiving the indication of the event and maintains display of the notification throughout a duration of the first time-based process (e.g., the determined time)).

Displaying the second notification after ceasing output of the first audio output allows a user to confirm that the computer system is configured to re-initiate output of the first audio output and/or that the first time-based process is still active, thereby providing improved visual feedback.

In some embodiments, the set of one or more process-termination criteria includes a second criterion that is met when an indication is received (e.g., from an external computer system that is configured to capture the first captured sound) that indicates that an external device (e.g., 606b, 606c, 606f, and/or 606g) configured to capture the first captured sound (e.g., 610, 628, and/or 642) has detected a user input of a first type (e.g., 650f) (e.g., the external device detected a user input corresponding to a hardware input device and/or a touch sensitive-surface of the external device that is associated with a request to cause the external device to stop, cease, and/or pause transmission of audio data that is based on the first captured sound). Terminating the first time-based process when an indication is received that indicates that an external device configured to capture the first captured sound has detected a user input of a first type enables a person that is located near the external device to cause the external device to stop and/or cease transmitting the first captured sound, which improves safety and security features of the computer system.

In some embodiments, while the first time-based process is active, the computer system (e.g., 100, 300, 500, 580, 602, and/or 652) displays, via a display generation component (e.g., 602a and/or 652a) (e.g., a display controller, a touch-sensitive display system, a projector, a display screen, a display monitor, and/or a holographic display) that is in communication with the computer system, a camera view (e.g., 634e) (e.g., an image and/or a video (e.g., live video)) of a camera device (e.g., 606d) that is associated with a first external device (e.g., 606c) (e.g., a smart speaker (in some embodiments, a smart speaker that is associated with a user account that is also associated with the computer system)) configured to capture the first captured sound (e.g., 610, 628, and/or 642) (e.g., the camera device is associated with a same area of a structure (e.g., a home) as the external device configured to capture the first captured sound and/or the camera device is in communication with and/or integrated into the external device configured to capture the first captured sound, and/or the camera device and the external device configured to capture the first captured sound are associated with the same group of device). Displaying a camera view of a camera device that is associated with a first external device configured to capture the first captured sound allows a user of the computer system to obtain visual information about the event, thereby providing improved visual feedback and improving safety and/or security features of the computer system.

In some embodiments, receiving the indication of the event includes the computer system (e.g., 100, 300, 500, 580, 602, and/or 652) receiving information from a second external device (e.g., 606b, 606c, 606f, and/or 606g) (in some embodiments, second external device is the same device as the first external device) about the second external device (e.g., 606b, 606c, 606f, and/or 606g) detecting sound (e.g., 610 and/or 642) that was determined to correspond to (e.g., matches) a sound of a recognized type (e.g., sound recognition performed using a sound detection algorithm; detecting a sound that matches one or more known/recognizable sound profiles) (e.g., the external device detects sound associated with the event and determines that an event occurred based on sound recognition techniques). In some embodiments, the external device transmits information after detecting sound of a recognized type directly to the computer system and/or indirectly via a server. Receiving information from a second external device about the second external device detecting sound that was determined to correspond to a sound of a recognized type enables the computer system to quickly inform a user of the computer system about the event, thereby improving safety and/or security features of the computer system.

In some embodiments, the sound (e.g., 610 and/or 642) of the recognized type is selected from the group consisting of: sound outputted by a smoke alarm (e.g., 606a and/or 606e) (e.g., sound output by a smoke alarm based on detecting a presence of smoke), sound outputted by a carbon monoxide detector (e.g., 606a and/or 606e) (e.g., sound output by a carbon monoxide detector based on detecting a presence of carbon monoxide), sound of glass breaking (e.g., a sound indicating that a window and/or other glass has broken), and sound of a baby crying. The sound of the recognized type being selected from the group consisting of: sound output by a smoke alarm, sound output by a carbon monoxide detector, sound of glass breaking, and sound of a baby crying enables the computer system to quickly inform a user of the computer system about a safety and/or security event, thereby improving safety and/or security features of the computer system.

In some embodiments, receiving the indication of the event includes the computer system (e.g., 100, 300, 500, 580, 602, and/or 652) receiving information from a third external device (e.g., 606a and/or 606e) (e.g., an alarm configured to detect smoke and/or carbon monoxide, a sensor configured to detect a window and/or other glass breaking, and/or a baby monitor configured to detect a baby crying) about the third external device (e.g., 606a and/or 606e) being in an active state (e.g., outputting sound 610 and/or 642) (e.g., detecting smoke and/or carbon monoxide, detecting glass breaking, and/or detecting a baby crying). In some embodiments, the external device transmits information directly to the computer system and/or indirectly via a server. Receiving information from a third external device about the third external device being in an active state enables the computer system to quickly inform a user of the computer system about the event, thereby improving safety and/or security features of the computer system.

In some embodiments, the event is associated with a fourth external device (e.g., 606b, 606c, 606f, and/or 606g) (e.g., a first external device that detected the event (e.g., via sound recognition)) having a first configuration (e.g., the first external device is configured to detect the event and/or the first external device is configured to transmit the first captured sound while the first time-based process is active), where the first external device is configured to capture the first captured sound (e.g., 610, 628, and/or 642) (e.g., the first external device includes one or more audio detection devices (e.g., a microphone) that enables the first external device to capture the first captured sound and transmit audio data to the computer system that includes the first captured sound and/or is based on the first captured sound). In some embodiments, while the first time-based process is active, the computer system (e.g., 100, 300, 500, 580, 602, and/or 652) receives (e.g., from a second external device) an indication of a second event (e.g., an event detected by the second external device (e.g., a smart speaker, a smart camera, and/or a smart alarm) that is in communication with the computer system, such as an audio event indicative of an activated smoke alarm, an activated carbon monoxide detector, glass breaking, and/or a baby crying) associated with a fifth external device (e.g., 606b, 606c, 606f, and/or 606g), different from the fourth external device (e.g., 606b, 606c, 606f, and/or 606g). In some embodiments, while the first time-based process is active, after receiving the indication of the second event, and in accordance with a determination that the fifth external device (e.g., 606b, 606c, 606f, and/or 606g) includes the first configuration (e.g., the second external device is configured to detect the second event and/or the second external device is configured to transmit audio data to the computer system that is based on second sound captured by the second external device while the first time-based process is active), the computer system receives (e.g., from the second external device or via a microphone of the second external device; receiving data corresponding to the first captured sound) a second captured sound (e.g., 610, 628, and/or 642) captured by the fifth external device (e.g., 606b, 606c, 606f, and/or 606g) and the computer system outputs, via the one or more audio output devices, a second audio output (e.g., audio represented by 614c, 630, audio represented by 634c, and/or audio represented by 656c) (e.g., machine-generated noise that is based on audio data of (e.g., received by) the computer system and output via one the one or more audio output devices of the computer system) that is based on the second captured sound (e.g., 610, 628, and/or 642). In some embodiments, the second audio output is playback (e.g., live playback) of the second captured sound.

In some embodiments, the computer system receives the indication of the second event from the second external device (e.g., 606a, 606b, 606c, 606e, 606f, and/or 606g) after the second external device detects the second event. In some embodiments, the computer system receives the indication of the second event via an external computer system, such as a server, that does not detect the second event. In some embodiments, the indication of the second event is detected by the second external device (e.g., 606b, 606c, 606f, and/or 606g) via sound recognition (e.g., the second external device includes one or more microphones that are configured to detect one or more predetermined sounds and/or noises). In some embodiments, the indication of the second event is received by the second external device (e.g., 606b, 606c, 606f, and/or 606g) based on a communication from an alarm and/or a sensor (e.g., 606a and/or 606e) in communication with the second external device, and the indication of the second event is directed (e.g., transmitted) to the computer system.

Enabling the computer system to output the second audio output that is based on the second captured sound captured by a fifth external device having the first configuration allows a user to obtain additional information about the second event, thereby improving safety and/or security features of the computer system.

In some embodiments, while the first time-based process is active, after receiving the indication of the second event, and in accordance with a determination that the fifth external device does not include the first configuration (e.g., the second external device is not configured to detect the second event and/or the second external device is not configured to transmit audio data to the computer system that is based on second sound captured by the second external device while the first time-based process is active), the computer system (e.g., 100, 300, 500, 580, 602, and/or 652) forgoes outputting, via the one or more audio output devices, the second audio output (e.g., audio represented by 614c, 630, audio represented by 634c, and/or audio represented by 656c) that is based on the second captured sound (e.g., 610, 628, and/or 642) (e.g., the computer system does not output the second audio output that is based on the second captured sound). In some embodiments, the computer system does not receive the second captured sound captured by the second external device because the second external device does not transmit audio data that includes and/or is based on the second captured sound.

Forgoing outputting the second audio output that is based on the second captured sound when the fifth external device does not include the first configuration allows a user to customize which devices are configured to transmit and/or provide captured sound, thereby improving safety and/or security features of the computer system.

In some embodiments, the first configuration is a configuration that enables a device (e.g., 606b, 606c, 606f, and/or 606g) that is configured with the first configuration to transmit (e.g., the first configuration is a setting that permits transmission of captured audio) captured sound (e.g., 610, 628, and/or 642) for output by the computer system (e.g., 100, 300, 500, 580, 602, and/or 652) (e.g., transmit audio data that includes and/or is based on the second captured sound directly to the computer system and/or indirectly to the computer system, such as via a server). The first configuration enabling a device that is configured with the first configuration to transmit captured sound for output by the computer system allows a user to customize which devices are configured to transmit and/or provide captured sound, thereby improving safety and/or security features of the computer system.

In some embodiments, after receiving the indication of the event associated with the fourth external device (e.g., 606b, 606c, 606f, and/or 606g), the computer system (e.g., 100, 300, 500, 580, 602, and/or 652) displays, via a display generation component (e.g., 602a and/or 652a) (e.g., a display controller, a touch-sensitive display system, a projector, a display screen, a display monitor, and/or a holographic display) in communication with the computer system, a first notification (e.g., 612, 616, 632, 644, 646, 648, and/or 652) (e.g., a first push notification, pop-up notification, and/or banner notification that includes text, one or more user interface objects, symbols, icons, and/or images associated with the event). In some embodiments, after receiving the indication of the second event (e.g., a time that is before or after receiving the indication of the event) associated with the fifth external device (e.g., 606b, 606c, 606f, and/or 606g), the computer system displays, via the display generation component in communication with the computer system, a second notification (e.g., 612, 616, 632, 644, 646, 648, and/or 654) (e.g., a second push notification, pop-up notification, and/or banner notification that includes text, one or more user interface objects, symbols, icons, and/or images associated with the second event).

Displaying the first notification after receiving the indication of the event and displaying the second notification after receiving the indication of the second event informs a user of the computer system that the first time-based process is active and/or that the computer system can output the audio based on the sound captured by the first external device and/or the second external device, thereby providing improved visual feedback.

In some embodiments, the event is associated with a sixth external device (e.g., 606b, 606c, 606f, and/or 606g) (e.g., a first external device that detected the event (e.g., via sound recognition)) having a second configuration (e.g., the first external device is configured to detect the event and/or the first external device is configured to transmit the first captured sound while the first time-based process is active), where the sixth external device (e.g., 606b, 606c, 606f, and/or 606g) is configured to capture the first captured sound (e.g., 610, 628, and/or 642) (e.g., the first external device includes one or more audio detection devices (e.g., a microphone) that enables the first external device to capture the first captured sound and transmit audio data to the computer system that includes the first captured sound and/or is based on the first captured sound). In some embodiments, while the first time-based process is active, the computer system (e.g., 100, 300, 500, 580, 602, and/or 652) receives an indication of a third event (e.g., an event detected by the third external device (e.g., a smart speaker, a smart camera, and/or a smart alarm) that is in communication with the computer system, such as an audio event indicative of an activated smoke alarm, an activated carbon monoxide detector, glass breaking, and/or a baby crying) associated with a seventh external device (e.g., 606b, 606c, 606f, and/or 606g), different from the sixth external device (e.g., 606b, 606c, 606f, and/or 606g). In some embodiments, while the first time-based process is active, after receiving the indication of the third event, and in accordance with a determination that the seventh external device (e.g., 606b, 606c, 606f, and/or 606g) includes the first configuration (e.g., the third external device is configured to detect the third event and/or the third external device is configured to transmit audio data to the computer system that is based on third sound captured by the third external device while the first time-based process is active), the computer system displays, via a display generation component (e.g., 602a and/or 652a) (e.g., a display controller, a touch-sensitive display system, a projector, a display screen, a display monitor, and/or a holographic display) in communication with the computer system a first selectable option (e.g., 644, 646, and/or 646) (e.g., a first affordance and/or user interface object) that, when selected, initiates output of the first audio output (e.g., audio represented by 614c, 630, audio represented by 634c, and/or audio represented by 656c) that is based on the first captured sound (e.g., 610, 628, and/or 642) captured by the sixth external device (e.g., 606b, 606c, 606f, and/or 606g) (e.g., activates and/or causes the one or more audio output devices of the computer system to output the first audio output that is based on the first captured sound captured by the first external device) and a second selectable option (e.g., 644, 646, and/or 648) (e.g., a second affordance and/or user interface object) that, when selected, initiates output of a third audio output (e.g., audio represented by 614c, 630, audio represented by 634c, and/or audio represented by 656c) that is based on a third captured sound (e.g., 610, 628, and/or 642) captured by the seventh external device (e.g., 606b, 606c, 606f, and/or 606g) (e.g., activates and/or causes the one or more audio output devices of the computer system to output the third audio output that is based on the third captured sound captured by the third external device). In some embodiments, the computer system is not configured to output the first audio output and the third audio output concurrently.

In some embodiments, the computer system receives the indication of the third event from the third external device after the third external device detects the third event. In some embodiments, the computer system receives the indication of the third event via an external computer system, such as a server, that does not detect the third event. In some embodiments, the indication of the third event is detected by the third external device via sound recognition (e.g., the third external device includes one or more microphones that are configured to detect one or more predetermined sounds and/or noises). In some embodiments, the indication of the third event is received by the third external device based on a communication from an alarm and/or a sensor in communication with the third external device, and the indication of the third event is directed (e.g., transmitted) to the computer system.

Displaying the first selectable option and the second selectable option allows a user of the computer system to select an external device for which to output audio while the first time-based process is active to obtain more information about the event and/or the third event, thereby improving safety and/or security features of the computer system.

Note that details of the processes described above with respect to method 700 (e.g., FIG. 7) are also applicable in an analogous manner to the methods described below. For example, methods 800 and 1000 optionally includes one or more of the characteristics of the various methods described above with reference to method 700. For example, a computer system that performs method 800 can capture sound that is output by a computer system that performs method 700 and/or a computer system that performs method 1000 can output the captured sound during a first time-based process. For brevity, these details are not repeated below.

FIG. 8 is a flow diagram illustrating a method for initiating a time-based event that includes transmitting captured audio using a computer system in accordance with some embodiments. Method 800 is performed at a computer system (e.g., 580, 606b, 606c, 606f, and/or 606g) (e.g., an electronic device; a smart device, such as a smartphone or a smartwatch; a mobile device; a head mounted display, a robot, a personal assistive device, a self-motive device, a wearable device) that is in communication with one or more audio detection devices (e.g., microphones). Some operations in method 800 are, optionally, combined, the orders of some operations are, optionally, changed, and some operations are, optionally, omitted.

As described below, method 800 provides an intuitive way for initiating a time-based event that includes transmitting captured audio. The method reduces the cognitive burden on a user for transmitting captured audio, thereby creating a more efficient human-machine interface. For battery-operated computing devices, enabling a user to transmit captured audio faster and more efficiently conserves power and increases the time between battery charges.

The computer system (e.g., 580, 606b, 606c, 606f, and/or 606g) receives (802) an indication of an event (e.g., kitchen sensor 606a outputting sound 610 and/or bedroom sensor 606e outputting sound 642) (e.g., an event detected by the computer system, such as an audio event indicative of an activated smoke alarm, an activated carbon monoxide detector, glass breaking, and/or a baby crying). In some embodiments, the indication of the event is detected by the computer system via sound recognition using the one or more audio detection devices. In some embodiments, the indication of the event is received by the computer system based on a communication from an alarm and/or a sensor (e.g., 606a and/or 606e) in communication with the computer system.

In response to receiving the indication of the event, the computer system (e.g., 580, 606b, 606c, 606f, and/or 606g) initiates (804) a first time-based process (e.g., a process that is configured to execute and/or continue for a predetermined duration of time that starts from a time at which the first time-based process is initiated and ends after the expiration of the predetermined duration of time (e.g., the process stops, does not execute, and/or ceases after the predetermined duration of time elapses) and/or when a set of one or more process-termination criteria are met), where during the first time-based process (e.g., during a phase of the process after receiving authorization to transmit audio data (e.g., authorization received from an external computer system)), audio data associated with sound captured (e.g., 610, 628, and/or 642) via the one or more audio detection devices (e.g., audio data associated with sound and/or noise in a physical environment in which the computer system is located and captured by the one or more audio detection devices) is enabled to be transmitted to an external computer system (e.g., 100, 300, 500, 602, and/or 652) (e.g., able to be transmitted and/or transmitted (e.g., to an external computer system, such as a phone, a smart phone, and/or a server)). In some embodiments, the audio data associated with sound captured via the one or more audio detection devices is transmitted to the external computer system in response to receiving a request (e.g., 650a, 650b, 650e, and/or 650g) to transmit the audio data (e.g., a request received from the external computer system). In some embodiments, the audio data associated with sound captured via the one or more audio detection devices is not transmitted to the external computer system until the request to transmit the audio data is received and/or detected.

At a first time (806) (e.g., a time during the process after enabling the transmission of captured audio (e.g., a time after receiving authorization to transmit the audio data associated with the sound captured via the one or more audio detection devices)) while the first time-based process is active, the computer system (e.g., 580, 606b, 606c, 606f, and/or 606g) transmits (808) the audio data associated with sound captured (e.g., 610, 628, and/or 642) via the one or more audio detection devices (e.g., transmitting (e.g., to an external computer system, such as a phone, a smart phone, and/or a server) audio data associated with sound and/or noise in a physical environment in which the computer system is located and captured by the one or more audio detection devices).

At a first time (806) (e.g., a time during the process after enabling the transmission of captured audio (e.g., a time after receiving authorization to transmit the audio data associated with the sound captured via the one or more audio detection devices)) while the first time-based process is active, the computer system (e.g., 580, 606b, 606c, 606f, and/or 606g) outputs (810) feedback (e.g., 620, 622, 636, and/or 638) (e.g., audio feedback (e.g., audio including speech, one or more audio bursts, and/or continuous audio that is output for a predetermined amount of time) and/or visual feedback (e.g., emitting light including a predetermined color via one or more lights in communication with the computer system and/or displaying a visual element on a display generation component in communication with the computer system) indicative of the transmission of the audio data associated with sound captured (e.g., 610, 628, and/or 642) via the one or more audio detection devices (e.g., the feedback provides a user that is located near and/or proximate to the computer system with an indication that sound and/or noise within a physical environment in which the computer system is located is being captured and transmitted (e.g., transmitted to an external computer system so that another user can listen to audio based on the audio data captured by the one or more audio detection devices)).

At a second time (812) (e.g., a time that is the same as, earlier than, or later than, the first time) while the first time-based process is active and in accordance with a determination that a set of one or more process-termination criteria are met (e.g., home 604 as it appears at FIG. 6J) (e.g., the set of one or more process-termination criteria are met when the computer system does not include an established communication connection with an external computer system that is configured to output audio data associated with the captured sound, when a predetermined amount of time from detection of the event has passed, and/or when the computer system receives and/or detects user input of a first type), where the set of one or more process-termination criteria includes a criterion that is met when a predetermined time (e.g., 15 minutes or 16 minutes) has elapsed since a third time (e.g., a time that the event was detected, a time after receiving authorization to transmit the captured sound, a time since starting the transmission of captured sound, and/or a time since captured sound was last detected after the event), the computer system (e.g., 580, 606b, 606c, 606f, and/or 606g) terminates (814) the first time-based process. In some embodiments, after the first time-based process is terminated and while the first time-based process is not active, captured sounds (e.g., sounds captured at an external device) are not transmitted to one or more external computer systems.

At a second time (812) (e.g., a time that is the same as, earlier than, or later than, the first time) while the first time-based process is active and in accordance with a determination that the set of one or more process-termination criteria are not met (e.g., home 604 as it appears at FIGS. 6B-6I) (e.g., the set of one or more process-termination criteria are not met when the computer system includes an established communication connection with an external computer system that is configured to output audio data associated with the captured sound, when a predetermined amount of time from detection of the event has not passed, and/or when the computer system does not receive and/or detect user input of a first type), the computer system (e.g., 580, 606b, 606c, 606f, and/or 606g) maintains (816) (e.g., continuing to run; continuing to transmit the audio data) the first time-based process (e.g., the process remains in an active state).

Terminating the first time-based process in accordance with a determination that the set of one or more process-termination criteria are met and maintaining the first time-based process in accordance with a determination that the set of one or more process termination criteria are not met enables the computer system to transmit audio data associated with captured sound for a finite duration after the indication of the event is received, thereby improving safety and security features of the computer system.

In some embodiments, the computer system (e.g., 580, 606b, 606c, 606f, and/or 606g) includes one or more sensors (e.g., acoustic sensors (e.g., microphones), optical sensors (e.g., cameras), contact sensors (e.g., touch-sensitive surfaces)). In some embodiments, receiving the indication of the event includes the computer system (e.g., 580, 606b, 606c, 606f, and/or 606g) detecting the event, via the one or more sensors (e.g., the computer system detects the event via the one or more audio detection devices and/or via the one or more sensors in communication with the computer system). The computer system detecting the event allows the computer system to begin transmitting the audio data associated with sound captured via the one or more audio detection devices more quickly, thereby improving safety and/or security features of the computer system.

In some embodiments, detecting the event includes the computer system (e.g., 580, 606b, 606c, 606f, and/or 606g) detecting, via the one or more audio detection devices, a first sound (e.g., 610 and/or 642) (e.g., an activated smoke alarm, an activated carbon monoxide detector, glass breaking, and/or a baby crying) that was determined to correspond to (e.g., matches) a sound of a recognized type (e.g., the computer system is configured to recognize one or more predetermined sounds, including the second sound via sound recognition techniques). The computer system detecting the event by detecting a first sound that was determined to correspond to a sound of a recognized type allows the computer system to begin transmitting the audio data associated with sound captured via the one or more audio detection devices more quickly, thereby improving safety and/or security features of the computer system.

In some embodiments, the sound of the recognized type is selected from the group consisting of: sound outputted by a smoke alarm (e.g., 606a and/or 606e) (e.g., sound output by a smoke alarm based on detecting a presence of smoke), sound outputted by a carbon monoxide detector (e.g., 606a and/or 606e) (e.g., sound output by a carbon monoxide detector based on detecting a presence of carbon monoxide), sound of glass breaking (e.g., a sound indicating that a window and/or other glass has broken), and sound of a baby crying. The sound of the recognized type including the sound outputted by a smoke alarm, sound outputted by a carbon monoxide detector, the sound of glass breaking, and/or the sound of a baby crying enables the computer system to detect events that affect the safety and/or security of a structure in which the computer system is located, thereby improving safety and/or security features of the computer system.

In some embodiments, while the first time-based process is active and prior to determining that the set of one or more process-termination criteria are met, the computer system (e.g., 580, 606b, 606c, 606f, and/or 606g) ceases to detect the first sound (e.g., 610 and/or 642). In some embodiments, in response to ceasing to detect the first sound (e.g., 610 and/or 642), the computer system maintains the first time-based process (in some embodiments, the first time-based process is maintained, even if the detected first sound is no longer detected). Maintaining the first time-based process in response to ceasing to detect the first sound allows the computer system to continue transmitting the audio data associated with sound captured via the one or more audio detection devices for a finite amount of time even when the computer system stops detecting the second sound, thereby improving safety and/or security features of the computer system.

In some embodiments, receiving the indication of the event includes the computer system (e.g., 580, 606b, 606c, 606f, and/or 606g) receiving information about the event (e.g., information that the event has been detected and/or that the event is occurring) from an external device (e.g., 606a and/or 606e) (e.g., a smoke alarm, a fire alarm, a carbon monoxide detector, a glass breaking sensor, a baby monitor, and/or a security alarm). Receiving the indication of the event from an external device enables the computer system to transmit the audio data associated with sound captured via the one or more audio detection devices even when the computer system cannot and/or does not detect the event, thereby improving safety and/or security features of the computer system.

In some embodiments, the computer system (e.g., 580, 606b, 606c, 606f, and/or 606g) includes an audio speaker. In some embodiments, outputting the feedback (e.g., 620, 622, 636, and/or 638) indicative of the transmission of the audio data associated with sound captured (e.g., 610, 628, and/or 642) via the one or more audio detection devices includes the computer system outputting, via the audio speaker, a first audio output (e.g., 622 and/or 638) (e.g., a predetermined sound/tone, a phrase (e.g., “alert event detected”) (e.g., audio output that is not based on the sound captured via the one or more audio detection devices, audio output that includes speech, and/or audio output that includes audio bursts that are output at predetermined intervals of time). Outputting first audio output as feedback indicative of the transmission of the audio data associated with sound captured via the one or more audio detection devices enables a person that is in proximity to the computer system to be informed that the audio data is being transmitted, thereby increasing safety and/or security features of the computer system.

In some embodiments, the first audio output (e.g., 622 and/or 638) includes speech (e.g., recorded human speech and/or synthesized speech) indicating that the audio data associated with sound captured (e.g., 610, 628, and/or 642) via the one or more audio detection devices is being transmitted (e.g., “A USER IS LISTENING IN”). Outputting first audio output that includes speech as feedback indicative of the transmission of the audio data associated with sound captured via the one or more audio detection devices enables a person that is in proximity to the computer system to be informed that the audio data is being transmitted, thereby increasing safety and/or security features of the computer system.

In some embodiments, the first audio output (e.g., 622 and/or 638) is output at predetermined intervals of time (e.g., every ten seconds, every thirty seconds, or every minute) while the first time-based process is active (e.g., the first audio output includes periodically (e.g., at the predetermined intervals of time) outputting audio (e.g., beeps, chimes, and/or tunes)). Outputting first audio output at predetermined intervals of time as feedback indicative of the transmission of the audio data associated with sound captured via the one or more audio detection devices enables a person that is in proximity to the computer system to be informed that the audio data is being transmitted, thereby increasing safety and/or security features of the computer system.

In some embodiments, the feedback (e.g., 620, 622, 636, and/or 638) indicative of the transmission of the audio data associated with sound captured (e.g., 610, 628, and/or 642) via the one or more audio detection devices includes the computer system (e.g., 580, 606b, 606c, 606f, and/or 606g) outputting light (e.g., 620 and/or 636) (e.g., light having a particular color, color temperature, brightness, pattern, and/or hue) via one or more lighting devices (e.g., light bulbs and/or light emitting diodes (“LEDs”)) in communication with the computer system. Outputting light as feedback indicative of the transmission of the audio data associated with sound captured via the one or more audio detection devices enables a person that is in proximity to the computer system to be informed that the audio data is being transmitted, thereby increasing safety and/or security features of the computer system.

In some embodiments, while the first time based process is active, the computer system (e.g., 580, 606b, 606c, 606f, and/or 606g) detects user input (e.g., 650f) (e.g., a press gesture and/or a tap gesture on a hardware input component and/or a touch-sensitive surface of the computer system) requesting to cease transmitting the audio data associated with sound captured (e.g., 610, 628, and/or 642) via the one or more audio detection devices (e.g., a request to stop capturing sound and transmitting audio data based on the captured sound). In some embodiments, in response to detecting the user input (e.g., 650f) requesting to cease transmitting the audio data associated with sound captured (e.g., 610, 628, and/or 642) via the one or more audio detection devices, the computer system (e.g., 580, 606b, 606c, 606f, and/or 606g) terminates the first time-based process (e.g., the computer system ceases (e.g., stopping and/or pausing) transmitting the audio data associated with sound captured via the one or more audio detection devices (e.g., to the external device) and/or ceases (e.g., stopping and/or pausing) outputting the feedback indicative of the transmission of the audio data associated with sound captured via the one or more audio detection devices (e.g., stopping, pausing, and/or forgoing outputting audio feedback and/or visual feedback indicating that the computer system is transmitting the audio data associated with sound captured via the one or more audio detection devices)).

In some embodiments, the request to cease transmitting the audio data associated with sound captured via the one or more audio detection devices includes an authentication input detected by the computer system and/or another computer system (e.g., the external computer system). In some embodiments, the request to cease transmitting the audio data associated with sound captured via the one or more audio detection devices is ignored and/or not detected when an authentication input is not associated with and/or included in the request.

Terminating the first time-based process in response to detecting the user input requesting to cease transmitting the audio data associated with sound captured via the one or more audio detection devices allows the computer system to stop transmitting the audio data before the predetermined time, thereby improving battery life of the computer system and increasing safety and/or security features of the computer system.

In some embodiments, while the first time-based process is active, the computer system (e.g., 580, 606b, 606c, 606f, and/or 606g) receives an indication of a request (e.g., 650c) to output (e.g., via one or more audio output devices (e.g., a speaker and/or a pair of headphones) in communication with the computer system) audio (e.g., 626) captured by a second external device (e.g., 100, 300, 500, 602, and/or 654) (in some embodiments, the second audio output is playback (e.g., live playback) of the third sound captured by the second external device). In some embodiments, in response to receiving the indication of the request (e.g., 650c) to output audio (e.g., 626) captured by the second external device, the computer system outputs (e.g., via the one or more audio output devices (e.g., a speaker and/or a pair of headphones) in communication with the computer system) audio (e.g., 626) captured by the second external device (e.g., outputting audio that is based on sound captured via an audio detection device (e.g., a microphone) of the second external device).

Outputting audio captured by a second external device in response to receiving the indication of the request allows a person that is in proximity to the computer system to communicate with and/or converse with a user of the second external device, thereby improving safety and/or security features of the computer system.

In some embodiments, the event is of a first type. In some embodiments, while the first time-based process is active, the computer system (e.g., 580, 606b, 606c, 606f, and/or 606g) receives (e.g., from an external device) an indication of a second event of a second type (e.g., an event detected by the computer system that is indicative of a sound that the computer system is not configured to process and/or report), different from the first type. In some embodiments, while the first time-based process is active and in response to receiving the indication of the second event of the second type, the computer system forgoes transmitting second audio data associated with sound captured (e.g., 610, 628, and/or 642) via the one or more audio detection devices (e.g., the computer system does not transmit audio data to an external device when the second event is of a type that is not processed and/or reported by the computer system). In some embodiments, the computer system is configured to report sounds of a first type to an external device, but is not configured to report sounds of a second type to the external device. In some embodiments, the computer system detects the sound of the second type, but does not report detecting the sound of the second type. In some embodiments, the computer system is not configured to detect the sound of the second type.

Forgoing transmitting second audio data associated with sound captured via the one or more audio detection devices allows a user to customize the types of events for which the computer system can output audio based on captured sound, thereby improving safety and/or security features of the computer system.

Note that details of the processes described above with respect to method 800 (e.g., FIG. 8) are also applicable in an analogous manner to the methods described below/above. For example, methods 700 and 1000 optionally includes one or more of the characteristics of the various methods described above with reference to method 800. For example, a computer system that performs method 700 can output the sound captured by a computer system that performs method 800 and/or a computer system that performs method 1000 can configure a computer system that performs method 800. For brevity, these details are not repeated below.

FIGS. 9A-9G illustrate exemplary user interfaces for configuring a device to initiate a time-based event, in accordance with some embodiments. The user interfaces in these figures are used to illustrate the processes described below, including the process in FIG. 10.

FIG. 9A illustrates electronic device 602 displaying home user interface 618, which enables electronic device 602 to control and/or otherwise adjust settings of the home automation system described above with reference to FIGS. 6A-6M. At FIG. 9A, home user interface 618 includes settings user interface object 618a, scenes region 900, and kitchen region 902. Scenes region 900 of home user interface 618 includes user interface objects 900a and 900b that, when selected, adjust a state and/or setting of one or more devices of home 604 to a predetermined state and/or setting. Kitchen region 902 includes speaker user interface object 902a corresponding to kitchen speaker 606b and sensor user interface object 902b corresponding to kitchen sensor 606a. As set forth below, in response to user input 950a (e.g., a tap gesture) selecting speaker user interface object 902a, electronic device 602 displays speaker setting user interface 930, as shown at FIG. 9G.

At FIG. 9A, electronic device 602 detects user input 950b (e.g., a tap gesture) corresponding to selection of settings user interface object 618a. In response to detecting user input 950b, electronic device 602 displays menu 904 including selectable options 904a-904j corresponding to various settings and/or configurations of home automation system and/or electronic device 602. At FIG. 9A, electronic device 602 detects user input 650c (e.g., a tap gesture) corresponding to selection of home settings user interface object 904h. In response to detecting user input 950c, electronic device 602 displays home settings user interface 906, as shown at FIG. 9B.

At FIG. 9B, home settings user interface 906 includes home indicator 906a that provides a visual indication and/or identification of a location (e.g., a physical location) of the home automation system, such as “123 Main St.” Home settings user interface 906 includes user region 908 which includes user interface objects 908a and 908b corresponding to user accounts and/or devices associated with users that have authorization to control and/or adjust settings of home automation system. Home settings user interface 906 includes settings user interface objects 906b-906f that, when selected, cause electronic device 602 to display one or more user interfaces associated with a particular category of settings of the home automation system. For instance, at FIG. 9B, electronic device 602 detects user input 950d (e.g., a tap gesture) corresponding to settings user interface object 906e associated with safety and security settings of the home automation system. In response to detecting user input 950d, electronic device 602 displays safety and security user interface 910, as shown at FIG. 9C.

At FIG. 9C, safety and security user interface 910 includes sound detection user interface object 914, notifications user interface object 916, and user region 918. Sound detection user interface object 914 is associated with configuring one or more devices (e.g., kitchen speaker 606b, dining room speaker 606c, bedroom speaker 606f, and/or living room speakers 606g) of the home automation system to detect and/or to not detect one or more sounds. As set forth below with reference to FIG. 9D, sound detection user interface object 914, when selected, allows electronic device 602 to enable or disable one or more of the devices of the home automation system to detect sounds associated with various events and/or enable or disable detection of particular types of sounds. At FIG. 9C, sound detection user interface object 914 includes sound indicator 914a that provides a visual indication of a number (e.g., one) of different sounds for which one or more devices of the home automation system are configured to detect. In some embodiments, electronic device 602 updates sound indicator 914a in response to one or more user inputs selecting sound user interface objects 922a-922c, as shown at FIG. 9D.

Notifications user interface object 916 is associated with enabling and/or disabling notifications associated with one or more devices of the home automation system. In some embodiments, electronic device 602 is configured to output notifications (e.g., notifications 612, 616, 632, 644, 646, and/or 648) in response to receiving an indication associated with an event, such as an event detected by one or more devices of the home automation system. In some embodiments, electronic device 602 disables and/or enables notifications associated with one or more devices of the home automation system detecting an event based. For instance, in response to detecting user input corresponding to notification user interface objects 928a and/or 928b, as shown at FIG. 9F, electronic device 602 is configured to adjust a notification setting for a respective device of the home automation system. In some embodiments, electronic device 602 disables and/or enables any notifications associated with respective devices of the home automation system based on user input corresponding to notification user interface objects 928a and/or 928b, as shown at FIG. 9F. At FIG. 9C, notifications user interface object 916 includes notifications indicator 916a, which provides a visual indication for a number of devices of the home automation system for which notifications are enabled (e.g., able to be received by electronic device 602 and/or other electronic devices). In some embodiments, electronic device 602 updates notifications indicator 916a based on user input corresponding to notification user interface objects 928a and/or 928b, as shown at FIG. 9F.

At FIG. 9C, user region 918 includes first user interface object 918a corresponding to a first user account that has authorization to access, control, and/or adjust the home automation system and second user interface object 918b corresponding to a second user account that has authorization to access, control, and/or adjust the home automation system. In some embodiments, the first user account is associated with a first user (e.g., a person) and enables the first user to sign into and/or use one or more first electronic devices to access, control, and/or adjust the home automation system. Similarly, in some embodiments, the second user account is associated with a second user (e.g., a second person) and enables the second user to sign into and/or use one or more second electronic devices to access, control, and/or adjust the home automation system.

At FIG. 9C, first user interface object 918a and second user interface object 918b are both in an active, enabled, and/or on position. When first user interface object 918a is in the active, enabled, and/or on position, the one or more first electronic devices associated with the first user account (“JANE APPLESEED”) are configured to output audio based on sound captured by respective devices of the home automation system (e.g., when the respective devices of the home automation system are configured to detect a first sound and/or when the respective devices of the home automation system detect the first sound). In some embodiments, in response to detecting user input corresponding to first user interface object 918a, electronic device 602 is configured to cause first user interface object 918a to transition to an inactive, disabled, and/or off position. When first user interface object 918a is in the inactive, disabled, and/or off position, the one or more first electronic devices associated with the first user account are not configured to output audio based on sound captured by respective devices of the home automation system (e.g., when the respective devices of the home automation system are configured to detect a first sound and/or when the respective devices of the home automation system detect the first sound).

Similarly, when second user interface object 918b is in the active, enabled, and/or on position, the one or more second electronic devices associated with the second user account (“JOHN APPLESEED”) are configured to output audio based on sound captured by respective devices of the home automation system (e.g., when the respective devices of the home automation system are configured to detect a first sound and/or when the respective devices of the home automation system detect the first sound). In some embodiments, in response to detecting user input corresponding to second user interface object 918b, electronic device 602 is configured to cause second user interface object 918b to transition to an inactive, disabled, and/or off position. When second user interface object 918b is in the inactive, disabled, and/or off position, the one or more second electronic devices associated with the second user account are not configured to output audio based on sound captured by respective devices of the home automation system (e.g., when the respective devices of the home automation system are configured to detect a first sound and/or when the respective devices of the home automation system detect the first sound). Accordingly, a user of electronic device 602 (e.g., a primary user associated with the home automation system and/or a main user associated with the home automation system) can configure whether various user accounts that have authorization to access, control, and/or adjust the home automation system have authorization to output audio based on sound captured by devices of the home automation system.

At FIG. 9C, electronic device 602 detects user input 950e (e.g., a tap gesture) corresponding to selection of sound detection user interface object 914. In response to detecting user input 950e corresponding to selection of sound detection user interface object 914, electronic device 602 displays sound detection user interface 920, as shown at FIG. 9D. Additionally or alternatively, at FIG. 9C, electronic device 602 detects user input 950f (e.g., a tap gesture) corresponding to selection of notifications user interface object 916. In response to detection of user input 950f corresponding to selection of notifications user interface object 916, electronic device 602 displays notifications user interface 928, as shown at FIG. 9F.

At FIG. 9D, sound detection user interface 920 includes sound region 922 and device region 924. Sound region 922 includes sound user interface objects 922a-922c corresponding to respective sounds indicative of events in which one or more devices of the home automation system are configured to detect (e.g., when one or more devices of the home automation system are enabled to detect the respective sounds). For instance, at FIG. 9D, first sound user interface object 922a corresponds to a smoke alarm sound, second sound user interface object 922b corresponds to a glass breaking sound, and third sound user interface object 922c corresponds to a carbon monoxide detector sound. In some embodiments, sound region 922 includes fewer than three sound user interface objects. In some embodiments, sound region 922 includes more than three sound user interface objects corresponding to additional sounds indicative of events in which one or more devices of the home automation system are configured to detect (e.g., baby crying sound and/or a security alarm sound).

At FIG. 9D, first sound user interface object 922a is in an active, enabled, and/or on position, such that one or more devices associated with device user interface objects 924a-924c (e.g., one or more devices associated with device user interface objects 924a-924c that are in the active, enabled, and/or on position) are configured to detect a smoke alarm sound and enable electronic device 602 (and, optionally, additional electronic devices) to output audio based on sound captured by the one or more devices. Second sound user interface object 922b and third sound user interface object 922c are in an inactive, disabled, and/or off position, such that the one or more devices associated with device user interface objects 924a-924c are not configured to detect a glass breaking sound and/or a carbon monoxide detector sound (e.g., the one or more devices do not provide information to electronic device 602 so that electronic device 602 is not configured to output audio based on sound captured by the one or more devices and/or the one or more devices ignore the glass breaking sound and/or the carbon monoxide detector sound).

At FIG. 9D, electronic device 602 detects user input 950g (e.g., a tap gesture) corresponding to second sound user interface object 922b. In some embodiments, in response to detecting user input 950g, electronic device 602 displays second sound user interface object 922b in the active, enabled, and/or on position. When second sound user interface object 922b is in the active, enabled, and/or on position, the one or more devices associated with device user interface objects 924a-924c (e.g., one or more devices associated with device user interface objects 924a-924c that are in the active, enabled, and/or on position) are configured to detect the glass breaking sound and electronic device 602 is configured to output audio based on sound captured by the one or more devices.

At FIG. 9D, electronic device 602 detects user input 950h (e.g., a tap gesture) corresponding to back user interface object 920a. In some embodiments, in response to detecting user input 950h, electronic device 602 displays safety and security user interface 910, as shown at FIG. 9C. After detecting user input 950g and in response to detecting user input 950h, electronic device 602 displays safety and security user interface 910 with sound indicator 914a including a “2” instead of a “1” to indicate that second sound user interface object 922b is in the active, enabled, and/or on position.

Device region 924 includes device user interface objects 924a-924c corresponding to devices of the home automation system that are configured to detect the sounds associated with sound user interface objects 922a-922c that are in the active, enabled, and/or on position. At FIG. 9D, first device user interface object 924a corresponds to bedroom speaker 606f, second device user interface object 924b corresponds to dining room speaker 606c, and third user interface object 924c corresponds to kitchen speaker 606b. In some embodiments, device region 924 includes less than three device user interface objects. In some embodiments, device region 924 includes more than three device user interface objects. In some embodiments, device region 924 includes a number of device user interface objects corresponding to a number of devices of the home automation system that are capable of detecting sound (e.g., devices that include a microphone and/or another sound detection device). For instance, in some embodiments, device region 924 includes one or more additional device user interface objects corresponding to living room speakers 606g.

At FIG. 9D, first device user interface object 924a and third device user interface object 924c are in the active, enabled, and/or on position, whereas second device user interface object 924b is in the inactive, disabled, and/or off position. Accordingly, bedroom speaker 606f and kitchen speaker 606b are configured to detect the smoke alarm sound and/or the glass breaking sound (e.g., when second sound user interface object 622b is in the active, enabled, and/or on position), but dining room speaker 606c is not configured to detect the smoke alarm sound and/or the glass breaking sound. Further, bedroom speaker 606f, dining room speaker 606c, and kitchen speaker 606b are not configured to detect the carbon monoxide detector sound because third sound user interface object 922c is in the inactive, disabled, and/or off position.

At FIG. 9D, when device user interface objects 924a-924c are in the active, enabled, and/or on position, the respective devices associated with device user interface objects 924a-924c are configured to transmit audio data based on sound captured by the respective devices to electronic device 602 (and/or another electronic device) after detecting the smoke alarm sound and/or the glass breaking sound. As set forth above, the respective devices are configured to transmit the audio data based on sound captured by the respective devices to electronic device 602 for a predefined amount of time of a time-based process (e.g., a time-based process that is initiated when the respective devices detect the smoke alarm sound and/or the glass breaking sound). In some embodiments, when device user interface objects 924a-924c are in the inactive, disabled, and/or off position, the respective devices associated with device user interface objects 924a-924c are not configured to transmit audio data based on sound captured by the respective devices to electronic device 602 (and/or another electronic device).

In some embodiments, electronic device 602 (and/or another electronic device) can configure settings of the respective devices associated with device user interface objects 924a-924b via a privacy settings user interface. In some embodiments, the privacy settings user interface can adjust whether the respective devices can provide captured sound to external electronic devices (e.g., electronic device 602 and/or other electronic devices). In some embodiments, the privacy settings user interface can enable a remote user (e.g., a user of electronic device 602) to monitor home 604, while respecting the privacy of individuals that are present in home 604. For instance, in some embodiments, the privacy settings user interface can prevent the respective devices from transmitting captured sound unless one or more criteria have been satisfied. In some embodiments, the one or more criteria include receiving approval from an individual that is present in home 604 (e.g., after a respective device detects an event that initiates the time-based process), detecting that one or more electronic devices associated with a respective user account is not present in home 604 (e.g., not connected to a wireless network associated with home 604 and/or location information of the electronic device indicates that the electronic device is not located at home 604), and/or that an event detected by a respective device is associated with a predetermined priority level and/or urgency level (e.g., the respective device can transmit captured sound when an event detected by the respective device is indicative of a high priority event (e.g., smoke detected and/or a security alarm being triggered) but does not transmit captured sound when an event detected by the respective is indicative of a low priority event (e.g., a baby crying)).

At FIG. 9D, electronic device 602 detects user input 950i (e.g., a tap gesture) corresponding to selection of second device user interface object 924b. In response to detecting user input 950i, electronic device 602 transitions second device user interface object 924b into the active, enabled, and/or on position, such that dining room speaker 606c is configured to detect the smoke alarm sound and/or the glass breaking sound (but not the carbon monoxide detector sound). In addition, at FIG. 9D, electronic device 602 detects user input 950j (e.g., a tap gesture) corresponding to selection of third device user interface object 924c. In response to detecting user input 950j, electronic device 602 transitions third device user interface object 924c into the inactive, disabled, and/or off position, such that kitchen speaker 606b is not configured to detect the smoke alarm sound and/or the glass breaking sound (and/or the carbon monoxide detector sound).

At FIG. 9E, while second device user interface object 924b is in the active, enabled, and/or on position and while third user interface object 924c is in the inactive, disabled, and/or off position, kitchen sensor 606a outputs sound 610, as shown at FIG. 6B. Even though kitchen speaker 606b is located closest to kitchen sensor 606a in home 604, kitchen speaker 606b is not configured to detect sound 610 (e.g., kitchen sensor 606a is a smoke alarm and sound 610 corresponds to the smoke alarm sound), and thus, kitchen speaker 606b does not send and/or transmit an indication of the event to electronic device 602. Instead, at FIG. 9E, dining room speaker 606c sends and/or transmits an indication of the event to electronic device 602. In some embodiments, because dining room speaker 606c is the closest device within home 604 to kitchen sensor 606a that is configured to detect sound 610, dining room speaker 606c is the first device to detect sound 610 and send and/or transmit the indication of the event to electronic device 602 (e.g., instead of kitchen speaker 606b, as shown at FIGS. 6B and 6C).

At FIG. 9E, electronic device 602 displays notification 926, which is based on electronic device 602 receiving the indication of the event from dining room speaker 606c. For instance, at FIG. 9E, notification 926 includes application indicator 926a, alert indicator 926b, home indicator 926c, and event information 926d. Application indicator 926a provides a visual indication (e.g., an icon, an image, and/or a symbol) of an application that is associated with notification 926, such as an application associated with the home automation system and/or an application that enables electronic device 602 to control the home automation system. Alert indicator 926b (e.g., “CRITICAL”) provides a visual indication as to a type and/or urgency of notification 926. Home indicator 926c provides a visual indication (e.g., “123 MAIN STREET”) about a location and/or identification of home 604 where the event occurred and/or was detected. Event information 926d includes information about the event, such as that dining room speaker 606c detected the event, the type of event (e.g., smoke alarm and/or kitchen sensor 606a being activated and/or triggered), and/or a time associated with the event.

At FIG. 9F, electronic device 602 displays notification user interface 928 in response to detecting user input 950f. Notifications user interface 928 includes first notification user interface object 928a corresponding to bedroom speaker 606f and second notification user interface object 928b corresponding to dining room speaker 606c. At FIG. 9F, notifications user interface 928 includes notification user interface objects associated with devices of home 604 that are configured and/or enabled to detect sounds (e.g., devices associated with device user interface objects 924a-924c that are in the active, enabled, and/or on position). In some embodiments, notifications user interface 928 includes notification user interface objects associated with all devices of home 604.

At FIG. 9F, first notification user interface object 928a indicates that notifications associated with bedroom speaker 606f are enabled (e.g., first notification user interface object 928a includes the text “ON”). When first notification user interface object 928a indicates that notifications associated with bedroom speaker 606f are enabled, electronic device 602 is configured to display and/or output notifications based on information received from bedroom speaker 606f For instance, when bedroom speaker 606f detects a smoke alarm sound and/or a glass breaking sound, bedroom speaker 606f sends information to electronic device 602 and electronic device 602 displays and/or outputs a notification based on the received information. In some embodiments, in response to detecting user input corresponding to first notification user interface object 928a, electronic device 602 is configured to forgo displaying and/or outputting notifications (e.g., notifications of a first type) based on information received from bedroom speaker 606f In some embodiments, in response to detecting user input corresponding to first notification user interface object 928a, electronic device 602 is configured to adjust an appearance of first notification user interface object 928a (e.g., change “ON” to “OFF”) to indicate that notifications associated with bedroom speaker 606f are disabled. In some embodiments, electronic device 602 is still configured to display a notification (e.g., notification 616 and/or notification 632) on home user interface 618 in response to receiving information from bedroom speaker 606f indicating that bedroom speaker 606f detected the smoke alarm sound and/or the glass breaking sound even when first notification user interface object 928a indicates that notifications associated with bedroom speaker 606f are disabled.

Second notification user interface object 928b indicates that notifications associated with dining room speaker 606c are enabled (e.g., second notification user interface object 928b includes the text “ON”). When second notification user interface object 928b indicates that notifications associated with dining room speaker 606c are enabled, electronic device 602 is configured to display and/or output notifications based on information received from dining room speaker 606c. For instance, when dining room speaker 606c detects a smoke alarm sound and/or a glass breaking sound, dining room speaker 606c sends information to electronic device 602 and electronic device 602 displays and/or outputs a notification based on the received information. In some embodiments, in response to detecting user input corresponding to second notification user interface object 928b, electronic device 602 is configured to forgo displaying and/or outputting notifications (e.g., notifications of a first type) based on information received from dining room speaker 606c. In some embodiments, in response to detecting user input corresponding to second notification user interface object 928b, electronic device 602 is configured to adjust an appearance of second notification user interface object 928b (e.g., change “ON” to “OFF”) to indicate that notifications associated with dining room speaker 606c are disabled. In some embodiments, electronic device 602 is still configured to display a notification (e.g., notification 616 and/or notification 632) on home user interface 618 in response to receiving information from dining room speaker 606c indicating that dining room speaker 606c detected the smoke alarm sound and/or the glass breaking sound even when second notification user interface object 928b indicates that notifications associated with dining room speaker 606c are disabled.

As set forth above, in response to detecting user input 950a selecting speaker user interface object 902a, electronic device 602 displays speaker setting user interface 930, as shown at FIG. 9G. At FIG. 9G, speaker setting user interface 930 includes safety and security region 932. Safety and security region 932 includes sound detection user interface object 932a and notifications user interface object 932b. In some embodiments, in response to detecting user input selecting sound detection user interface object 932a, electronic device 602 displays sound detection user interface 914, as shown at FIG. 9D. In some embodiments, in response to detecting user input selecting sound detection user interface object 932a, electronic device 602 enables and/or disables an ability of kitchen speaker 606b to detect sounds associated with sound user interface objects 922a-922c (e.g., sounds associated with sound user interface objects 922a-922c that are in the active, enabled, and/or on position). In some embodiments, in response to detecting user input selecting notifications user interface object 932b, electronic device 602 displays notification user interface 928, as shown at FIG. 9F. In some embodiments, in response to detecting user input selecting notifications user interface object 932b, electronic device 602 enables and/or disables an ability of electronic device 602 to display and/or output notifications associated with kitchen speaker 606b.

In some embodiments, electronic device 602 is configured to display one or more user interfaces for configuring one or more devices of the home automation system to detect different types of sounds during a setup process of the home automation system and/or a respective of the home automation system. Accordingly, electronic device 602 is configured to provide different ways of allowing a user to configure settings of one or more devices of the home automation system for detecting different types of sounds and for managing which devices (e.g., smart speakers) report events based on the selected sounds.

FIG. 10 is a flow diagram illustrating a method for configuring a device to initiate a time-based event using a computer system in accordance with some embodiments. Method 1000 is performed at a computer system (e.g., 100, 300, 500, 580, 602, and/or 652) (e.g., an electronic device; a smart device, such as a smartphone or a smartwatch; a mobile device; a wearable device) that is in communication with a display generation component (e.g., 602a and/or 652a) (e.g., a display controller, a touch-sensitive display system, a projector, a display screen, a display monitor, and/or a holographic display). Some operations in method 1000 are, optionally, combined, the orders of some operations are, optionally, changed, and some operations are, optionally, omitted.

As described below, method 1000 provides an intuitive way for configuring a device to initiate a time-based event. The method reduces the cognitive burden on a user for configuring a device to initiate a time-based event, thereby creating a more efficient human-machine interface. For battery-operated computing devices, enabling a user to configure a device to initiate a time-based event faster and more efficiently conserves power and increases the time between battery charges.

The computer system (e.g., 100, 300, 500, 580, 602, and/or 652) displays (1002), via the display generation component (e.g., 602a and/or 652a), a user interface (e.g., 920) (e.g., a user interface associated with a home automation system that is configured to be controlled and/or adjusted via the computer system).

The user interface (e.g., 920) includes a first user interface object (1004) (e.g., 922a-922c) (e.g., an affordance, a selectable user interface object having an active position and an inactive position, and/or a slider) that, when selected, modifies the state of a first setting (e.g., a sound detection event of a first type, such as detection of a smoke detector, a carbon monoxide detector, glass breaking, and/or a baby crying), where the first setting, when in a first state (e.g., a state of first sound user interface object 922a shown at FIG. 9D) (e.g., an active position, an authorized position, and/or an enabled position), enables (e.g., by transmitting instructions to the set of one or more external devices directly or to an intermediate server) the computer system to report an event (e.g., display notification 612, 616, 632, 644, 646, 648, and/or 654) (e.g., as a push notification and/or as a banner in a user interface (e.g., of a home application) based on a sound (e.g., 610 and/or 642) of a first type (e.g., the set of one or more external computer systems provide an indication (e.g., a notification) associated with the event based on the captured sound of the first type to the computer system and/or to one or more additional computer systems) that is detected by at least a first external computer system (e.g., 606b, 606c, 606f, and/or 606g) of a set of one or more external computer systems (e.g., 606b, 606c, 606f, and/or 606g) (e.g., one or more external computer systems that are in communication with the computer system via a wireless communication technique (e.g., Bluetooth, WiFi, another Internet connection, and/or near-field communication)). In some embodiments, when the first setting is not in the first state (e.g., a state of second and third sound user interface objects 922b and 922c shown at FIG. 9D) (e.g., the setting is disabled), the set of one or more external computer systems do not report events based on sound of the first type or do not monitor for sounds of the first type, at all. In some embodiments, when the first setting is not in the first state (e.g., the setting is disabled), the computer system receives data from the set of one or more external computer system based on detection of sounds of a respective type, but does not report such events.

The user interface (e.g., 920) includes a second user interface object (1006) (e.g., 922a-922c) (e.g., an affordance, a selectable user interface object having an active position and an inactive position, and/or a slider) that, when selected, modifies the state of a second setting (e.g., a sound detection event of a second type, such as detection of a smoke detector, a carbon monoxide detector, glass breaking, and/or a baby crying), where the second setting, when in a second state (e.g., a state of first sound user interface object 922a shown at FIG. 9D) (e.g., an active position, an authorized position, and/or an enabled position), enables the computer system (e.g., 100, 200, 500, 580, 602, and/or 652) to report an event (e.g., display notification 612, 616, 632, 644, 646, 648, and/or 654) (e.g., as a push notification and/or as a banner in a user interface (e.g., of a home application) based on a sound (e.g., 610 and/or 642) of a second type, different from the first type (e.g., the set of one or more external computer systems provide an indication (e.g., a notification) associated with the event based on the captured sound of the second type to the computer system and/or to one or more additional computer systems), that is detected by at least a second external computer system (e.g., 606b, 606c, 606f, and/or 606g) (e.g., that is the same as or different from the first external computer system) of the set of one or more external computer systems (e.g., 606b, 606c, 606f, and/or 606g) (e.g., one or more external computer systems that are in communication with the computer system via a wireless communication technique (e.g., Bluetooth, WiFi, another Internet connection, and/or near-field communication)).

The user interface (e.g., 920) includes a third user interface object (1008) (e.g., 924a-924c) (e.g., an affordance, a selectable user interface object having an active position and an inactive position, and/or a slider) that, when selected, modifies the state of a third setting (e.g., an ability of the computer system to output audio that is based on sound captured by a first external computer system), where the third setting, when in a third state (e.g., a state of device user interface objects 924a and 924c shown at FIG. 9D) (e.g., an active position, an authorized position, and/or an enabled position), causes a third external computer system (e.g., 606b, 606c, 606f, and/or 606g) to be included in the set of one or more external computer systems (e.g., 606b, 606c, 606f, and/or 606g) (e.g., an external computer system that is in communication with the computer system via a wireless communication technique (e.g., Bluetooth, WiFi, another Internet connection, and/or near field communication) is included in the set of one or more external computer systems that is configured to report an event based on a sound of a first type and/or a second type based on whether the first setting is in the first state and/or the second setting is in the second state, respectively). In some embodiments, when the third setting is not in the third state (e.g., the state of device user interface object 924b shown at FIG. 9D) (e.g., the setting is disabled), the third external computer system is not included in the set of one or more external computer systems, such that the third external computer system does not report events based on sound detected by the third external computer system.

The user interface (e.g., 920) includes a fourth user interface object (1010) (e.g., 924a-924c) (e.g., an affordance, a selectable user interface object having an active position and an inactive position, and/or a slider) that, when selected, modifies the state of a fourth setting (e.g., an ability of the computer system to output audio that is based on sound captured by a second external computer system), where the fourth setting, when in a fourth state (e.g., a state of device user interface objects 924a and 924c shown at FIG. 9D) (e.g., an active position, an authorized position, and/or an enabled position), causes a fourth external computer system (e.g., 606b, 606c, 606f, and/or 606g), different from the third external computer system (e.g., 606b, 606c, 606f, and/or 606g), to be included in the set of one or more external computer systems (e.g., 606b, 606c, 606f, and/or 606g) (e.g., an external computer system that is in communication with the computer system via a wireless communication technique (e.g., Bluetooth, WiFi, another Internet connection, and/or near field communication) is included in the set of one or more external computer systems that is configured to report an event based on a sound of a first type and/or a second type based on whether the first setting is in the first state and/or the second setting is in the second state, respectively).

Displaying the user interface that includes the first user interface object, the second user interface object, the third user interface object, and the fourth user interface object allows a user of the computer system to customize and/or otherwise change settings related to which types of sounds a set of one or more external computer systems are configured to detect and which external computer systems are included in the set of one or more external computer systems without having to navigate to additional user interfaces, thereby reducing the number of inputs needed to perform an operation and improving safety and/or security features of the computer system.

In some embodiments, after reporting the event (e.g., displaying notification 612, 616, 632, 644, 646, 648, and/or 654) based on the sound (e.g., 610 and/or 642) of the first type that is detected by at least the first external computer system (e.g., 606b, 606c, 606f, and/or 606g) of the set of one or more external computer systems (e.g., 606b, 606c, 606f, and/or 606g) (e.g., the computer system receives information from at least the first external computer system indicating that the first external computer system detecting the sound of the first type), the computer system (e.g., 100, 300, 500, 580, 602, and/or 652) outputs first audio output (e.g., audio represented by 614c, 630, audio represented by 634c, and/or audio represented by 656c) (e.g., machine-generated noise that is based on audio data of (e.g., received by) the computer system and output via one the one or more audio output devices of the computer system) that is based on sound (e.g., 610, 628, and/or 642) captured by the first external computer system (e.g., 606b, 606c, 606f, and/or 606g) (in some embodiments, the first audio output is playback (e.g., live playback) of the first captured sound). Outputting first audio output that is based on sound captured by the first external computer system allows a user of the computer system to obtain additional information about the event, thereby improving safety and/or security features of the computer system.

In some embodiments, after reporting the event (e.g., displaying notification 612, 616, 632, 644, 646, 648, and/or 654) based on the sound (e.g., 610 and/or 642) of the first type that is detected by at least the first external computer system (e.g., 606b, 606c, 606f, and/or 606g) of the set of one or more external computer systems (e.g., 606b, 606c, 606f, and/or 606g) and in accordance with a determination that a fifth external computer system (e.g., 606b, 606, 606f, and/or 606g) (e.g., an external computer system that is in communication with the computer system via a wireless communication technique (e.g., Bluetooth, WiFi, another Internet connection, and/or near-field communication)) is not included in the set of one or more external computer systems (e.g., 606b, 606c, 606f, and/or 606g) (e.g., the fifth external computer system is not configured to detect and/or is configured to ignore the sound of the first type because the fifth external computer system is not included in the set of one or more external computer systems), the computer system (e.g., 100, 300, 500, 580, 602, and/or 652) forgoes outputting second audio output (e.g., audio represented by 614c, 630, audio represented by 634c, and/or audio represented by 656c) that is based on sound (e.g., 610, 628, and/or 642) captured by the fifth external computer system (e.g., 606b, 606c, 606f, and/or 606g) (e.g., the computer system does not and/or cannot output audio based on sound captured by the fifth external computer system because the fifth external computer system is not configured to detect and/or is configured to ignore the sound of the first type).

Forgoing outputting second audio output that is based on sound captured by the fifth external computer system when the fifth external computer system is not included in the set of one or more external computer systems allows a user of the computer system customize and/or change which external computer systems can detect the sound of the first type and/or which external computer systems can provide audio data based on captured sound to the computer system, thereby improving safety and/or security features of the computer system.

In some embodiments, while outputting the first audio output (e.g., audio represented by 614c, 630, audio represented by 634c, and/or audio represented by 656c) that is based on sound (e.g., 610, 628, and/or 642) captured by the first external computer system (e.g., 606b, 606c, 606f, and/or 606g) and in accordance with a determination that a predetermined time (e.g., minutes or 16 minutes) has elapsed since a first time (e.g., a time that the event was detected, a time after receiving an input (e.g., on a notification issued in response to the event), a time since starting the output of audio of captured sound, and/or a time since captured sound was last detected (e.g., by an external device) after the event), the computer system (e.g., 100, 300, 500, 580, 602, and/or 652) ceases outputting the first audio output (e.g., audio represented by 614c, 630, audio represented by 634c, and/or audio represented by 656c) that is based on sound (e.g., 610, 628, and/or 642) captured by the first external computer system (e.g., 606b, 606c, 606f, and/or 606g) (e.g., the computer system stops outputting the first audio output because a time-based process that, when active, enables the computer system to output the first audio output terminates when the predetermined time has elapsed since the first time). In some embodiments, while outputting the first audio output (e.g., audio represented by 614c, 630, audio represented by 634c, and/or audio represented by 656c) that is based on sound (e.g., 610, 628, and/or 642) captured by the first external computer system (e.g., 606b, 606c, 606f, and/or 606g) and in accordance with a determination that the predetermined time (e.g., 15 minutes or 16 minutes) has not elapsed since the first time (e.g., a time that the event was detected, a time after receiving an input (e.g., on a notification issued in response to the event), a time since starting the output of audio of captured sound, and/or a time since captured sound was last detected (e.g., by an external device) after the event), the computer system (e.g., 100, 300, 500, 580, 602, and/or 652) maintains outputting the first audio output (e.g., audio represented by 614c, 630, audio represented by 634c, and/or audio represented by 656c) that is based on sound (e.g., 610, 628, and/or 642) captured by the first external computer system (e.g., 606b, 606c, 606f, and/or 606g) (e.g., the computer system continues outputting the first audio output because a time-based process that, when active, enables the computer system to output the first audio output has not terminated when the predetermined time has not elapsed since the first time).

Enabling the computer system to output the first audio output that is based on sound captured by the first external computer system for the predetermined time since the first time provides a finite period of time for the user of the computer system to obtain additional information about the event, thereby improving safety and/or security features of the computer system.

In some embodiments, the third setting, when in a fifth state (e.g., a state of device user interface object 924b shown at FIG. 9D) (e.g., an inactive position, an unauthorized position, and/or a disabled position), different from the third state, causes the third external computer system (e.g., 606b, 606c, 606f, and/or 606g) to not be included in the set of one or more external computer systems (e.g., 606b, 606c, 606f, and/or 606g) (e.g., an external computer system that is in communication with the computer system via a wireless communication technique (e.g., Bluetooth, WiFi, another Internet connection, and/or near field communication) is not included in the set of one or more external computer systems that is configured to report an event based on a sound of a first type and/or a second type based on whether the first setting is in the first state and/or the second setting is in the second state, respectively). Not including the third external computer system in the set of one or more external computer systems when the third setting is in a fifth state allows a user of the computer system customize and/or change which external computer systems can detect the sound of the first type and/or the sound of the second type and/or which external computer systems can provide audio data based on captured sound to the computer system, thereby improving safety and/or security features of the computer system.

In some embodiments, while displaying, via the display generation component, a second user interface (e.g., 910) (e.g., the first user interface or a user interface that is different from the user interface) that includes a fifth user interface object (e.g., 916) (e.g., an affordance and/or a selectable user interface object), the computer system (e.g., 100, 300, 500, 580, 602, and/or 652) detects a first user input (e.g., 950f) (e.g., a tap gesture, a press gesture, and/or user input on a hardware input device of the computer system) corresponding to selection of the fifth user interface object (e.g., 916). In some embodiments, in response to detecting the first user input (e.g., 950f), the computer system (e.g., 100, 300, 500, 580, 602, and/or 652) displays, via the display generation component (e.g., 602a and/or 652a), a sixth user interface object (e.g., 928a and/or 928b) (e.g., an affordance, a selectable user interface object having an active position and an inactive position, and/or a slider) that, when selected, modifies a state of a fifth setting (e.g., an ability of the computer system to output notifications when an external computer system of the set of one or more external computer systems detect the sound of the first type and/or the sound of the second type), where the fifth setting, when in a sixth state (e.g., the state of notification user interface objects 928a and/or 928b shown at FIG. 9F) (e.g., an active position, an authorized position, and/or an enabled position), enables the computer system (e.g., 100, 300, 500, 580, 602, and/or 652) to output a notification (e.g., 612, 616, 632, 644, 646, 648, and/or 654) associated with a sixth external computer system (e.g., 606b, 606c, 606f, and/or 606g) when an event based on a sound (e.g., 610 and/or 642) of a respective type is detected by the sixth external computer system (e.g., 606b, 606c, 606f, and/or 606g) (e.g., the computer system is configured to output and/or display a notification when a sixth external computer system of the set of one or more external computer systems detects the sound of the first type and/or the sound of the second type).

Enabling the computer system to output a notification associated with a sixth external computer system when an event based on a sound of a respective type is detected by the sixth external setting and when the fifth setting is in a sixth state allows a user to customize and/or change whether the computer system outputs or does not output notifications when events are detected by a respective external computer system, thereby reducing battery usage of the computer system and improving safety and/or security features of the computer system.

In some embodiments, the second user interface (e.g., 910) includes a sixth user interface object (e.g., 914) (e.g., an affordance and/or a selectable user interface object) that, when selected, displays the user interface (e.g., 920) (e.g., causes the computer system to display the user interface), and the sixth user interface object (e.g., 914) includes an indication (e.g., 914a) (e.g., text, a symbol, an icon, and/or an image) of a number of sound types (e.g., the first sound type, the second type) for which the computer system (e.g., 100, 300, 500, 580, 602, and/or 652) is enabled to report events (e.g., a number of types of sounds corresponding to events in which the set of one or more external computer systems are configured to detect and that the computer system is configured to report). Displaying the sixth user interface object that includes an indication of a number of sound types for which the computer system is enabled report events allows a user of the computer system to confirm the number of events that the computer system is enabled to report, thereby providing improved visual feedback.

In some embodiments, the computer system (e.g., 100, 300, 500, 580, 602, and/or 652) displays, via the display generation component (e.g., 602a and/or 652a), a third user interface (e.g., 910) (e.g., a user interface that is different from the user interface). In some embodiments, the third user interface (e.g., 910) includes a seventh user interface object (e.g., 918a and/or 918b) (e.g., an affordance, a selectable user interface object having an active position and an inactive position, and/or a slider) that, when selected, modifies a state of a sixth setting (e.g., an ability of an external computer system associated with a user account to output audio that is based on sound captured by a second external computer system), where the sixth setting, when in a seventh state (e.g., a state of first and second user interface objects 918a and 918b shown at FIG. 9C) (e.g., an active position, an authorized position, and/or an enabled position), enables a seventh external computer system (e.g., 100, 300, 500, 580, 602, and/or 652) (e.g., an electronic device; a smart device, such as a smartphone or a smartwatch; a mobile device; a wearable device) associated with a first user account (e.g., accounts associated with “JANE APPLESEED” and/or “JOHN APPLESEED” shown at FIG. 9C) (e.g., a user account that authorizes a user to log into and/or use the seventh external computer system) to report an event (e.g., as a push notification and/or as a banner in a user interface (e.g., of a home application) based on a sound (e.g., 610 and/or 642) of a third type (e.g., the set of one or more external computer systems provide an indication (e.g., a notification) associated with the event based on the captured sound of the third type to the seventh external computer system) that is detected by at least an eighth external computer system (e.g., 606b, 606c, 606f, and/or 606g) of the set of one or more external computer systems (e.g., 606b, 606c, 606f, and/or 606g) (e.g., one or more external computer systems that are in communication with the seventh external computer system via a wireless communication technique (e.g., Bluetooth, WiFi, another Internet connection, and/or near-field communication)). In some embodiments, when the sixth setting is not in the seventh state (e.g., a disabled state), the seventh computer system associated with the first user account is not enabled to report the event based on the sound of the third type that is detected by at least the eighth external computer system of the set of one or more external computer systems.

Enabling the seventh external computer system to report an event based on a sound of a third type that is detected by at least an eight external computer system of the set of one or more external computer systems when the sixth setting is in the seventh state allows a user to provide authorization for respective users to use external computer systems to output audio based on sound captured by the set of one or more external computer systems, thereby improving safety and/or security features of the computer system.

In some embodiments, the user interface (e.g., 920) is associated with an application of a home automation system (e.g., the user interface enables the computer system to control and/or adjust a state of one or more devices of a home automation system) that includes (e.g., one or more functions of the external computer systems are controllable via the application) the set of one or more external computer systems (e.g., 606b, 606c, 606f, and/or 606g). The user interface being associated with an application of a home automation system enables a user to customize settings of the set of one or more external computer systems without having to navigate to additional user interfaces, thereby reducing the number of inputs needed to perform an operation.

In some embodiments, the user interface (e.g., 920) is a settings user interface associated with a ninth external computer system (e.g., 606b, 606c, 606f, and/or 606g) (e.g., a user interface that enables the computer system to adjust, change, and/or configure settings of at least the ninth external computer system). The user interface being a settings user interface associated with a ninth external computer system allows a user to configure settings of the set of one or more external computer systems while adjusting settings of the ninth external computer system without having to navigate to additional user interfaces, thereby reducing the number of inputs needed to perform an operation.

In some embodiments, the user interface (e.g., 920) is a setup user interface (e.g., a user interface that is displayed by the computer system during an initial setup process, such as a process that enables the computer system to communicate with, control, and/or adjust a state of the tenth external computer system) that is displayed during a process for adding a tenth external computer system (e.g., 606b, 606c, 606f, and/or 606g) to a home automation system that includes the set of one or more external computer systems (e.g., 606b, 606c, 606f, and/or 606g) (e.g., adding a new device and/or computer system to the home automation system so that the computer system can communicate with, control, and/or adjust a state of the tenth external computer system). Displaying the user interface as a setup user interface allows a user to configure settings of the tenth external computer system and/or the set of one or more external computer systems while configuring the tenth external computer system without having to navigate to additional user interfaces, thereby reducing the number of inputs needed to perform an operation.

In some embodiments, the sound (e.g., 610 and/or 642) of the first type is selected from the group consisting of: sound outputted by a smoke alarm (e.g., 606a and/or 606e) (e.g., sound output by a smoke alarm based on detecting a presence of smoke), sound outputted by a carbon monoxide detector (e.g., 606a and/or 606e) (e.g., sound output by a carbon monoxide detector based on detecting a presence of carbon monoxide), sound of glass breaking (e.g., a sound indicating that a window and/or other glass has broken), and sound of a baby crying. The sound of the first type including the sound outputted by a smoke alarm, the sound outputted by a carbon monoxide detector, the sound of glass breaking, and/or the sound of baby crying enables the set of one or more external computer systems to detect events that affect the safety and/or security of a structure in which the computer system is located, thereby improving safety and/or security features of the computer system.

In some embodiments, the first external computer system (e.g., 606b, 606c, 606f, and/or 606g) (in some embodiments, the third external computer system) is a smart speaker (e.g., a speaker that is configured to perform operations in addition to outputting audio, such as controlling one or more devices, connecting to the Internet, and/or providing notifications associated with incoming messages and/or communications, schedules, and/or alarms). The first external computer system being a smart speaker allows the smart speaker to perform additional operations that enhance the safety and/or security of an environment in which the smart speaker is located, thereby improving safety and/or security features of the computer system.

Note that details of the processes described above with respect to method 1000 (e.g., FIG. 10) are also applicable in an analogous manner to the methods described above. For example, methods 700 and/or 800 optionally includes one or more of the characteristics of the various methods described above with reference to method 1000. For example, a computer system that performs method 700 can display the user interface and/or a computer system that performs method 800 can be configured by a computer system that performs method 1000. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to notify users of events. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver notifications about an event. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing event notifications, the present technology can be configured to allow users to select to “opt in” or “opt out” of participation in the collection of personal information data during registration for services or anytime thereafter. In another example, users can select not to be notified of an event and/or not to enable communication between various devices. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, notifications about an event can based on non-personal information data or a bare minimum amount of personal information, such as the content being requested by the device associated with a user, other non-personal information, or publicly available information.

What is claimed is:

1. A computer system configured to communicate with one or more audio output devices, comprising:
one or more processors; and
memory storing one or more programs configured to be executed by the one or more processors, the one or more programs including instructions for:
receiving an indication of an event;
in response to receiving the indication of the event, initiating a first time-based process, wherein during the first time-based process, captured sound is outputted via the one or more audio output devices;
at a first time while the first time-based process is active:
receiving a first captured sound; and
outputting, via the one or more audio output devices, a first audio output that is based on the first captured sound; and
at a second time while the first time-based process is active:
in accordance with a determination that a set of one or more process-termination criteria are met, wherein the set of one or more process-termination criteria includes a criterion that is met when a predetermined time has elapsed since a third time, terminating the first time-based process; and
in accordance with a determination that the set of one or more process-termination criteria are not met, maintaining the first time-based process.

2. The computer system of claim 1, wherein the one or more programs further include instructions for:
in response to receiving the indication of the event and while the first time-based process is active, displaying, via a display generation component in communication with the computer system, a notification associated with the event.

3. The computer system of claim 2, wherein the one or more programs further include instructions for:
while displaying the notification associated with the event and while the first time-based process is active, detecting a user input corresponding to selection of the notification, wherein outputting the first audio output that is based on the first captured sound occurs in response to the user input corresponding to selection of the notification.

4. The computer system of claim 2, wherein the one or more programs further include instructions for:
in accordance with a determination that the predetermined time has elapsed since the third time, ceasing display of the notification associated with the event.

5. The computer system of claim 2, wherein the notification associated with the event includes an indication with information about the event.

6. The computer system of claim 2, wherein the notification associated with the event is displayed on a user interface of an application associated with a home automation system.

7. The computer system of claim 1, wherein the one or more programs further include instructions for:
while outputting the first audio output that is based on the first captured sound and while the first time-based process is active, detecting a user input requesting to cease outputting the first audio output that is based on the first captured sound; and
in response to detecting the user input requesting to cease outputting the first audio output that is based on the first captured sound, ceasing output of the first audio output that is based on the first captured sound.

8. The computer system of claim 7, wherein the one or more programs further include instructions for:
after ceasing output of the first audio output that is based on the first captured sound and while the first time-based process is active:
in accordance with the determination that the set of one or more process-termination criteria are not met, maintaining the first time-based process.

9. The computer system of claim 7, wherein the one or more programs further include instructions for:
after ceasing output of the first audio output that is based on the first captured sound and while the first time-based process is active:
in accordance with the determination that the set of one or more process-termination criteria are not met, displaying, via a display generation component in communication with the computer system, a second notification associated with the event, wherein the second notification, when selected, is configured to initiate output, via the one or more audio output devices, of the first audio output that is based on the first captured sound.

10. The computer system of claim 1, wherein the set of one or more process-termination criteria includes a second criterion that is met when an indication is received that indicates that an external device configured to capture the first captured sound has detected a user input of a first type.

11. The computer system of claim 1, wherein the one or more programs further include instructions for:
while the first time-based process is active, displaying, via a display generation component that is in communication with the computer system, a camera view of a camera device that is associated with a first external device configured to capture the first captured sound.

12. The computer system of claim 1, wherein receiving the indication of the event includes receiving information from a second external device about the second external device detecting sound that was determined to correspond to a sound of a recognized type.

13. The computer system of claim 12, wherein the sound of the recognized type is selected from the group consisting of: sound outputted by a smoke alarm, sound outputted by a carbon monoxide detector, sound of glass breaking, and sound of a baby crying.

14. The computer system of claim 1, wherein receiving the indication of the event includes receiving information from a third external device about the third external device being in an active state.

15. The computer system of claim 1, wherein the event is associated with a fourth external device having a first configuration, wherein the first external device is configured to capture the first captured sound, and wherein the one or more programs further include instructions for:
while the first time-based process is active, receiving an indication of a second event associated with a fifth external device, different from the fourth external device; and
while the first time-based process is active and after receiving the indication of the second event:
in accordance with a determination that the fifth external device includes the first configuration:
receiving a second captured sound captured by the fifth external device; and
outputting, via the one or more audio output devices, a second audio output that is based on the second captured sound.

16. The computer system of claim 15, wherein the one or more programs further include instructions for:
while the first time-based process is active and after receiving the indication of the second event:
in accordance with a determination that the fifth external device does not include the first configuration:
forgoing outputting, via the one or more audio output devices, the second audio output that is based on the second captured sound.

17. The computer system of claim 15, wherein the first configuration is a configuration that enables a device that is configured with the first configuration to transmit captured sound for output by the computer system.

18. The computer system of claim 15, wherein the one or more programs further include instructions for:
after receiving the indication of the event associated with the fourth external device, displaying, via a display generation component in communication with the computer system, a first notification; and
after receiving the indication of the second event associated with the fifth external device, displaying, via the display generation component in communication with the computer system, a second notification.

19. The computer system of claim 1, wherein the event is associated with a sixth external device having a second configuration, wherein the sixth external device is configured to capture the first captured sound, and wherein the one or more programs further include instructions for:
while the first time-based process is active, receiving an indication of a third event associated with a seventh external device, different from the sixth external device; and
while the first time-based process is active and after receiving the indication of the third event:
in accordance with a determination that the seventh external device includes the first configuration, displaying, via a display generation component in communication with the computer system:
a first selectable option that, when selected, initiates output of the first audio output that is based on the first captured sound captured by the sixth external device; and
a second selectable option that, when selected, initiates output of a third audio output that is based on a third captured sound captured by the seventh external device.

20. A non-transitory computer-readable storage medium storing one or more programs configured to be executed by one or more processors of a computer system that is in communication with one or more audio output devices, the one or more programs including instructions for:
receiving an indication of an event;
in response to receiving the indication of the event, initiating a first time-based process, wherein during the first time-based process, captured sound is outputted via the one or more audio output devices;
at a first time while the first time-based process is active:
receiving a first captured sound; and
outputting, via the one or more audio output devices, a first audio output that is based on the first captured sound; and
at a second time while the first time-based process is active:
in accordance with a determination that a set of one or more process-termination criteria are met, wherein the set of one or more process-termination criteria includes a criterion that is met when a predetermined time has elapsed since a third time, terminating the first time-based process; and
in accordance with a determination that the set of one or more process-termination criteria are not met, maintaining the first time-based process.

21. A method, comprising:
at a computer system that is in communication with one or more audio output devices:
receiving an indication of an event;
in response to receiving the indication of the event, initiating a first time-based process, wherein during the first time-based process, captured sound is outputted via the one or more audio output devices;
at a first time while the first time-based process is active:
receiving a first captured sound; and
outputting, via the one or more audio output devices, a first audio output that is based on the first captured sound; and
at a second time while the first time-based process is active:
in accordance with a determination that a set of one or more process-termination criteria are met, wherein the set of one or more process-termination criteria includes a criterion that is met when a predetermined time has elapsed since a third time, terminating the first time-based process; and
in accordance with a determination that the set of one or more process-termination criteria are not met, maintaining the first time-based process.
